(19) United States
(12) Patent Application Publication
(10) Pub. No.: US 2007/0172752 A1
(43) Pub. Date: Jul. 26, 2007

(54) IMAGE FORMING APPARATUS AND IMAGE FORMING METHOD

(76) Inventor: Tatsuya NIIMI, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/625,873

(22) Filed: Jan. 23, 2007

(30) Foreign Application Priority Data
Jan. 24, 2006 (JP) 2006-014539
Jan. 24, 2006 (JP) 2006-014544
Jan. 24, 2006 (JP) 2006-014550

(51) Int. Cl. G03G 15/14

(52) U.S. Cl. 430/123.43; 399/159

(57) ABSTRACT

An image forming apparatus including
a photoreceptor including
   a substrate, and
   an intermediate layer,
   a charge generation layer, and
   a charge transport layer on the substrate in this order;
a charger charging the photoreceptor; an irradiator irradiating the photoreceptor to form an electrostatic latent image thereon;
an image developer developing the electrostatic latent image with a toner to form a toner image on the photoreceptor;
a transferer transferring the toner image onto a recording medium;
a fixer fixing the toner image on the recording medium; and
a discharger removing a residual potential from the photoreceptor with light,
wherein the intermediate layer includes a metal oxide, the charge generation layer comprises an organic charge generation material, and the irradiator irradiates the photoreceptor with writing light having a wavelength shorter than 450 nm, which is not absorbed in the metal oxide in the intermediate layer.

### BACKGROUND OF THE INVENTION

1. Field of the Invention

The present invention relates to an image forming apparatus and an image forming method using an electrostatic latent image bearer (hereinafter referred to as an “electrophotographic photoreceptor”, a “photoreceptor” or a “photoconductive insulator”) having a photosensitive layer comprising a charge generation layer and a charge transport layer, wherein the charge generation layer comprises an organic charge generation material.

2. Discussion of the Background

Recently, development of information processing systems utilizing electrophotography is remarkable. In particular, optical printers in which information converted to digital signals is recorded using light have been dramatically improved in print qualities and reliability. This digital recording technique is applied not only to printers but also to copiers, and so-called digital copiers have been developed and used. Copiers utilizing both the conventional analogue recording technique and this digital recording technique have various information processing functions, and therefore it is expected that demand for such copiers will be escalating. In addition, with popularization and improvement of personal computers, the digital color printers producing color images and documents have been rapidly improved.

At present, as the electrophotographic photoreceptor used for the electrophotographic image forming methods, functionally-separated multilayer photoreceptors having a charge generation layer on an electroconductive substrate directly or through an intermediate layer and a charge transport layer thereon are typically used. In addition, for improving mechanical or chemical durability of the photoreceptors, a protection layer is optionally formed on the surface of the photoreceptors.

As for these functionally-separated multilayer photoreceptors, when a photoreceptor with a charged surface is exposed to light, the light passes through the charge transport layer and is then absorbed in the charge generation material in the charge generation layer. The charge generation material generates charge carriers by absorbing light. The thus generated charge carriers are injected into the charge transport layer. The charge carriers are transported along an electric field formed by charges on the charge transport layer to neutralize the charges of the photoreceptor. Thus, an electrostatic latent image is formed on the surface of the photoreceptor. In order to impart high sensitivity to such a functionally-separated multilayer photoreceptor, a combination of a charge generation material mainly having absorption in near infrared to visible regions and a charge transport material having absorption in yellow to ultraviolet regions, which does not prevent transmission of absorbed light toward the charge generation material (i.e., hardly causes masking effects (filtering effects) of writing light) is typically used.

As writing light sources applicable to the digital recording methods, small, inexpensive and reliable laser diodes (hereinafter referred to as “LD”) and light emitting diodes (hereinafter referred to as “LED”) which emit light having a wavelength of from about 600 to 800 nm are typically used. The wavelength of light emitted by LDs typically used at present is 780 to 800 nm (i.e. a near infrared region). The LED typically emits light having a wavelength of 740 nm.

However, lately, as a light source for digital recording methods such as DVD, LDs (short wavelength LDs) and LEDs which emit light having a wavelength of from 375 to 450 nm (i.e., violet to blue light) have been developed and marketed. When such a LD which emits light having about a half wavelength of that of a conventional near infrared LD is used as a writing light source for a laser scanner head, it is theoretically possible to make the spot diameter of the laser beam on a photoreceptor considerably small as can be understood by the following formula:

d∝(π/4)(λf/D) (1)

wherein d represents the spot diameter of the laser formed on the photoreceptor; λ represents the wavelength of the laser; f represents the focal distance of the fθ lens used; and D represents the lens diameter. Therefore, these short wavelength LDs are very useful for improving image recording density (i.e., image resolution).

Therefore, a writing light source emitting light having a short wavelength of from 375 to 450 nm can irradiate a photoreceptor with a beam spot, i.e., a dot diameter about 30 μm for 1,200 dpi or about 15 μm for 2,400 dpi.

The image forming apparatuses are required to produce full-color images having higher quality. For that purpose, there are two key points, and one of them is to form a clear and small one-dot electrostatic latent image and the other is to reduce formation of abnormal images. The former could be realized with the writing light source emitting short-wavelength light, but the latter is not fully solved yet. Highly stabilizing electrostatic properties of a photoreceptor is considered a most effective method.

There thought to be various methods for solving them, however, in order to solve both of them, property variations of a photoreceptor due to electrostatic fatigue should be reduced. Specifically, deterioration of potential of unirradiated parts and increase of residual potential of irradiated parts thereof when repeatedly used should be reduced.

In order to prevent deterioration of potential of unirradiated parts and increase of residual potential of irradiated parts of a photoreceptor, materials used for the photoreceptor and formulation of coated layers thereof have been studied. However, the electrostatic fatigue of a photoreceptor largely depends not only on the formulation of the layers thereof but also on the image forming conditions of image forming apparatuses. Therefore, it is the conventional way of researchers and developers that materials and formulations are studied to develop a photoreceptor suitable for the target image forming apparatus. In other words, the electrostatic fatigue of a photoreceptor has not been studied in terms of formulation of a photoreceptor suitable for a light source emitting short-wavelength light.

Because of these reasons, a need exists for an image forming apparatus and an image forming method, capable of producing high-durability and high-definition images while preventing deterioration of potential of unirradiated parts and increase of residual potential of irradiated parts of a photoreceptor when repeatedly used in the apparatus.

### SUMMARY OF THE INVENTION

Accordingly, an object of the present invention is to provide an image forming apparatus and an image forming method, capable of producing high-durability and high-definition images while preventing deterioration of potential of unirradiated parts and increase of residual potential of irradiated parts of a photoreceptor when repeatedly used in the apparatus.

This object and other objects of the present invention, either individually or collectively, have been satisfied by the discovery of an image forming apparatus, comprising:

a photoreceptor, comprising:
a substrate; and
a photosensitive layer, comprising:
   an intermediate layer, located overlying the substrate;
   a charge generation layer, located overlying the intermediate layer; and
   a charge transport layer, overlying the charge generation layer;

a charger configured to charge the photoreceptor;

an irradiator configured to irradiate the photoreceptor to form an electrostatic latent image thereon;

an image developer configured to develop the electrostatic latent image with a toner to form a toner image on the photoreceptor;

a transferer configured to transfer the toner image onto a recording medium;

a fixer configured to fix the toner image on the recording medium; and

a discharger configured to discharge a residual potential on the photoreceptor with light;

wherein the intermediate layer comprises a metal oxide, the charge generation layer comprises an organic charge generation material, and the irradiator irradiates the photoreceptor with light having a wavelength shorter than 450 nm, which is not absorbed in the metal oxide in the intermediate layer.

As used herein, “overlying” includes, but does not require, contact with any underlying material.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view for explaining how an inorganic material generates a photocarrier;

FIG. 2 is across-sectional view illustrating an embodiment of layer composition of the electrostatic photoreceptor of the present invention;

FIG. 3 is a cross-sectional view illustrating another embodiment of layer composition of the electrostatic photoreceptor of the present invention;

FIG. 4 is a cross-sectional view illustrating a further embodiment of layer composition of the electrostatic photoreceptor of the present invention;

FIG. 5 is a photograph showing the dispersion status of a charge generation material in a dispersion when the dispersion time is short;

FIG. 6 is a photograph showing the dispersion status of a charge generation material in a dispersion when the dispersion time is long;

FIG. 7 is a graph showing an average particle diameter and a particle diameter distribution of the dispersions in FIGS. 5 and 6;

FIG. 8 is a schematic view illustrating an embodiment of the image forming apparatus of the present invention;

FIG. 9 is a schematic view illustrating another embodiment (a tandem-type full color image forming apparatus) of the image forming apparatus of the present invention;

FIG. 10 is a schematic view illustrating a process cartridge for use in the image forming apparatus of the present invention;

FIG. 11 is a X-ray diffraction spectrum of the titanylphthalocyanine crystal prepared in Synthesis Example 1;

FIG. 12 is a X-ray diffraction spectrum of the titanylphthalocyanine pigment obtained by drying the wet paste prepared in Synthesis Example 1;

FIG. 13 is a test chart used in Example 1;

FIG. 14 is a test chart used in Example 20; and

FIG. 15 is a test chart used in Example 42.

### DETAILED DESCRIPTION OF THE INVENTION

The present invention provides an image forming apparatus and an image forming method, capable of producing high-durability and high-definition images while preventing deterioration of potential of unirradiated parts and increase of residual potential of irradiated parts of a photoreceptor when repeatedly used in the apparatus.

The present inventor studied how the electrostatic properties of a photoreceptor are influenced after repeatedly irradiated with short-wavelength light. Specifically, when repeatedly charging and irradiating a photoreceptor to be subject to electrostatic fatigue, the wavelength of a light source used for the irradiation is changed to evaluate the dependency of the photoreceptor on the wavelength. It is important that a charge transport layer of the photoreceptor transmits all light and a charge generation layer absorbs the light. In other words, the photoreceptor is fully photosensitive to all the light.

As a result of evaluation of the electrostatic fatigue, wherein the wavelength having an allowance of ±10 nm is changed at an interval of about 100 nm, the present inventor discovered that the electrostatic fatigues are completely different from each other across a specific wavelength.

Specifically, when subject to the electrostatic fatigue with only a wavelength longer than the specific wavelength, the residual potential of irradiated parts largely increases and the potential of unirradiated parts does not much deteriorate. When subject to the electrostatic fatigue with only a wavelength shorter than the specific wavelength, the residual potential of irradiated parts does not much increase and the potential of unirradiated parts much deteriorates.

The present inventor also discovered that only a photoreceptor including an intermediate layer has above-mentioned properties. In addition, the present inventor discovered that the specific wavelength varies when materials forming the intermediate layer are changed. Further, he discovered that a photoreceptor has the above-mentioned properties when irradiated light which is absorbed in a metal oxide included in the intermediate layer, particularly when the light has a wavelength shorter than 450 nm.

Namely, when a metal oxide included in the intermediate layer absorbs writing light and generates a photocarrier, the deterioration of potential of unirradiated parts and the increase of residual potential of irradiated parts of a photoreceptor is prevented and the deterioration of potential of unirradiated parts thereof is promoted.

In the recent nega-posi development, most images have monochrome image proparts of 10% or less, and images having similar images in specific places are few. Therefore, photoreceptors have been designed assuming that they are almost uniformly irradiated. Actually, in running tests for long periods, electrostatic properties thereof have not partially been deteriorated.

The image forming apparatus of the present invention proves its worth when producing full-color images. Full-color images even have image proparts of 100%. In addition, formulaic images such as images having a logo at a fixed place increase. Therefore, a photoreceptor has an area frequently used and an area less used in the longitudinal direction thereof.

Conventionally, since writing light and discharging light do not have a wavelength close to each other, and an intermediate layer does not generate a photocarrier, high image proparts and high frequency of partial use of a photoreceptor have not largely affected images produced.

However, writing light having a wavelength shorter than 450 nm is absorbed and a photocarrier is generated depending on materials forming the intermediate layer. Therefore, the irradiated parts and unirradiated parts have fatigues different from each other. As mentioned above, when a large amount of formulaic images are produced, electrostatic properties of a photoreceptor varies depending on the parts.

Such variations of electrostatic properties do not influence so much on images when the images are monochrome. As a matter of course, when the potential of unirradiated parts extremely deteriorate and the residual potential of irradiated parts extremely increases, abnormal images such as background fouling and lowering of image density respectively are produced. However, the images having lower image density are not so apparently identified unless black solid images are produced. Meanwhile, the variations of electrostatic properties largely influence full-color images having many halftone colors, such as loss of color balance and deterioration of color reproducibility.

Therefore, when writing light having a wavelength shorter than 450 nm is used to form an electrostatic latent image, the wavelength needs to be a wavelength which is not absorbed in a metal oxide in an intermediate layer.

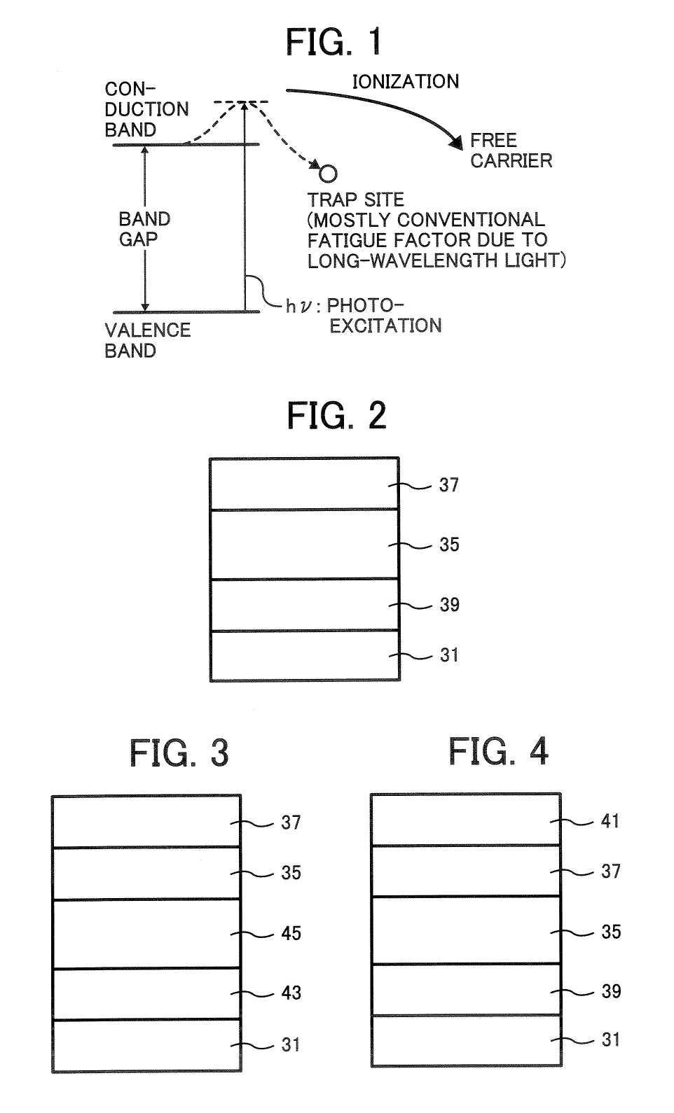

FIG. 1 is a schematic view for explaining how a photocarrier is generated from an inorganic material. In general, a band model including a valence band and a conduction band applies to an inorganic material. An electron obtaining energy which is caused by photo-excitation and which corresponds to the band gap can freely move in the valence band. In addition, in the conduction band the electron is directly ionized, and thereby free carriers are formed. Namely when an electron obtains energy greater than the band gap, a free carrier is immediately formed. Therefore, only an energy smaller than the band gap is properly applied thereto. FIG. 1 also shows a band model wherein a trap site captures a charge carrier, which causes the increase of residual potential.

Practically, a photoreceptor is charged when irradiated, and the intermediate layer has an electric field. In addition, writing light having a wavelength shorter than 450 nm is essentially used to produce high-quality images. Therefore, a material in the intermediate layer is selected or the wavelength is selected.

The writing light having a such wavelength as is not absorbed in a metal oxide in the present invention is defined to have a wavelength having an energy smaller than that of a forbidden band width (energy gap or band gap) of the metal oxide. For example, a rutile-type titanium oxide has an energy gap of 3.0 eV, which is exchanged to a wavelength about 410 nm. This is the maximum wavelength that can be absorbed in the rutile-type titanium oxide, and the rutile-type titanium oxide does not absorb light having a wavelength longer than 410 nm. Therefore, when the rutile-type titanium oxide is used in an intermediate layer, the writing light source preferably emits light having a wavelength shorter than 450 nm and longer than 410 nm.

When writing light has a wavelength of 405 nm, the rutile-type titanium oxide cannot be used, and an anatase-type titanium oxide (3.2 eV: 390 nm) or zinc oxide (3.2 eV: 387 nm) absorbing light having a wavelength shorter (an energy gap larger) than this are used instead so as not be absorbed in the intermediate layer.

The writing light having a wavelength shorter than 450 nm of the present invention does not have a wavelength not shorter than 450 nm.

Methods of measuring the energy gap typically include 3 methods.

One is to measure a spectral reflectance of an intermediate layer to determine an absorption end of light having longer wavelength. This can be performed with a marketed spectral absorber. This method is used in Examples of the present invention. The intermediate layer absorbs light having a wavelength shorter than the absorption end.

The second is to measure a spectral absorption and an emission spectrum of an intermediate layer, and record them on the same graph to determine an intersecting point thereof. These can be measured with a marketed spectral photometer and a marketed fluorometer. The intermediate layer absorbs light having a wavelength shorter than the intersecting point.

The third is to measure energy levels of the conduction band and the valence band, and a difference therebetween is determined as an energy gap. This needs an exclusive measurer and is not so common. The energy gap is exchanged to a wavelength, and the intermediate layer absorbs light having a wavelength shorter than that wavelength.

The reason why the electrostatic properties of a photoreceptor repeatedly used are stable when writing light having a wavelength, which is not absorbed in a metal oxide in the intermediate layer, is used is not clarified. However, the reason is considered as follows.

When a photoreceptor repeatedly used is irradiated with writing light having such a wavelength as is not absorbed in a metal oxide in the intermediate layer, all photocarriers are generated in a charge generation layer of the photoreceptor. Positive-hole photocarriers are injected into a charge transport layer thereof and electron photocarriers are injected into the intermediate layer, and transported to the surface or an electroconductive substrate thereof to cancel a surface charge or a charge induced at the substrate. Since the electron transport is slower than the positive-hole transport, electrons are somewhat accumulated in the intermediate layer. In addition, electrons are not fully injected therein from the charge generation layer, and electrons are accumulated in an interface between the charge generation layer and the intermediate layer.

Meanwhile, when a photoreceptor is irradiated with writing light having such a wavelength as is absorbed in a metal oxide in the intermediate layer, the charge generation layer does not absorb the writing light by 100%, and the writing light reaches the intermediate layer. When the writing light has a wavelength shorter than light having such a wavelength as can be absorbed in the metal oxide, the metal oxide in the intermediate layer absorbs the writing light and photoexcited to generate a photocarrier. When the intermediate layer generates a photocarrier, electrons accumulate less, but its prevention of positive-hole injection from the substrate deteriorates and lowers the potential of the unirradiated parts, resulting in production of abnormal images.

Typically, a red LED (600 nm or longer) is used for a discharge light source in an image forming apparatus. This is not absorbed in the intermediate layer and only the charge generation layer generates a carrier. When a photoreceptor is irradiated with writing light having a wavelength shorter than 450 nm, which can be absorbed in the intermediate layer, a carrier is generated as mentioned above and only the irradiated parts have electrostatic properties different from the other parts. Therefore, even when producing formulaic images, a photoreceptor is preferably irradiated with light having such a wavelength as cannot be absorbed in the intermediate layer, such that the irradiated parts and unirradiated parts do not have electrostatic properties different from each other.

The image forming apparatus of the present invention includes at least an electrostatic image bearer which includes a multilayer photosensitive layer including an intermediate layer including a metal oxide, a charge generation layer (CGL) which includes an organic charge generation material (CGM) and a charge transport layer (CTL) including a charge transport material (CTM) on an electroconductive substrate; a charger; an irradiator including a light source emitting light having a wavelength shorter than 450 nm, which is not absorbed in the metal oxide; an image developer; a transferer; a fixer; and a discharger. Further, the image forming apparatus optionally includes other means such as a cleaner, a toner recycler and a controller.

The image forming method of the present invention includes at least a charging process; an irradiating process with a light source emitting light having a wavelength shorter than 450 nm, which is not absorbed in the metal oxide; a developing process, a transferring process, a discharging process; and a fixing process. The image forming method optionally includes other processes such as a cleaning process, a toner recycling process and a controlling process.

The image forming method of the present invention can preferably be performed using the image forming apparatus of the present invention. Specifically, the charging process, irradiating process, developing process, transferring process, discharging process and fixing process are performed with the charger, image developer, transferer, discharger and fixer, respectively. The other optional processes can be performed with the optional means mentioned above.

This is not substantially influencing the present invention, however, even though the photoreceptor for use in the present invention is heated, the increase of residual potential after irradiated is not noticeably improved. Therefore, only the band model wherein a trap site captures a charge carrier, which mostly causes the increase of residual potential, is apparently difficult to explain causes and prevention of the electrostatic fatigue.

### Electrostatic Latent Image Bearer (i.e., Photoreceptor)

The photoreceptor for use in the image forming apparatus of the present invention includes at least a metal oxide in the intermediate layer and an organic CGM in the CGL. The materials, shape, structure, dimension, etc. of the photoreceptor are not particularly limited. The photoreceptor preferably includes an electroconductive substrate.

FIGS. 2 to 4 illustrate examples of the photoreceptor for use in the image forming apparatus of the present invention.

The photoreceptor illustrated in FIG. 2 has an electroconductive substrate 31; and an intermediate layer 39 including a metal oxide, a CGL 35 including at least an organic CGM as a main component and a CTL 37 including a CTM as a main component on the substrate.

The photoreceptor illustrated in FIG. 3 has a structure similar to the photoreceptor illustrated in FIG. 2 except that the intermediate layer 39 includes a charge blocking layer 43 and an anti-moiré layer 45.

The photoreceptor illustrated in FIG. 4 has a structure similar to the photoreceptor illustrated in FIG. 3 except that a protection layer 41 is formed on the CTL.

Suitable materials for use as the electroconductive substrate 31 include materials having a volume resistivity not greater than 10¹⁰ Ω·cm. Specific examples of such materials include plastic cylinders, plastic films or paper sheets, on the surface of which a metal such as aluminum, nickel, chromium, nichrome, copper, gold, silver and platinum, or a metal oxide such as a tin oxide and an indium oxide, is formed by deposition or sputtering. In addition, a plate of a metal such as aluminum, aluminum alloys, nickel and stainless steel can be used. A metal cylinder can also be used as the substrate 31, which is prepared by tubing a metal such as aluminum, aluminum alloys, nickel and stainless steel by a method such as impact ironing or direct ironing, and then treating the surface of the tube by cutting, super finishing, polishing, etc. In addition, endless belts of a metal such as nickel and stainless steel can also be used as the substrate 31.

Further, substrates, in which a coating liquid including a binder resin and an electroconductive powder is coated on the supports mentioned above, can be used as the substrate 31. Specific examples of such an electroconductive powder include carbon black, acetylene black, powders of metals such as aluminum, nickel, iron, nichrome, copper, zinc, and silver, and metal oxides such as electroconductive tin oxides and ITO.

Specific examples of the binder resin include known thermoplastic resins, thermosetting resins and photo-crosslinking resins, such as polystyrene, a styrene-acrylonitrile copolymer, a styrene-butadiene copolymer, a styrene-maleic anhydride copolymer, polyester, polyvinyl chloride, a vinyl chloride-vinyl acetate copolymer, polyvinyl acetate, polyvinylidene chloride, polyarylate, a phenoxy resin, polycarbonate, a cellulose acetate resins, an ethyl cellulose resin, a polyvinyl butyral resin, a polyvinyl formal resin, polyvinyl toluene, poly-N-vinyl carbazole, an acrylic resin, a silicone resin, an epoxy resin, a melamine resin, a urethane resin, a phenolic resin and an alkyd resin. Such an electroconductive layer can be formed by coating a coating liquid in which an electroconductive powder and a binder resin are dispersed or dissolved in a proper solvent such as tetrahydrofuran, dichloromethane, methyl ethyl ketone and toluene, and then drying the coated liquid.

In addition, substrates, in which an electroconductive resin film is formed on a surface of a cylindrical substrate using a heat-shrinkable resin tube which is made of a combination of a resin such as polyvinyl chloride, polypropylene, polyesters, polyvinylidene chloride, polyethylene, chlorinated rubber and fluorine-containing resins (such as TEFLON), with an electroconductive material, can also be used as the substrate 31.

Among these materials, cylinders made of aluminum or an aluminum alloy are preferable because aluminum can be easily anodized. Suitable aluminum materials for use as the substrate include aluminum and aluminum alloys such as JIS 1000 series, 3000 series and 6000 series. Anodic oxide films can be formed by anodizing metals or metal alloys in an electrolyte solution. Among the anodic oxide films, alumite films which can be prepared by anodizing aluminum or an aluminum alloy are preferably used for the photoreceptor of the present invention. This is because the resultant photoreceptor hardly causes undesired images such as black spots and background fouling when used for reverse development (i.e., nega-posi development).

The anodizing treatment is performed in an acidic solution including an acid such as chromic acid, sulfuric acid, oxalic acid, phosphoric acid, boric acid, and sulfamic acid. Among these acids, sulfuric acid is preferably used for the anodizing treatment in the present invention. It is preferable to perform an anodizing treatment on a substrate under the following conditions:

(1) concentration of sulfuric acid: 10 to 20%

(2) temperature of treatment liquid: 5 to 25° C.

(3) current density: 1 to 4 A/dm²

(4) electrolyzation voltage: 5 to 30 V

(5) treatment time: 5 to 60 minutes.

However, the treatment conditions are not limited thereto. The thus prepared anodic oxide film is porous and highly insulative. Therefore, the surface of the substrate is very unstable, and the physical properties of the anodic oxide film change with time. In order to avoid such a problem, the anodic oxide film is preferably subjected to a sealing treatment. The sealing treatment can be performed by, for example, the following methods:

(1) dipping the anodic oxide film in an aqueous solution of nickel fluoride or nickel acetate;

(2) dipping the anodic oxide film in boiling water; and

(3) subjecting the anodic oxide film to steam sealing.

After the sealing treatment, the anodic oxide film is subjected to a washing treatment to remove foreign materials such as metal salts adhered to the surface of the anodic oxide film during the sealing treatment. Such foreign materials present on the surface of the substrate not only affect the coating quality of a layer formed thereon but also produce images having background fouling because of typically having a low electric resistance. The washing treatment is performed by washing the substrate having an anodic oxide film thereon with pure water one or more times. It is preferable that the washing treatment is performed until the washing water is as clean (i.e., deionized) as possible. In addition, it is also preferable to rub the substrate with a washing member such as brushes in the washing treatment. The thickness of the thus prepared anodic oxide film is preferably from 5 to 15 μm. When the anodic oxide film is too thin, the barrier effect thereof is not satisfactory. In contrast, when the anodic oxide film is too thick, the time constant of the electrode (i.e., the substrate) becomes excessively large, resulting in increase of residual potential of the resultant photoreceptor and deterioration of response thereof.

The photoreceptor of the present invention can include an intermediate layer 39 between the electroconductive substrate 31 and the CGL 35. The intermediate layer 39 includes a resin as a main component. Since a CGL is formed on the intermediate layer typically by coating a liquid including an organic solvent, the resin in the intermediate layer preferably has good resistance to general organic solvents. Specific examples of such resins include water-soluble resins such as a polyvinyl alcohol resin, casein and a polyacrylic acid sodium salt; alcohol soluble resins such as a nylon copolymer and a methoxymethylated nylon resin; and thermosetting resins capable of forming a three-dimensional network such as a polyurethane resin, a melamine resin, an alkyd-melamine resin and an epoxy resin.

The intermediate layer includes a metal oxide for preventing moiré as well as reducing the residual potential. Specific examples of the metal oxide include titanium oxide, silica, alumina, zirconium oxide, tin oxide, indium oxide, zinc oxide, etc. Particularly, titanium oxide and zinc oxide are effectively used. Anatase-type titanium oxide is preferably used as the titanium oxide. Considering light absorption, the anatase-type titanium oxide is more preferably used than rutile-type titanium oxide because of absorbing light having a wavelength shorter than that of the rutile-type titanium oxide.

The absorption wavelength range of the metal oxide varies depending on impurities included therein and crystal form thereof. Therefore, the energy gap of the metal oxide or an intermediate layer including the metal oxide needs to actually measured as mentioned above.

The titanium oxide, zinc oxide and tin oxide each has an absorption end wavelength of about 410 nm, 388 nm and 350 nm respectively when exchanged from their energy gaps. As mentioned above, these are subject to change depending on impurities included therein and crystal forms thereof.

The metal oxide is preferably surface-treated because of having a smaller surface area preventing a carrier needlessly produced thereby from transporting.

The intermediate layer can be formed by coating a coating liquid using a proper solvent and a proper coating method, and preferably has a thickness of from 0.1 to 5 μm.

The intermediate layer 39 has both a function of preventing the charges, which are induced at the electroconductive substrate side of the layer in the charging process, from being injected into the photosensitive layer, and a function of preventing occurrence of moiré fringe caused by using coherent light such as laser light as image writing light. In the present invention it is preferable to use a functionally separated intermediate layer i.e., a combination of the charge blocking layer 43 and the anti-moiré layer 45. Next, the functionally separated intermediate layer will be explained.

The function of the charge blocking layer 43 is to prevent the charges, which are induced in the electrode (i.e., the electroconductive substrate 31) and have a polarity opposite to that of the voltage applied to the photoreceptor by a charger, from being injected to the photosensitive layer. Specifically, when negative charging is performed, the charge blocking layer 43 prevents injection of positive holes to the photosensitive layer. In contrast, when positive charging is performed, the charge blocking layer 43 prevents injection of electrons to the photosensitive layer. Specific examples of the charge blocking layer include the following layers:

(1) a layer prepared by anodic oxidation such as aluminum oxide layer;

(2) an insulating layer of an inorganic material such as SiO;

(3) a layer made of a network of a glassy metal oxide;

(4) a layer made of polyphosphazene;

(5) a layer made of a reaction product of aminosilane;

(6) a layer made of an insulating resin; and

(7) a crosslinked resin layer.

Among these layers, an insulating resin layer and a crosslinked resin layer, which can be formed by a wet coating method, are preferably used. Since the anti-moiré layer and the photosensitive layer are typically formed on the charge blocking layer by a wet coating method, the charge blocking layer preferably has good resistance to the solvents included in the coating liquids of the anti-moiré layer and the photosensitive layer.

Suitable resins for use in the charge blocking layer include thermoplastic resins such as a polyamide resin, a polyester resin and a vinyl chloride/vinyl acetate copolymer; and thermosetting resins which can be prepared by thermally polymerizing a compound having a plurality of active hydrogen atoms (such as hydrogen atoms of —OH, —NH2, and —NH) with a compound having a plurality of isocyanate groups and/or a compound having a plurality of epoxy groups. Specific examples of the compound having a plurality of active hydrogen atoms include polyvinyl butyral, a phenoxy resin, a phenolic resin, a polyamide resin, a phenolic resin, a polyamide resin, a polyester resin, a polyethylene glycol resin, a polypropylene glycol resin, a polybutylene glycol resin and an acrylic resin like a hydroxyethyl methacrylate resin. Specific examples of the compound having a plurality of isocyanate groups include tolylene diisocyanate, hexamethylene diisocyanate, diphenylmethane diisocyanate, prepolymers of these compounds, etc. Specific examples of the compound having a plurality of epoxy groups include bisphenol A based on an epoxy resin, etc. Among these resins, the polyamide resin is preferably used in view of film formability, environmental stability and resistance to solvents. Particularly, a N-methoxymethylated nylon is most preferably used. The N-methoxymethylated nylon can be prepared by modifying polyamide including polyamide 6 by a method disclosed by T. L. Cairns (J. Am. Chem. Soc. 71. P 651 (1949)). An amide-linked hydrogen of the original polyamide is substituted with a methoxymethyl group to form the N-alkoxymethylated nylon. The substitutional rate thereof is largely dependent on the modifying conditions, however, preferably not less than 15 mol %, and more preferably not less than 35 mol % in terms of suppressing the hygroscopicity, alcohol affinity and environmental stability of the intermediate layer. The more the substitutional rate, the more the alcoholic solvent affinity. However, the hygroscopicity increases and the crystallinity deteriorates, resulting in deterioration of melting point, mechanical strength and elasticity, because bulk side chain groups around the main chain affect the relaxation and coordination of the main chain. Therefore, the substitutional rate is preferably not greater than 85 mol %, and more preferably not greater than 70 mol %. Further, nylon 6 is most preferably used, nylon 66 is preferably used, and a copolymer nylon such as nylon 6/66/610 is not preferably used as disclosed in Published Unexamined Japanese Patent Application No. 9-265202.

In addition, oil-free alkyd resins; amino resins such as thermosetting amino resins prepared by thermally polymerizing a butylated melamine resin; and photo-crosslinking resins prepared by reacting an unsaturated resin, such as unsaturated polyurethane resins unsaturated polyester resins, with a photo-polymerization initiator such as thioxanthone compounds and methylbenzyl formate, can also be used.

In addition, electroconductive polymers having a rectification property, and layers including a resin or a compound having an electron accepting or donating property which is determined depending on the polarity of the charges formed on the surface of the photoreceptor can also be used.

The charge blocking layer 43 preferably has a thickness not less than 0.1 μm and less than 2.0 μm, and more preferably from 0.3 μm to 1.0 μm. When the charge blocking layer is too thick, the residual potential of the photoreceptor increases after imagewise light irradiation is repeatedly performed particularly under low temperature and low humidity conditions. In contrast, the charge blocking layer is too thin, the charge blocking effect is hardly produced. The charge blocking layer 43 can include one or more materials such as crosslinking agents, solvents, additives and crosslinking promoters. The charge blocking layer 43 can be prepared by coating a coating liquid by a coating method such as blade coating, dip coating, spray coating, bead coating and nozzle coating, followed by drying and crosslinking using heat or light.

The function of the anti-moiré layer 45 is to prevent occurrence of moiré fringe in the resultant images due to interference of light, which is caused when coherent light (such as laser light) is used for optical writing. Namely, the anti-moiré layer scatters the above-mentioned writing light. In order to perform this function, the layer preferably includes a material having a high refractive index.

Therefore, when the intermediate layer includes a charge blocking layer and anti-moiré layer, the anti-moiré layer and the charge blocking layer preferably contact each other.

Since the injection of charges from the substrate 31 is blocked by the charge blocking layer 43, the anti-moiré layer 45 preferably has an ability to transport charges having the same polarity as that of the charges formed on the surface of the photoreceptor, to prevent increase of residual potential. For example, in a negative charge type photoreceptor, the anti-moiré layer 45 preferably has an electron conducting ability. Therefore it is preferable to use an electroconductive inorganic pigment or a conductive inorganic pigment for the anti-moiré layer 45. Alternatively, an electroconductive material (such as acceptors) may be added to the anti-moiré layer 45.

Specific examples of the binder resin for use in the anti-moiré layer 45 include the resins mentioned above for use in the charge blocking layer 43. Since the photosensitive layer (CGL 35 and CTL 37) is formed on the anti-moiré layer 45 by coating a coating liquid, the binder resin preferably has a good resistance to the solvent included in the photosensitive layer coating liquid

Among the resins, thermosetting resins are preferably used Particularly, a mixture of an alkyd resin and a melamine resin is most preferably used. The mixing ratio of an alkyd resin to a melamine resin is an important factor influencing the structure and properties of the anti-moiré layer 45, and the weight ratio thereof is preferably from 5/5 to 8/2. When the content of the melamine resin is too high, the coated film is shrunk in the thermosetting process, and thereby coating defects are formed in the resultant film. In addition, the residual potential increasing problem occurs. In contrast, when the content of the alkyd resin is too high, the electric resistance of the layer seriously decreases, and thereby the resultant images have background fouling, although residual potential of the photoreceptor is reduced.

The mixing ratio of the inorganic pigment to the binder resin in the anti-moiré layer 45 is also an important factor, and the volume ratio thereof is preferably from 1/1 to 3/1. When the ratio is too low (i.e., the content of the inorganic pigment is too low), not only the anti-moiré effect deteriorates but also the residual potential increases after repeated use. In contrast, when the ratio is too high, the film formability of the layer deteriorates, resulting in deterioration of surface conditions of the resultant layer. In addition, a problem in that the upper layer (e.g., the photosensitive layer) cannot form a good film thereon because the coating liquid penetrates into the anti-moiré layer. This problem is fatal to the photoreceptor having a layered photosensitive layer including a thin charge generation layer as a lower layer because such a thin CGL cannot be formed on such a anti-moiré layer. In addition, when the ratio is too large, a problem in that the surface of the inorganic pigment cannot be covered with the binder resin. In this case, the CGM is directly contacted with the inorganic pigment and thereby the possibility of occurrence of a problem in that carriers are thermally produced increases, resulting in occurrence of the background development problem.

By using two kinds of titanium oxides having different average particle diameters for the anti-moiré layer, the substrate 1 is effectively hidden by the anti-moiré layer and thereby occurrence of moiré fringes can be well prevented and formation of pinholes in the layer can also be prevented. In this regard, the average particle diameters (D1 and D2) of the two kinds of titanium oxides preferably satisfy the following relationship:

0.2<D2/D1<0.5.

When the ratio D2/D1 is too low, the surface of the titanium oxide becomes more active, and thereby stability of the electrostatic properties of the resultant photoreceptor seriously deteriorates. In contrast, when the ratio is too high, the electroconductive substrate 31 cannot be well hidden by the anti-moiré layer and thereby the anti-moiré effect deteriorates and abnormal images such as moiré fringes are produced. In this regard, the average particle diameter of the pigment means the average particle diameter of the pigment in a dispersion prepared by dispersing the pigment in water while applying a strong shear force thereto.

Further, the average particle diameter (D2) of the titanium oxide (T2) having a smaller average particle diameter is also an important factor, and is preferably greater than 0.05 μm and less than 0.20 μm. When D2 is too small, hiding power of the layer deteriorates. Therefore, moiré fringes tend to be caused. In contrast, when D2 is too large, the filling factor of the titanium oxide in the layer is small, and thereby background development preventing effect cannot be well produced.

The mixing ratio of the two kinds of titanium oxides in the anti-moiré layer 45 is also an important factor, and is preferably determined such that the following relationship is satisfied:

0.2<T2/(T1+T2)<0.8,

wherein T1 represents the weight of the titanium oxide having a larger average particle diameter, and T2 represents the weight of the titanium oxide having a smaller average particle diameter. When the mixing ratio is too low, the filling factor of the titanium oxide in the layer is small, and thereby background development preventing effect cannot be well produced. In contrast, when the mixing ratio is too high, the hiding power of the layer deteriorates, and thereby the anti-moiré effect cannot be well produced.

The anti-moiré layer preferably has a thickness of from 1 to 10 μm, and more preferably from 2 to 5 μm. When the layer is too thin, the anti-moiré effect cannot be well produced. In contrast, when the layer is too thick, the residual potential increases after repeated use.

The anti-moiré layer is typically prepared as follows. A metal oxide is dispersed in a solvent together with a binder resin using a dispersion machine such as ball mills, sand mills, and attritors. In this case, crosslinking agents, other solvents, additives, crosslinking promoters, etc., can be added thereto if desired. The thus prepared coating liquid is coated on the charge blocking layer by a method such as blade coating, dip coating, spray coating, bead coating and nozzle coating, followed by drying and crosslinking using light or heat.

Next, the photosensitive layer will be explained. The photosensitive layer includes the CGL 35 including an organic CGM and the CTL 37 including a CTM.

The CGL 35 includes an organic CGM as a main component, and is typically prepared by coating a coating liquid, which is prepared by dispersing an organic CGM in a solvent optionally together with a binder resin using a dispersing machine such as ball mills, attritors, sand mills and supersonic dispersing machines, on an electroconductive substrate, followed by drying.

Specific examples of the binder resins, which are optionally included in the CGL coating liquid, include polyamide, polyurethane, an epoxy resin, polyketone, polycarbonate, a silicone resin, an acrylic resin, polyvinyl butyral, polyvinyl formal, polyvinyl ketone, polystyrene, polysulfone, poly-N-vinylcarbazole, polyacrylamide, polyvinyl benzyl, polyester, a phenoxy resin, a vinyl chloride-vinyl acetate copolymer, polyvinyl acetate, polyphenylene oxide, polyamide, polyvinyl pyridine, a cellulose resin, casein, polyvinyl alcohol, polyvinyl pyrrolidone, etc. Among the binder resins, polyvinyl acetal represented by polyvinyl butyral is preferably used. The CGL preferably includes the binder resin of from 0 to 500 parts by weight, and preferably from 10 to 300 parts by weight, per 100 parts by weight of the CGM included in the layer.

Specific examples of the solvents for use in the CGL coating liquid include isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene, ligroin, etc. Among these solvents, ketones, esters and ethers are preferably used. The CGL preferably has a thickness of from 0.01 to 5 μm, and more preferably from 0.1 to 2 μm.

The CGL preferably has a writing light transmission of from 10 to 25%. When too large, the writing light reaches the intermediate layer too much. When too small, the electrostatic fatigue becomes large.

Specific examples of the organic CGM include phthalocyanine pigments such as metal phthalocyanine and metal-free phthalocyanine, an azulenium salt pigment, a squaric acid methine pigment, an azo pigment having a carbazole skeleton, an azo pigment having a triphenyl amine skeleton, an azo pigment having a diphenyl amine skeleton, an azo pigment having a dibenzothiophene skeleton, an azo pigment having a fluorenone skeleton, an azo pigment having an oxadiazole skeleton, an azo pigment having a bisstilbene skeleton, an azo pigment having a distyryloxadiazole skeleton, an azo pigment having a distyrylcarbazole skeleton, a perylene pigment, an anthraquinone pigment, a polycyclic quinone pigment, a quinone imine pigment, a diphenylmethane pigment, a triphenylmethane pigment, a benzoquinone pigment, a naphthoquinone pigment, a cyanine pigment, an azomethine pigment, an indigoide pigment, z bisbenzimidazole pigment, etc. These CGMs can be used alone or in combination.

Among the pigments, an asymmetric azo pigment having the following formula (I) can effectively be used:

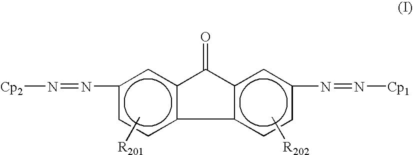

wherein Cp₁ and Cp₂ independently and differently represent a coupler residue, and R₂₀₁, and R₂₀₂ independently represent a hydrogen atom, a halogen atom, an alkyl group, an alkoxy group and a cyano group.

In addition, Cp₁ and Cp₂ have the following formula (II):

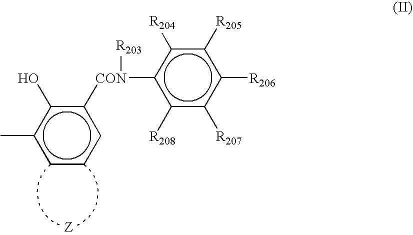

wherein R₂₀₃ represents a hydrogen atom, an alkyl group or an aryl group. R₂₀₄, R₂₀₅, R₂₀₆, R₂₀₇ and R₂₀₈ independently represent a hydrogen atom, a nitro group, a cyano group, a halogen atom, a halogenated alkyl group, an alkyl group, an alkoxy group, dialkylamino group and a hydroxyl group. Z represents atoms which are required to form a substituted or an unsubstituted aromatic carbon ring, or a substituted or an unsubstituted aromatic heterocycle.

Further, a titanylphthalocyanine compound having an X-ray diffraction spectrum such that a maximum peak is observed at a Bragg (2θ) angle (+0.2°) of 27.2°; or an X-ray diffraction spectrum such that a maximum peak is observed at a Bragg (2θ) angle of 27.2±0.2°, a lowest angle peak at an angle of 7.3±0.2°, and a main peak at each of Bragg (2θ) angles (±0.2°) of 9.4°, 9.6°, and 24.0°, wherein no peak is observed between the peaks of 7.3° and 9.4° and at an angle of 26.3 (±0.2°) is also preferably used.

The organic CGM preferably has an average particle diameter not greater than 0.25 μm, and more preferably not greater than 0.2 μm. The organic CGM having a particle diameter not less than 0.25 μm is removed after dispersed.

The average particle diameter means a volume average particle diameter, and can be determined by a centrifugal automatic particle diameter analyzer, CAPA-700 from Horiba Ltd. The volume average particle diameter means the cumulative 50% particle diameter (i.e., Median diameter). However, by using this particle diameter determining method, there is a case where a small amount of coarse particles cannot be detected. Therefore, it is preferable to directly observe the dispersion including a CGM with an electron microscope, to determine the particle diameter of the crystal.

In addition, with respect to minute coating defects included in a layer using a dispersion, the following knowledge can be acquired. Whether coarse particles are present in the dispersion can be detected by a particle diameter measuring instrument if the concentration of coarse particles is on the order of a few percent or more. However, when the concentration is not greater than 1% the presence of coarse particles cannot be detected by such an instrument. Therefore, even when it is confirmed that the average particle diameter of the crystal in a dispersion falls in the preferable range, a problem in that the resultant charge generation layer has minute coating defects can occur.

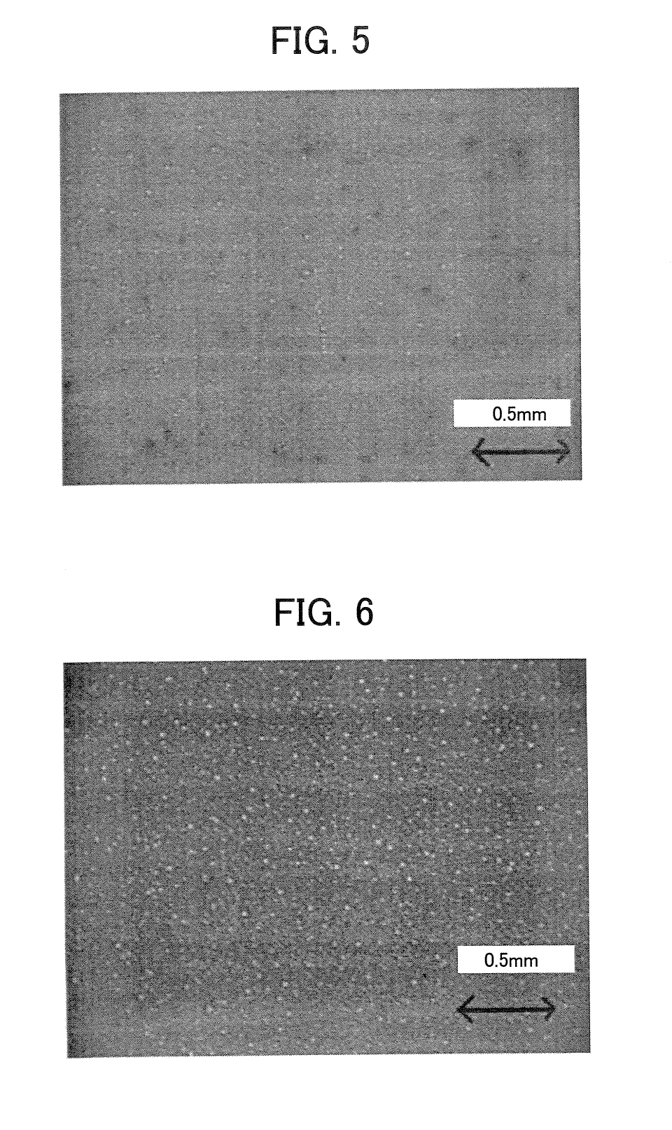

FIGS. 5 and 6 are photographs showing the dispersion status in different dispersions which are prepared by the same method except that the dispersion time is changed. The dispersion time for the dispersion in FIG. 5 is shorter than that for the dispersion in FIG. 6. It is clear from the comparison of FIG. 5 with FIG. 6 that coarse particles are present in the dispersion in FIG. 5. Coarse particles are observed as black spots in FIG. 5.

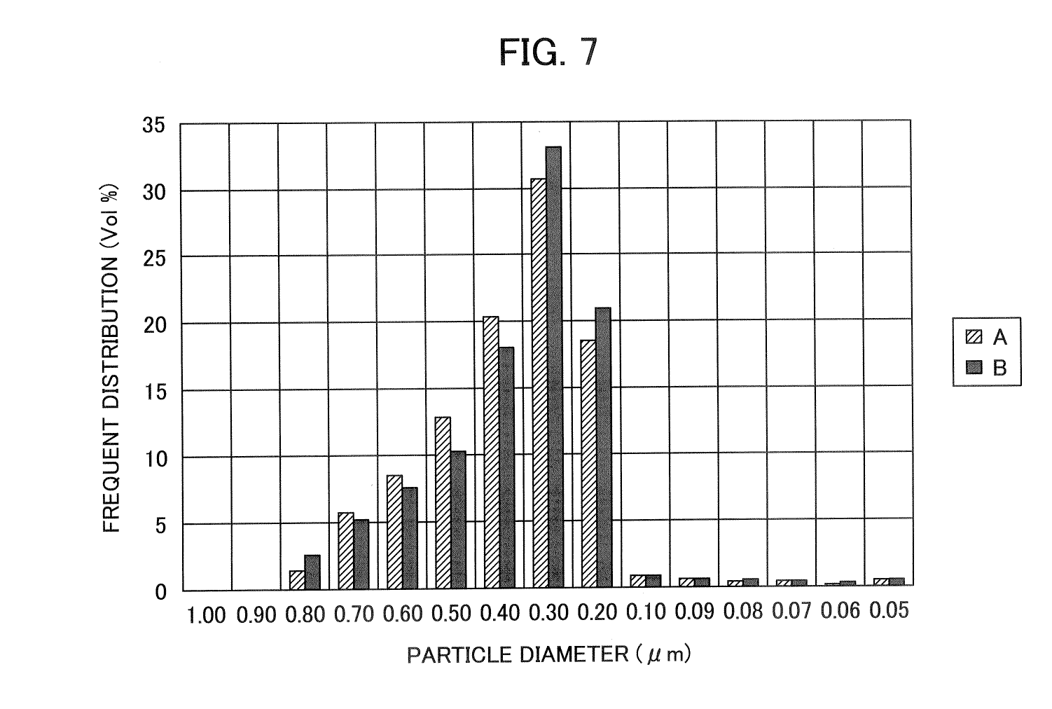

The particle diameter distributions of the dispersions, which are measured with a centrifugal automatic particle diameter analyzer, CAPA-700 from Horiba Ltd., are illustrated in FIG. 7. In FIG. 7, A and B represent the particle diameter distributions of the dispersions in FIG. 5 and FIG. 6, respectively. As can be understood from the graph, the particle diameter distributions are almost the same. The average particle diameters of A and B are 0.29 μm and 0.28 μm, respectively, which are the same when considering the measurement error.

Thus, whether or not coarse particles are present cannot be determined using such a particle diameter measuring instrument. As mentioned above, whether coarse particles are present in a dispersion can be detected only by the method in which the dispersion is directly observed using a microscope.

Next, a method of removing coarse particles from an organic CGM dispersion will be explained.

A dispersion is prepared by dispersing the organic CGM in a solvent, optionally together with a binder resin, using a ball mill, an attritor, a sand mill, a bead mill, an ultrasonic dispersing machine or the like. In this case, it is preferable that a proper binder resin is chosen in consideration of the electrostatic properties of the resultant photoreceptor and a proper solvent is chosen while considering its abilities to wet and disperse the pigment.

Specifically, after a dispersion wherein the particles are refined as much as possible is prepared, the dispersion is then filtered using a filter with a proper pore size. By using this method, a small amount of coarse particles (which cannot be visually observed or cannot be detected by a particle diameter measuring instrument) can be removed from the dispersion. In addition, the particle diameter distribution of the particles in the dispersion can be properly controlled. Specifically, it is preferable to use a filter with an effective pore diameter not greater than 5 μm, and more preferably not greater than 3 μm. By using such a filter, a dispersion in which the CGM is dispersed while having an average particle diameter not greater than 0.25 μm (or not greater than 0.20 μm) can be prepared. By using this dispersion, a CGL can be formed without causing coating defects. Therefore, the effects of the present invention can be fully produced.

When a dispersion including a large amount of coarse particles is filtered, the amount of particles removed by filtering increases, and thereby a problem in that the solid content of the resultant dispersion is seriously decreased. Therefore, it is preferable that the dispersion to be filtered has a proper particle diameter distribution (i.e., a proper particle diameter and a proper standard deviation of particle diameter). Specifically, in order to efficiently perform the filtering operation without causing the clogging problem of the filter at a little loss of the resultant CGM, it is preferable that the average particle diameter is not greater than 0.3 μm and the standard deviation of the particle diameter is not greater than 0.2 μm.

The CGMs for use in the present invention have a high intermolecular hydrogen bond force. Therefore, the dispersed pigment particles have a high interaction. As a result thereof, the dispersed CGM particles tend to aggregate. By performing the above-mentioned filtering using a filter having the specific pore diameter, such aggregates can be removed. In this regard, the dispersion has a thixotropic property, and thereby particles having a particle diameter less than the pore diameter of the filter used can be removed. Alternatively, a liquid having a structural viscosity can be changed to a Newtonian liquid by filtering. By removing coarse particles from a CGL coating liquid, a good CGL can be prepared and the effect of the present invention can be produced.

It is preferable that a proper filter is chosen depending on the size of coarse particles to be removed. As a result of the present inventors' investigation, it is found that coarse particles having a particle diameter not less than 3 μm affect the image qualities of images with a resolution of 600 dpi. Therefore, it is preferable to use a filter with a pore diameter not greater than 5 μm, and more preferably not greater than 3 μm. Filters with too small a pore diameter filter out TiOPc particles, which can be used for the CGL, as well as coarse particles to be removed. In addition, such filters cause problems in that filtering takes a long time, the filters are clogged with particles, and an excessive stress is applied to the pump used. Therefore, a filter with a proper pore diameter is preferably used. Needless to say, the filter preferably has good resistance to the solvent used for the dispersion.

The CTL is typically prepared by coating a coating liquid, which is prepared by dissolving or dispersing a CTM in a solvent optionally together with a binder resin, followed by drying. If desired, additives such as plasticizers, leveling agents and antioxidants can be added to the coating liquid.

The CTM includes a positive-hole transport material and an electron transport material. Specific examples of the electron transport material include electron accepting materials such as chloranil, bromanil, tetracyanoethylene, tetracyanoquinodimethane, 2,4,7-trinitro-9-fluorenon, 2,4,5,7-tetranitro-9-fluorenon, 2,4,5,7-tetanitroxanthone, 2,4,8-trinitrothioxanthone, 2,6,8-trinitro-4H-indeno[1,2-b]thiophene-4-one, 1,3,7-trinitrodibenzothiphene-5,5-dioxide, benzoquinone derivatives, etc.

Specific examples of the positive-hole transport material include known materials such as poly-N-carbazole and its derivatives, poly-γ-carbazolylethylglutamate and its derivatives, pyrene-formaldehyde condensation products and their derivatives, polyvinyl pyrene, polyvinyl phenanthrene, polysilane, oxazole derivatives, oxadiazole derivatives, imidazole derivatives, monoarylamines, diarylamines, triarylamines, stilbene derivatives, α-phenyl stilbene derivatives, benzidine derivatives, diarylmethane derivatives, triarylmethane derivatives, 9-styrylanthracene derivatives, pyrazoline derivatives, divinyl benzene derivatives, hydrazone derivatives, indene derivatives, butadiene derivatives, pyrene derivatives, bisstilbene derivatives, enamine derivatives, etc These CTMs can be used alone or in combination.

Specific examples of the binder resin for use in the CTL include known thermoplastic resins and thermosetting resins, such as polystyrene, a styrene-acrylonitrile copolymer, a styrene-butadiene copolymer, a styrene-maleic anhydride copolymer, polyester, polyvinyl chloride, a vinyl chloride-vinyl acetate copolymer, polyvinyl acetate, polyvinylidene chloride, polyarylate, a phenoxy resin, polycarbonate, a cellulose acetate resin, an ethyl cellulose resin, s polyvinyl butyral resin, a polyvinyl formal resin, polyvinyl toluene, poly-N-vinyl carbazole, an acrylic resin, a silicone resin, an epoxy resin, a melamine resin, a urethane resin, a phenolic resin and an alkyd resin.

The content of the CTM in the charge transport layer is preferably from 20 to 300 parts by weight, and more preferably from 40 to 150 parts by weight, per 100 parts by weight of the binder resin included in the CTL. The thickness of the CTL 8 is preferably from 5 to 100 μm.

Suitable solvents for use in the CTL coating liquid include tetrahydrofuran, dioxane, toluene, dichloromethane, monochlorobenzene, dichloroethane, cyclohexanone, methyl ethyl ketone, acetone and the like solvents. However, in view of environmental protection, non-halogenated solvents are preferably used. Specifically, cyclic ethers such as tetrahydrofuran, dioxolan and dioxane, aromatic hydrocarbons such as toluene and xylene, and their derivatives are preferably used.

In the present invention, a CGL and a CTL are formed on an intermediate layer. Therefore, occasionally, writing light cannot reach the intermediate layer and photocarriers do not generate therein unless a CTM is properly selected. In addition, when a CTM absorbs the writing light, the CTM easily deteriorate by the light, resulting in the increase of residual potential. Therefore, the CTL preferably has a transmission not less than 30%, more preferably not less than 50% and even more preferably not less than 85% against the writing light.

Therefore, it is important to select a CTM suitable for discharging light. Particularly, a CTM having a triarylamine skeleton is preferably used because of well transmitting discharging light having a wavelength less than 450 nm.

The CTL may include additives such as plasticizers and leveling agents. Specific examples of the plasticizers include known plasticizers such as dibutyl phthalate and dioctyl phthalate. The content of the plasticizer in the CTL is from 0 to 30% by weight based on the total weight of the binder resin included in the CTL. Specific examples of the leveling agents include silicone oils such as a dimethyl silicone oil and a methyl phenyl silicone oil, and polymers and oligomers including a perfluoroalkyl group in their side chain. The CTL preferably includes the leveling agent of from 0 to 1% by weight based on the total weight of the binder resin included in the CTL.

The photoreceptor for use in the present invention optionally includes a protection layer, which is formed on the photosensitive layer to protect the photosensitive layer. Recently, computers are used in daily life, and therefore a need exists for a high-speed and small-sized printer. By forming a protection layer on the photosensitive layer, the resultant photoreceptor has good durability while having a high photosensitivity and producing images without abnormal images.

The protection layers for use in the present invention are classified into two types, one of which is a layer including a binder resin and a filler dispersed in the binder resin and the other of which is a layer including a crosslinked binder resin.

At first, the protection layer of the first type will be explained.

Specific examples of the material for use in the protection layer include amABS resin, anACS resins, an olefin-vinyl monomer copolymer, chlorinated polyether, an aryl resin, a phenolic resin, polyacetal, polyamide, polyamideimide, polyallylsulfone, polybutylene, polybutyleneterephthalate, polycarbonate, polyarylate, polyethersulfone, polyethylene, polyethyleneterephthalate, polyimide, an acrylic resin, polymethylpentene, polypropylene, polyphenyleneoxide, polysulfone, polystyrene, an AS resin, a butadiene-styrene copolymer, polyurethane, polyvinyl chloride, polyvinylidene chloride, an epoxy resin, etc. Among these resins, polycarbonate and polyarylate are preferably used.

In addition, in order to improve the abrasion resistance of the protection layer, fluorine-containing resins such as polytetrafluoroethylene, and silicone resins can be used therefor. Further, materials in which such resins as mentioned above are mixed with an inorganic filler such as titanium oxide, aluminum oxide, tin oxide, zinc oxide, zirconium oxide, magnesium oxide, potassium titanate and silica or an organic filler can also be used therefor.

Suitable organic fillers for use in the protection layer include powders of fluorine-containing resins such as polytetrafluoroethylene, silicone resin powders, amorphous carbon powders, etc. Specific examples of the inorganic fillers for use in the protection layer include powders of metals such as copper, tin, aluminum and indium; metal oxides such as alumina, silica, tin oxide, zinc oxide, titanium oxide, alumina, zirconia, indium oxide, antimony oxide, bismuth oxide, calcium oxide, tin oxide doped with antimony, indium oxide doped with tin; potassium titanate, etc. In view of hardness, the inorganic fillers are preferable, and in particular, silica, titanium oxide and alumina are effectively used.

The content of the filler in the protection layer is preferably determined depending on the species of the filler used and the application of the resultant photoreceptor, but the content of a filler in the surface part of the protection layer is preferably not less than 5% by weight, more preferably from 10 to 50% by weight, and even more preferably from 10 to 30% by weight, based on the total weight of the surface part of the protection layer. The filler included in the protection layer preferably has a volume average particle diameter of from 0.1 to 2 μm, and more preferably from 0.3 to 1 μm. When the average particle diameter is too small, good abrasion resistance cannot be imparted to the resultant photoreceptor. In contrast, when the average particle diameter is too large, the surface of the resultant protection layer is seriously roughened or a problem that a protection layer itself cannot be formed occurs.

In the present application, the average particle diameter of a filler means a volume average particle diameter unless otherwise specified, and is measured using an instrument, CAPA-700 manufactured by Horiba Ltd. In this case, the cumulative 50% particle diameter (i.e., the median particle diameter) is defined as the average particle diameter. In addition, it is preferable that the standard deviation of the particle diameter distribution curve of the filler used in the protection layer is not greater than 1 μm. When the standard deviation is too large (i.e., when the filler has too broad particle diameter distribution), the effect of the present invention cannot be produced.

The pH of the filler used in the protection layer coating liquid largely influences on the dispersibility of the filler therein and the resolution of the images produced by the resultant photoreceptor. The reasons therefor are as follows. Fillers (in particular, metal oxides) typically include hydrochloric acid therein which is used when the fillers are produced. When the amount of residual hydrochloric acid is large, the resultant photoreceptor tends to produce blurred images. In addition, inclusion of too large an amount of hydrochloric acid causes the dispersibility of the filler to deteriorate.

Another reason therefor is that the charge properties of fillers (in particular, metal oxides) are largely influenced by the pH of the fillers. In general, particles dispersed in a liquid are charged positively or negatively. In this case, ions having a charge opposite to the charge of the particles gather around the particles to neutralize the charge of the particles, resulting in formation of an electric double layer, and thereby the particles are stably dispersed in the liquid. The potential (i.e., zeta potential) of a point around one of the particles decreases (i.e., approaches to zero) as the distance between the point and the particle increases. Namely, a point far apart from the particle is electrically neutral, i.e., the zeta potential thereof is zero. In this case, the higher the zeta potential, the better the dispersion of the particles. When the zeta potential is nearly equal to zero, the particles easily aggregate (i.e., the particles are unstably dispersed). The zeta potential of a system largely depends on the pH of the system. When the system has a certain pH, the zeta potential becomes zero. This pH point is called an isoelectric point. It is preferable to increase the zeta potential by setting the pH of the system to be far apart from the isoelectric point, in order to enhance the dispersion stability of the system.

It is preferable for the protection layer to include a filler having an isoelectric point at a pH of 5 or more, in order to prevent formation of blurred images. In other words, fillers having a highly basic property can be preferably used in the photoreceptor of the present invention because the effect of the present invention can be heightened. Fillers having a highly basic property have a high zeta potential (i.e., the fillers are stably dispersed) when the system for which the fillers are used is acidic.

In this application, the pH of a filler means the pH of the filler at the isoelectric point, which is determined by the zeta potential of the filler. Zeta potential can be measured by a laser beam potential meter manufactured by Ootsuka Electric Co., Ltd.

In addition, in order to prevent production of blurred images, fillers having a high electric resistance (i.e., not less than 1×10¹⁰ Ω·cm in resistivity) are preferably used. Further, fillers having a pH of not less than 5 and fillers having a dielectric constant of not less than 5 can be more preferably used. Fillers having a dielectric constant of not less than 5 and/or a pH of not less than 5 can be used alone or in combination. In addition, combinations of a filler having a pH of not less than 5 and a filler having a pH of less than 5, or combinations of a filler having a dielectric constant of not less than 5 and a filler having a dielectric constant of less than 5, can also be used. Among these fillers, α-alumina having a closest packing structure is preferably used. This is because α-alumina has a high insulating property, a high heat stability and a good abrasion resistance, and thereby formation of blurred images can be prevented and abrasion resistance of the resultant photoreceptor can be improved.

In the present invention, the resistivity of a filler is defined as follows. The resistivity of a powder such as fillers largely changes depending on the filling factor of the powder when the resistivity is measured. Therefore, it is necessary to measure the resistivity under a constant condition. In the present application, the resistivity is measured by a device similar to the devices disclosed in FIG. 1 of 5-113688. The surface area of the electrodes of the device is 4.0 cm². Before the resistivity of a sample powder is measured, a load of 4 kg is applied to one of the electrodes for 1 minute and the amount of the sample powder is adjusted such that the distance between the two electrodes becomes 4 mm. The resistivity of the sample powder is measured by pressing the sample powder only by the weight (i.e., 1 kg) of the upper electrode without applying any other load to the sample. The voltage applied to the sample powder is 100 V. When the resistivity is not less than 10⁶ Ω·cm, HIGH RESISTANCEMETER (from Yokogawa Hewlett-Packard Co.) is used to measure the resistivity. When the resistivity is less than 10⁶ Ω·cm, a digital multimeter (from Fluke Corp.) is used.

The dielectric constant of a filler is measured as follows. A cell similar to that used for measuring the resistivity is also used for measuring the dielectric constant. After a load is applied to a sample powder, the capacity of the sample powder is measured using a dielectric loss measuring instrument (from Ando Electric Co., Ltd.) to determine the dielectric constant of the powder.

The fillers to be included in the protection layer are preferably subjected to a surface treatment using a surface treatment agent in order to improve the dispersion of the fillers in the protection layer. When a filler is poorly dispersed in the protection layer, the following problems occur:

(1) the residual potential of the resultant photoreceptor increases;

(2) the transparency of the resultant protection layer decreases;

(3) coating defects are formed in the resultant protection layer;

(4) the abrasion resistance of the protection layer deteriorates;

(5) the durability of the resultant photoreceptor deteriorates; and

(6) the image qualities of the images produced by the resultant photoreceptor deteriorate.

Suitable surface treatment agents include known surface treatment agents. However, surface treatment agents which can maintain the highly insulating property of the fillers used are preferably used. As for the surface treatment agents, titanate coupling agents, aluminum coupling agents, zircoaluminate coupling agents, higher fatty acids, combinations of these agents with a silane coupling agent, Al2O3, TiO2, ZrO2, silicones, aluminum stearate, and the like, can be preferably used to improve the dispersibility of fillers and to prevent formation of blurred images. These materials can be used alone or in combination. When fillers treated with a silane coupling agent are used, the resultant photoreceptor tends to produce blurred images. However, combinations of a silane coupling agent with one of the surface treatment agents mentioned above can often produce good images without blurring. The coating weight of the surface treatment agents is preferably from 3 to 30% by weight, and more preferably from 5 to 20% by weight, based on the weight of the filler to be treated, although the weight is determined depending on the average primary particle diameter of the filler. When the content of the surface treatment agent is too low, the dispersibility of the filler cannot be improved. In contrast, when the content is too high, the residual potential of the resultant photoreceptor seriously increases. These fillers can be dispersed using a proper dispersion machine. In this case, the fillers are preferably dispersed such that the aggregated particles are dissociated and primary particles of the fillers are dispersed, to improve the transparency of the resultant protection layer.

In addition, a CTM can be included in the protection layer to enhance the photo response and to reduce the residual potential of the resultant photoreceptor. The CTMs mentioned above for use in the charge transport layer can also be used for the protection layer. When a low molecular weight CTM is used for the protection layer, the concentration of the CTM may be changed in the thickness direction of the protection layer. Specifically, it is preferable to reduce the concentration of the CTM at the surface part of the protection layer in order to improve the abrasion resistance of the resultant photoreceptor. At this point, the concentration of the CTM means the ratio of the weight of the CTM to the total weight of the protection layer.

It is preferable to use one or more of the charge transport polymers mentioned above for use in the CTL for the protection layer in order to improve the durability and high speed charge transportability of the photoreceptor.

The protection layer can be formed by any known coating methods. The thickness of the protection layer is preferably from 0.1 to 10 μm.

Next, the crosslinked protection layer will be explained. The crosslinked protection layer is preferably prepared by subjecting a reactive monomer having plural crosslinkable functional groups in a molecule to a crosslinking reaction upon application of light or heat thereto. By forming a protection layer having such a three-dimensional network, the photoreceptor has good abrasion resistance.

In order to prepare the above-mentioned protection layer, monomers having a charge transportable moiety in the entire part or a part thereof are preferably used. By using such monomers, the resultant protection layer has the charge transport moiety in the three-dimensional network. Therefore, the CTL can fully exercise a charge transport function. Among the monomers, monomers having a triarylamine structure are preferably used.

The protection layer having such a three-dimensional structure has good abrasion resistance but often forms a crack therein if the layer is too thick. In order to prevent occurrence of such cracking problem, a multi-layered protection layer in which a crosslinked protection layer is formed on a protection layer in which a low molecular CTM is dispersed in a polymer can be used.

The crosslinked protection layer having a charge transport structure is preferably prepared by reacting and crosslinking a radical polymerizable tri- or more-functional monomer having no charge transport structure and a radical polymerizable monofunctional monomer having a charge transport structure. This protection layer has high hardness and high elasticity because of having a well-developed three dimensional network and a high crosslinking density. In addition, since the surface of the protection layer is uniform and smooth, the protection layer has good abrasion resistance and scratch resistance. Although it is important to increase the crosslinking density of the protection layer, a problem in that the protection layer has a high internal stress due to shrinkage in the crosslinking reaction tends to occur. The internal stress increases as the thickness of the protection layer increases. Therefore, when a thick protection layer is crosslinked, problems in that the protection layer is cracked and peeled occur. Even though these problems are not caused when a photoreceptor is new, the problems are easily caused when the photoreceptor receives various stresses after being repeatedly subjected to charging, developing, transferring and cleaning.

In order to prevent occurrence of the problems, the following techniques can be used:

(1) a polymeric component is added to the crosslinked protection layer;

(2) a large amount of mono- or di-functional monomers are used for forming the crosslinked protection layer; and

(3) a polyfunctional monomer having a group capable of imparting softness to the resultant crosslinked protection layer is used for forming the crosslinked protection layer. However, all the crosslinked protection layers prepared using these techniques have a low crosslinking density. Therefore, a good abrasion resistance cannot be imparted to the resultant protection layers. In contrast, the crosslinked protection layer of the photoreceptor for use in the present invention has a well-developed three-dimensional network, a high crosslinking density and a high charge transporting ability when having a thickness of from 1 to 10 μm. Therefore, the resultant photoreceptor has high abrasion resistance and hardly causes cracking and peeling problems. The thickness of the crosslinked protection layer is preferably from 2 to 8 μm. In this case, the margin for the above-mentioned problems can be improved and flexibility in choosing materials for forming a protection layer having a higher crosslinking density can be enhanced.

The reasons why the photoreceptor for use in the present invention hardly causes the cracking and peeling problems are as follows.

(1) a relatively thin crosslinked protection layer having a charge transport structure is formed and thereby increase of internal stress of the photoreceptor can be prevented; and

(2) since a CTL is formed below the crosslinked protection layer having a charge transport structure, the internal stress of the crosslinked protection layer can be relaxed.

Therefore, it is not necessary to increase the amount of polymer components in the protection layer. Accordingly, occurrence of problems in that the protection layer is scratched or a film (such as a toner film) is formed on the protection layer, which is caused by incomplete mixing of polymer components and the crosslinked material formed by reaction of radical polymerizable monomers, can be prevented. In addition, when a protection layer is crosslinked by irradiating light, a problem in that the inner part of the protection layer is incompletely reacted because the charge transport moieties absorb light occurs if the protection layer is too thick. However, since the protection layer of the photoreceptor for use in the present invention has a thickness of not greater than 10 μm, the inner part of the protection layer can be completely crosslinked and thereby a good abrasion resistance can be imparted to the entire protection layer. Further, since the crosslinked protection layer is prepared using a monofunctional monomer having a charge transport structure, the monofunctional monomer is incorporated in the crosslinking bonds formed by one or more tri- or more-functional monomers. When a crosslinked protection layer is formed using a low molecular weight CTM having no functional group, a problem in that the low molecular weight CTM is separated from the crosslinked resin, resulting in precipitation of the low molecular weight CTM and formation of a clouded protection layer, and thereby the mechanical strength of the protection layer is deteriorated. When a crosslinked protection layer is formed using di- or more-functional charge transport compounds as main components, the resultant protection layer is seriously distorted, resulting in increase of internal stress, because the charge transfer moieties are bulky, although the protection layer has a high crosslinking density.

Further, the photoreceptor of the present invention has good electric properties, good stability, and high durability. This is because the crosslinked protection layer has a structure in that a unit obtained from a monofunctional monomer having a charge transport structure is connected with the crosslinking bonds like a pendant. In contrast, the protection layer formed using a low molecular weight CTM having no functional group causes the precipitation and clouding problems, and thereby the photosensitivity of the photoreceptor is deteriorated and residual potential of the photoreceptor is increased (i.e., the photoreceptor has poor electric properties). In addition, in the crosslinked protection layer formed using di- or more-functional charge transport compounds as main components, the charge transport moieties are fixed in the crosslinked network, and thereby charges are trapped, resulting in deterioration of photosensitivity and increase of residual potential. When such electric properties of a photoreceptor are deteriorated, problems in that the resultant images have low image density and character images are narrowed occur. Since a CTL having a high mobility and few charge traps can be formed as the CTL of the photoreceptor of the present invention, production of side effects in electric properties of the photoreceptor can be prevented even when the crosslinked protection layer is formed on the CTL.

Further, the crosslinked protection layer of the present invention is insoluble in organic solvents and typically has an excellent abrasion resistance. The crosslinked protection layer prepared by reacting a tri- or more-functional polymerizable monomer having no charge transport structure with a monofunctional monomer having a charge transport structure has a well-developed three-dimensional network and a high crosslinking density. However, in a case where materials (such as mono- or di-functional monomers, polymer binders, antioxidants, leveling agents, and plasticizers) other than the above-mentioned polymerizable monomers are added and/or the crosslinking conditions are changed, problems in that the crosslinking density of the resultant protection layer is locally low and the resultant protection layer is constituted of aggregates of minute crosslinked material having a high crosslinking density tend to occur. Such a crosslinked protection layer has poor mechanical strength and poor resistance to organic solvents. Therefore, when the photoreceptor is repeatedly used, a problem in that a part of the protection layer is seriously abraded or is released from the protection layer occurs. In contrast, the crosslinked protection layer for use in the present photoreceptor has high molecular weight and good solvent resistance because of having a well-developed three dimensional network and a high crosslinking density. Therefore, the resultant photoreceptor has excellent abrasion resistance and does not cause the above-mentioned problems.

Then the constituents of the coating liquid for forming the crosslinked protection layer having a charge transport structure will be explained.

The tri- or more-functional monomers having no charge transport structure mean monomers which have three or more radical polymerizable groups and which do not have a charge transport structure (such as a positive hole transport structure (e.g., triarylamine, hydrazone, pyrazoline and carbazole structures); and an electron transport structure (e.g., condensed polycyclic quinine structure, diphenoquinone structure, a cyano group and a nitro group)). As the radical polymerizable groups, any radical polymerizable groups having a carbon-carbon double bond can be used. Suitable radical polymerizable groups include 1-substituted ethylene groups and 1,1-substituted ethylene groups having the following formulae, respectively.

### 1-Substituted Ethylene Groups

CH₂═CH—X₁—

wherein X₁ represents an arylene group (such as a phenylene group and a naphthylene group), which optionally has a substituent, a substituted or unsubstituted alkenylene group, a —CO— group, a —COO— group, a-CON(R¹⁰) group (wherein R¹⁰ represents a hydrogen atom, an alkyl group (e.g., a methyl group, and an ethyl group), an aralkyl group (e.g., a benzyl group, a naphthylmethyl group and a phenetyl group) or an aryl group (e.g., a phenyl group and a naphthyl group), or a —S— group.

Specific examples of the groups having the formula include a vinyl group, a styryl group, 2-methyl-1,3-butadienyl group, a vinylcarbonyl group, acryloyloxy group, acryloylamide, vinyl thioether, etc.

### 1,1-Substituted Ethylene Groups

CH₂═C(Y)—X₂—

wherein Y represents a substituted or unsubstituted alkyl group, a substituted or unsubstituted aralkyl group, a substituted or unsubstituted aryl group (such as phenyl and naphthyl groups), a halogen atom, a cyano group, a nitro group, an alkoxyl group (such as methoxy and ethoxy groups), or a —COOR¹ group (wherein R¹¹ represents a hydrogen atom, a substituted or unsubstituted alkyl group (such as methyl and ethyl groups), a substituted or unsubstituted aralkyl group (such as benzyl and phenethyl groups), a substituted or unsubstituted aryl group (such as phenyl and naphthyl groups) or a —CONR¹²R¹³ group (wherein each of R¹² and R¹³ represents a hydrogen atom, a substituted or unsubstituted alkyl group (such as methyl and ethyl groups), a substituted or unsubstituted aralkyl group (such as benzyl, naphthylmethyl and phenethyl groups), a substituted or unsubstituted aryl group (such as phenyl and naphthyl groups); and X₂ represents a group selected from the groups mentioned above for use in X₁ and an alkylene group, wherein at least one of Y and X₂ is an oxycarbonyl group, a cyano group, an alkenylene group or an aromatic group.

Specific examples of the groups having formula (XI) include an α-chloroacryloyloxy group, a methacryloyloxy group, an α-cyanoethylene group, an α-cyanoacryloyloxy group, an α-cyanophenylene group, a methacryloylamino group, etc.

Specific examples of the substituents for use in the groups X₁, X₂ and Y include halogen atoms, a nitro group, a cyano group, alkyl groups (such as methyl and ethyl groups), alkoxy groups (such as methoxy and ethoxy groups), aryloxy groups (such as a phenoxy group), aryl groups (such as phenyl and naphthyl groups), aralkyl groups (such as benzyl and phenethyl groups), etc.

Among these radical polymerizable tri- or more-functional groups, acryloyloxy groups and methacryloyloxy groups having three or more functional groups are preferably used. Compounds having three or more acryloyloxy groups can be prepared by subjecting (meth) acrylic acid (salts), (meth)acrylhalides and (meth)acrylates, which have three or more hydroxyl groups, to an ester reaction or an ester exchange reaction. The three or more radical polymerizable groups included in a radical polymerizable tri- or more-functional monomer are the same as or different from the others therein.

Specific examples of the radical polymerizable tri- or more-functional monomer include, but are not limited to, trimethylolpropane triacrylate (TMPTA), trimethylolpropane trimethacrylate, trimethylolpropane alkylene-modified triacrylate, trimethylolpropane ethyleneoxy-modified triacrylate, trimethylolpropane propyleneoxy-modified triacrylate, trimethylolpropane caprolactone-modified triacrylate, trimethylolpropane alkylene-modified trimethacrylate, pentaerythritol triacrylate, pentaerythritol tetraacrylate (PETTA), glycerol triacrylate, glycerol epichlorohydrin-modified triacrylate, glycerol ethyleneoxy-modified triacrylate, glycerol propyleneoxy-modified triacrylate, tris(acryloxyethyl)isocyanurate, dipentaerythritol hexaacrylate (DPHA), dipentaerythritol caprolactone-modified hexaacrylate, dipentaerythritol hydroxypentaacrylate, alkylated dipentaerythritol tetraacrylate, alkylated dipentaerythritol triacrylate, dimethylolpropane tetraacrylate (DTMPTA), pentaerythritol ethoxytriacrylate, ethyleneoxy-modified triacryl phosphate, 2,2,5,5-tetrahydroxymethylcyclopentanone tetraacrylate, etc. These monomers are used alone or in combination.

In order to form a dense crosslinked network in the crosslinked protection layer, the ratio (Mw/F) of the molecular weight (Mw) of the tri- or more-functional monomer to the number of functional groups (F) included in a molecule of the monomer is preferably not greater than 250. When the number is too large, the resultant protective becomes soft and thereby the abrasion resistance of the layer slightly deteriorates. In this case, it is not preferable to use only one monomer having a functional group having a long chain group such as ethylene oxide, propylene oxide and caprolactone. The content of the unit obtained from the tri- or more-functional monomers in the crosslinked protection layer is preferably from 20 to 80% by weight, and more preferably from 30 to 70% by weight based on the total weight of the protection layer When the content is too low, the three dimensional crosslinking density is low, and thereby good abrasion resistance cannot be imparted to the protection layer. In contrast, when the content is too high, the content of the charge transport compound decreases, good charge transport property cannot be imparted to the protection layer. In order to balance the abrasion resistance and charge transport property of the crosslinked protection layer, the content of the unit obtained from the tri- or more-functional monomers in the protection layer is preferably from 30 to 70% by weight.

Suitable radical polymerizable monofunctional monomers having a charge transport structure for use in preparing the crosslinked protection layer include compounds having one radical polymerizable functional group and a charge transport structure such as positive hole transport groups (e.g., triarylamine, hydrazone, pyrazoline and carbazole structures) and electron transport groups (e.g., electron accepting aromatic groups such as condensed polycyclic quinine structure, diphenoquinone structure, and cyano and nitro groups). As the functional group of the radical polymerizable monofunctional monomers, acryloyloxy and methacryloyloxy groups are preferably used. Among the charge transport groups, triarylamine groups are preferably used. Among the compounds having a triarylamine group, compounds having the following formula (1) or (2) are preferably used because of having good electric properties (i.e., high photosensitivity and low residual potential).

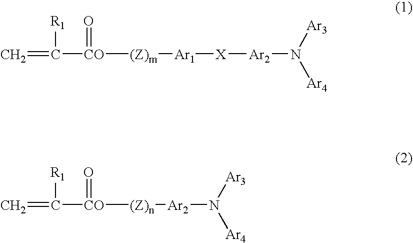

wherein R₁ represents a hydrogen atom, a halogen atom, a substituted or an unsubstituted alkyl group, a substituted or an unsubstituted aralkyl group, a substituted or an unsubstituted aryl group, a cyano group, a nitro group, an alkoxy group, —COOR₇ wherein R₇ represents a hydrogen atom, a halogen atom, a substituted or an unsubstituted alkyl group, a substituted or an unsubstituted aralkyl group and a substituted or an unsubstituted aryl group and a halogenated carbonyl group or CONR₈R₉ wherein R₈ and R₉ independently represent a hydrogen atom, a halogen atom, a substituted or an unsubstituted alkyl group, a substituted or an unsubstituted aralkyl group and a substituted or an unsubstituted aryl group; Ar₁ and Ar₂ independently represent a substituted or an unsubstituted arylene group; Ar₃ and Ar₄ independently represent a substituted or an unsubstituted aryl group; X represents a single bond, a substituted or an unsubstituted alkylene group, a substituted or an unsubstituted cycloalkylene group, a substituted or an unsubstituted alkyleneether group, an oxygen atom, a sulfur atom and vinylene group; Z represents a substituted or an unsubstituted alkylene group, a substituted or an unsubstituted alkyleneether group and alkyleneoxycarbonyl group; and m and n represent 0 and an integer of from 1 to 3.

In the formulae (1) and (2), among substituted groups of R₁, the alkyl groups include methyl groups, ethyl groups, propyl groups, butyl groups, etc.; the aryl groups include phenyl groups, naphtyl groups, etc.; aralkyl groups include benzyl groups, phenethyl groups, naphthylmethyl groups, etc.; and alkoxy groups include methoxy groups, ethoxy groups, propoxy groups, etc. These may be substituted by alkyl groups such as halogen atoms, nitro groups, cyano groups, methyl groups and ethyl groups; alkoxy groups such as methoxy groups and ethoxy groups; aryloxy groups such as phenoxy groups; aryl groups such as phenyl groups and naphthyl groups; aralkyl groups such as benzyl groups and phenethyl groups.

The substituted group of R₁ is preferably a hydrogen atom or a methyl group.

Ar₃ and Ar₄ independently represent a substituted or an unsubstituted aryl group, and specific examples thereof include condensed polycyclic hydrocarbon groups, non-condensed cyclic hydrocarbon groups and heterocyclic groups.

The condensed polycyclic hydrocarbon group is preferably a group having 18 or less carbon atoms forming a ring such as a fentanyl group, a indenyl group, a naphthyl group, an azulenyl group, a heptalenyl group, a biphenylenyl group, an As-indacenyl group, a fluorenyl group, an acenaphthylenyl group, a praadenyl group, an acenaphthenyl group, a phenalenyl group, a phenantolyl group, an anthryl group, a fluoranthenyl group, an acephenantolylenyl group, an aceanthrylenyl group, a triphenylel group, a pyrenyl group, a crycenyl group and a naphthacenyl group.

Specific examples of the non-condensed cyclic hydrocarbon groups and heterocyclic groups include monovalent groups of monocyclic hydrocarbon compounds such as benzene, diphenylether, polyethylenediphenylether, diphenylthioether, and diphenylsulfone; monovalent groups of non-condensed hydrocarbon compounds such as biphenyl, polyphenyl, diphenylalkane, diphenylalkene, diphenylalkine, triphenylmethane, distyrylbenzene, 1,1-diphenylcycloalkane, polyphenylalkane and polyphenylalkene; and monovalent groups of ring gathering hydrocarbon compounds such as 9,9-diphenylfluorene.

Specific examples of the heterocyclic groups include monovalent groups such as carbazole, dibenzofuran, dibenzothiophene and oxadiazole.

Specific examples of the substituted or unsubstituted aryl group represented by Ar₃ and Ar₄ include the following groups:

(1) a halogen atom, a cyano group and a nitro group;

(2) a straight or a branched-chain alkyl group having 1 to 12, preferably from 1 to 8, and more preferably from 1 to 4 carbon atoms, and these alkyl groups may further include a fluorine atom, a hydroxyl group, a cyano group, an alkoxy group having 1 to 4 carbon atoms, a phenyl group or a halogen atom, an alkyl group having 1 to 4 carbon atoms or a phenyl group substituted by an alkoxy group having 1 to 4 carbon atoms. Specific examples of the alkyl groups include methyl groups, ethyl groups, n-butyl groups, i-propyl groups, t-butyl groups, s-butyl groups, n-propyl groups, trifluoromethyl groups, 2-hydroxyethyl groups, 2-ethoxyethyl groups, 2-cyanoethyl groups, 2-methocyethyl groups, benzyl groups, 4-chlorobenzyl groups, 4-methylbenzyl groups, 4-phenylbenzyl groups, etc.

(3) alkoxy groups (—OR₂) wherein R₂ represents an alkyl group specified in (2). Specific examples thereof include methoxy groups, ethoxy groups, n-propoxy groups, 1-propoxy groups, t-butoxy groups, s-butoxy groups, 1-butoxy groups, 2-hydroxyethoxy groups, benzyloxy groups, trifluoromethoxy groups, etc.

(4) aryloxy groups, and specific examples of the aryl groups include phenyl groups and naphthyl groups. These aryl group may include an alkoxy group having 1 to 4 carbon atoms, an alkyl group having 1 to 4 carbon atoms or a halogen atom as a substituent. Specific examples of the aryloxy groups include phenoxy groups, 1-naphthyloxy groups, 2-naphthyloxy groups, 4-methoxyphenoxy groups, 4-methylphenoxy groups, etc.

(5) alkyl mercapto groups or aryl mercapto groups such as methylthio groups, ethylthio groups, phenylthio groups and p-methylphenylthio groups.

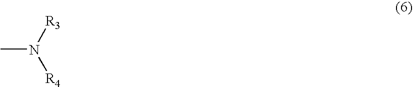

wherein R₃ and R₄ independently represent a hydrogen atom, an alkyl groups specified in (2) and an aryl group, and specific examples of the aryl groups include phenyl groups, biphenyl groups and naphthyl groups, and these may include an alkoxy group having 1 to 4 carbon atoms, an alkyl group having 1 to 4 carbon atoms or a halogen atom as a substituent, and R₃ and R₄ may form a ring together. Specific examples of the groups having this formula include amino groups, diethylamino groups, N-methyl-N-phenylamino groups, N,N-diphenylamino groups, N—N-di(tolyl)amino groups, dibenzylamino groups, piperidino groups, morpholino groups, pyrrolidino groups, etc.

(7) a methylenedioxy group, an alkylenedioxy group such as a methylenedithio group or an alkylenedithio group.

(8) a substituted or an unsubstituted styryl group, a substituted or an unsubstituted β-phenylstyryl group, a diphenylaminophenyl group, a ditolylaminophenyl group, etc.

The arylene group represented by Ar₁ and Ar₂ are derivative divalent groups from the aryl groups represented by Ar₃ and Ar₄.

The above-mentioned X represents a single bond, a substituted or an unsubstituted alkylene group, a substituted or an unsubstituted cycloalkylene group, a substituted or an unsubstituted alkyleneether group, an oxygen atom, a sulfur atom and vinylene group.

The substituted or unsubstituted alkylene group is a straight or a branched-chain alkylene group having 1 to 12, preferably from 1 to 8, and more preferably from 1 to 4 carbon atoms, and these alkylene groups may further includes a fluorine atom, a hydroxyl group, a cyano group, an alkoxy group having 1 to 4 carbon atoms, a phenyl group or a halogen atom, an alkyl group having 1 to 4 carbon atoms or a phenyl group substituted by an alkoxy group having 1 to 4 carbon atoms. Specific examples of the alkylene groups include methylene groups, ethylene groups, n-butylene groups, i-propylene groups, t-butylene groups, s-butylene groups, n-propylene groups, trifluoromethylene groups, 2-hydroxyethylene groups, 2-ethoxyethylene groups, 2-cyanoethylene groups, 2-methocyethylene groups, benzylidene groups, phenylethylene groups, 4-chlorophenylethylene groups, 4-methylphenylethylene groups, 4-biphenylethylene groups, etc.

The substituted or unsubstituted cycloalkylene group is a cyclic alkylene group having 5 to 7 carbon atoms, and these alkylene groups may include a fluorine atom, a hydroxyl group, a cyano group, an alkoxy group having 1 to 4 carbon atoms. Specific examples thereof include cyclohexylidine groups, cyclohexylene groups and 3,3-dimethylcyclohexylidine groups, etc.

Specific examples of the substituted or unsubstituted alkyleneether groups include ethylene oxy, propylene oxy, ethylene glycol, propylene glycol, diethylene glycol, tetraethylene glycol and tripropylene glycol, and the alkylene group of the alkyleneether group may include a substituent such as a hydroxyl group, a methyl group and an ethyl group.

The vinylene group has the following formula:

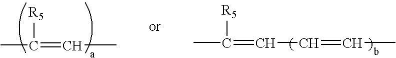

wherein R₅ represents a hydrogen atom, an alkyl group (same as those specified in (2)), an aryl group (same as those represented by Ar₃ and Ar₄); a represents 1 or 2; and b represents 1, 2 or 3.

Z represents a substituted or an unsubstituted alkylene group, a divalent substituted or an unsubstituted alkyleneether group and alkyleneoxycarbonyl group.

Specific examples of the substituted or unsubstituted alkylene group include those of X.

Specific examples of the divalent substituted or unsubstituted alkyleneether group include those of X.

Specific examples of the divalent alkyleneoxycarbonyl group include a divalent caprolactone-modified group.

In addition, the monofunctional radical polymerizing compound having a charge transport structure of the present invention is more preferably a compound having the following formula (3):

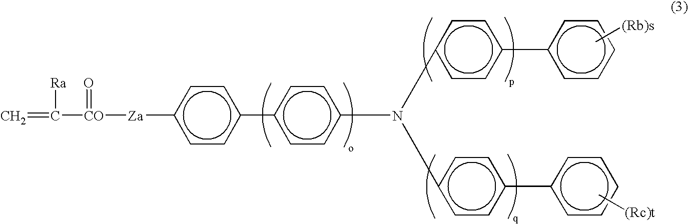

wherein o, p and q independently represent 0 or 1; Ra represents a hydrogen atom or a methyl group; Rb and Rc represents a substituent besides a hydrogen atom and an alkyl group having 1 to 6 carbon atoms, and may be different from each other when having plural carbon atoms; s and t represent 0 or an integer of from 1 to 3; Za represents a single bond, a methylene group, ethylene group,

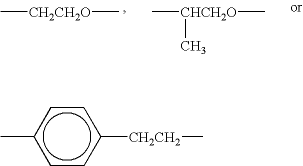

The compound having formula (3) is preferably a compound having an methyl group or a ethyl group as a substituent of Rb and Rc.

The monofunctional radical polymerizing compound having a charge transport structure of the formulae (1), (2) and particularly (3) for use in the present invention does not become an end structure because a double bonding between the carbons is polymerized while opened to the both sides, and is built in a chain polymer. In a crosslinked polymer polymerized with a radical polymerizing monomer having three or more functional groups, the compound is present in a main chain and in a crosslinked chain between the main chains (the crosslinked chain includes an intermolecular crosslinked chain between a polymer and another polymer and an intramolecular crosslinked chain wherein a part having a folded main chain and another part originally from the monomer, which is polymerized with a position apart therefrom in the main chain are polymerized). Even when the compound is present in a main chain or a crosslinked chain, a triarylamine structure suspending from the chain has at least three aryl groups radially located from a nitrogen atom, is not directly bonded with the chain and suspends through a carbonyl group or the like, and is sterically and flexibly fixed although bulky. The triarylamine structures can spatially be located so as to be moderately adjacent to one another in a polymer, and has less structural distortion in a molecule. Therefore, it is supposed that the monofunctional radical polymerizing compound having a charge transport structure in a surface layer of an electrophotographic photoreceptor can have an intramolecular structure wherein blocking of a charge transport route is comparatively prevented.

Specific examples of the monofunctional radical polymerizing compound having a charge transport structure include compounds having the following formulae, but the compounds are not limited thereto.

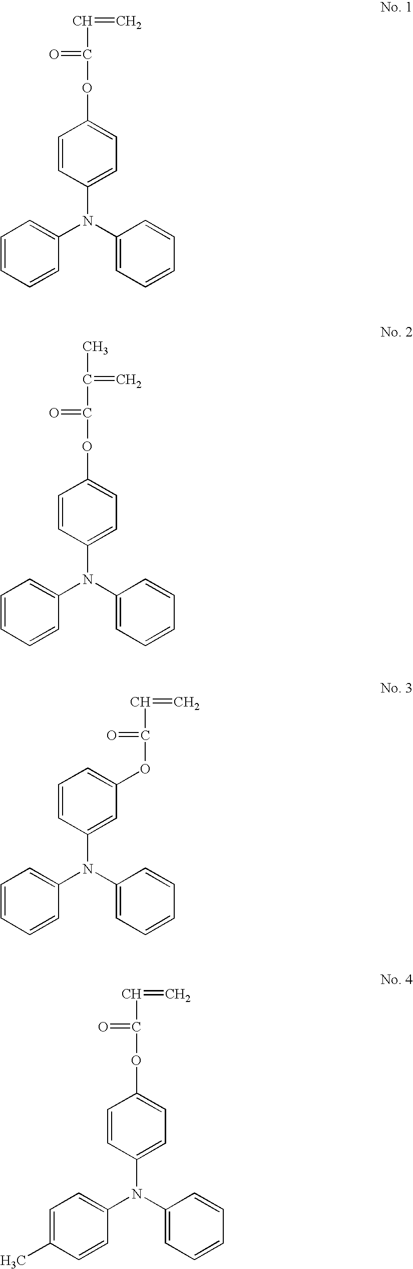

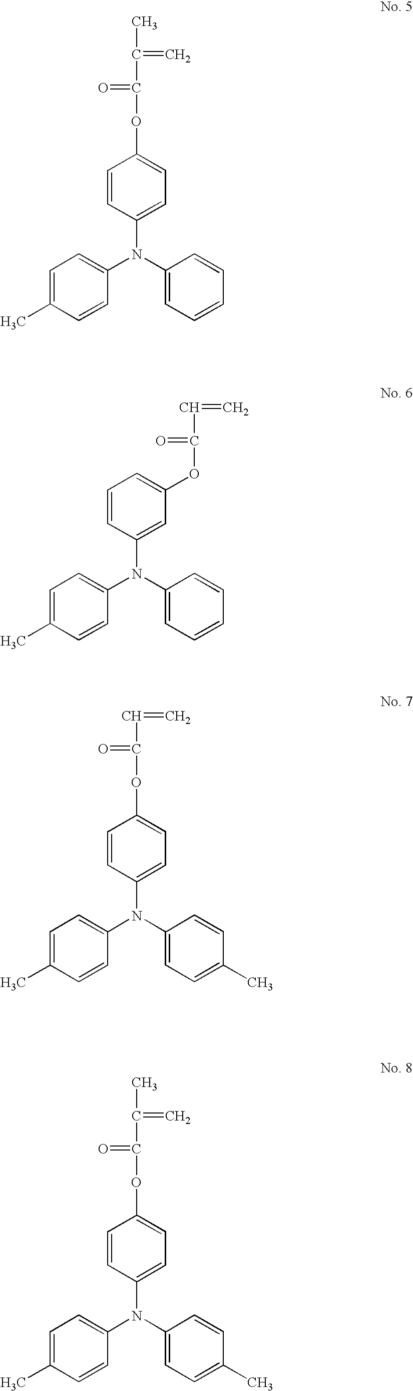

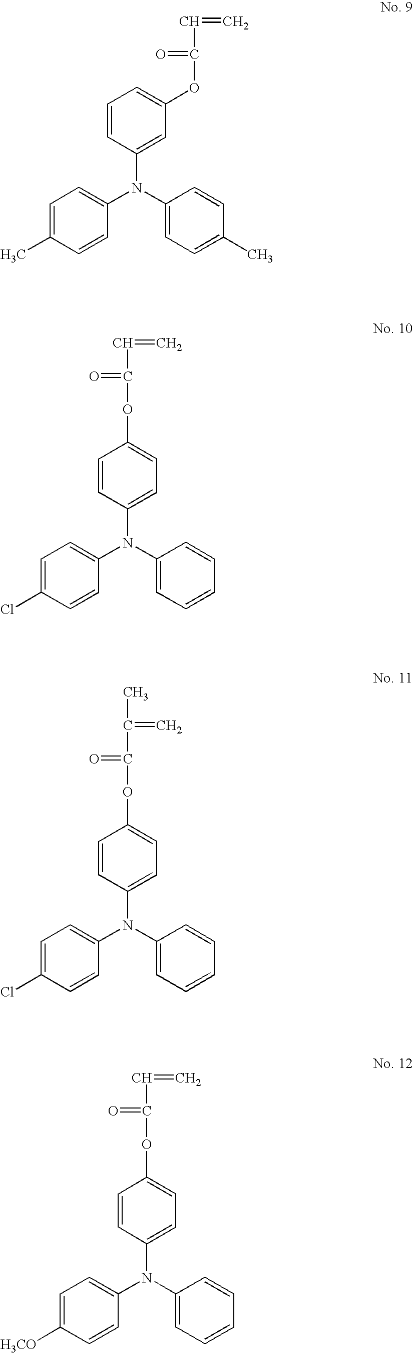

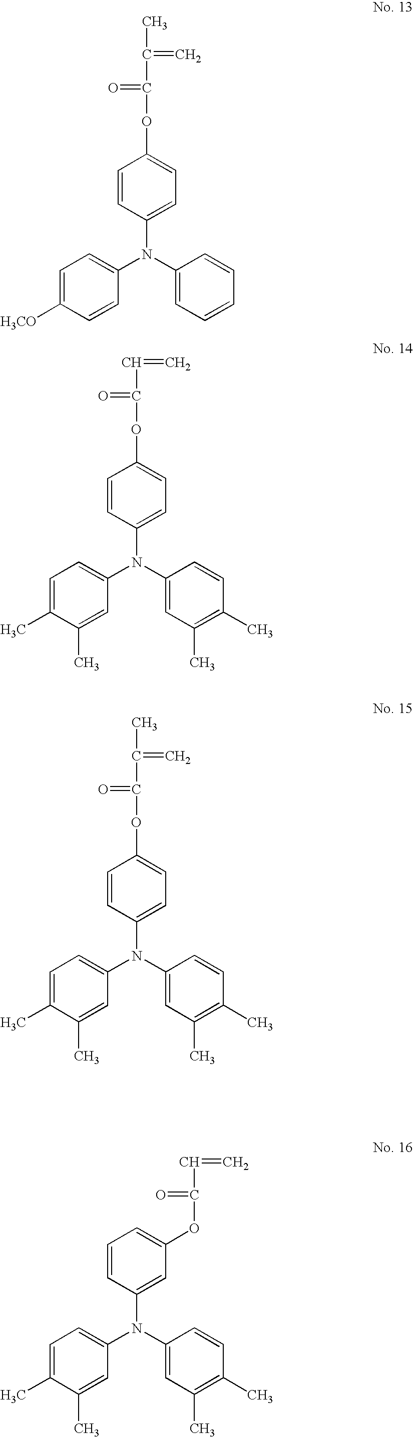

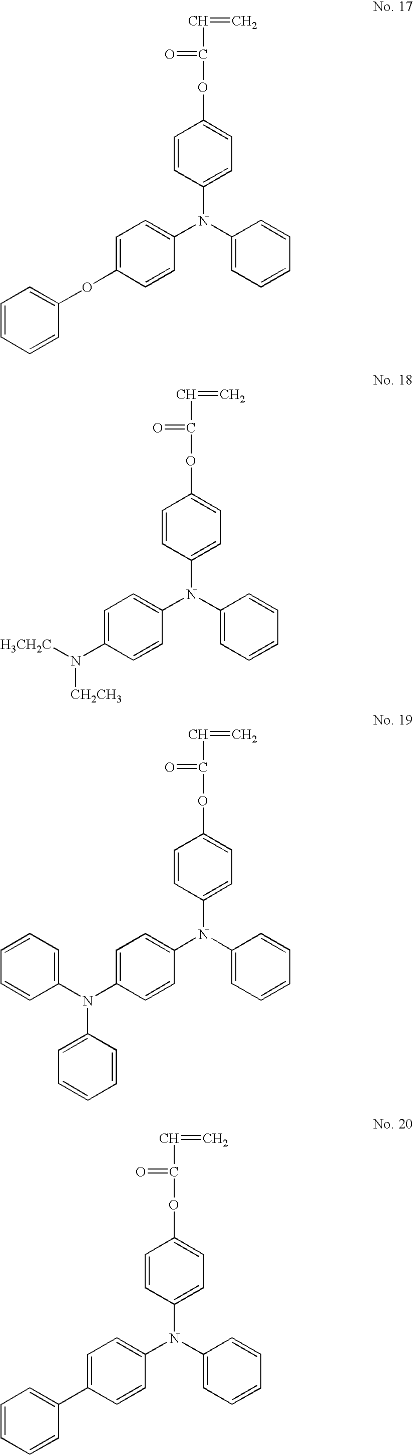

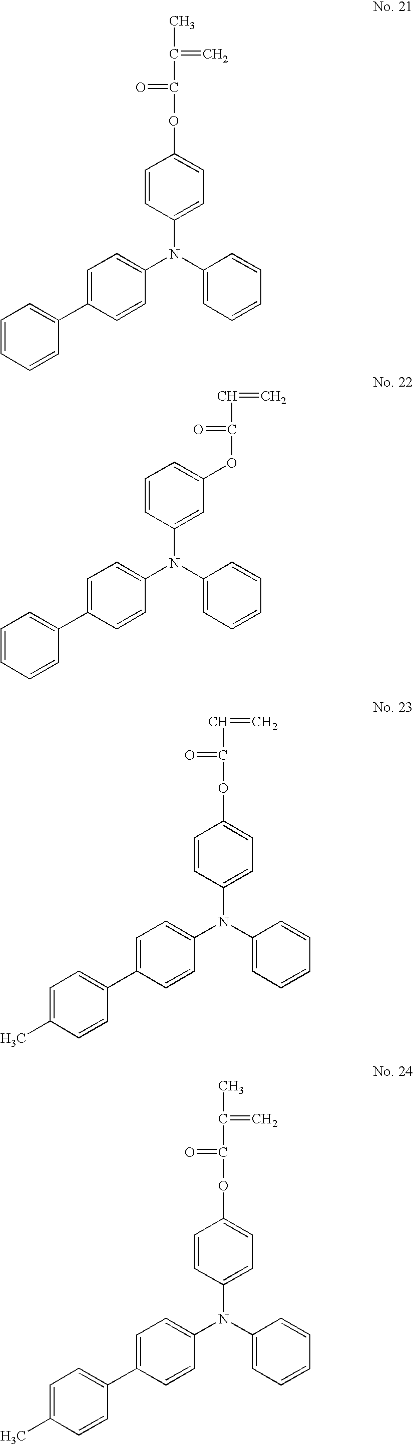

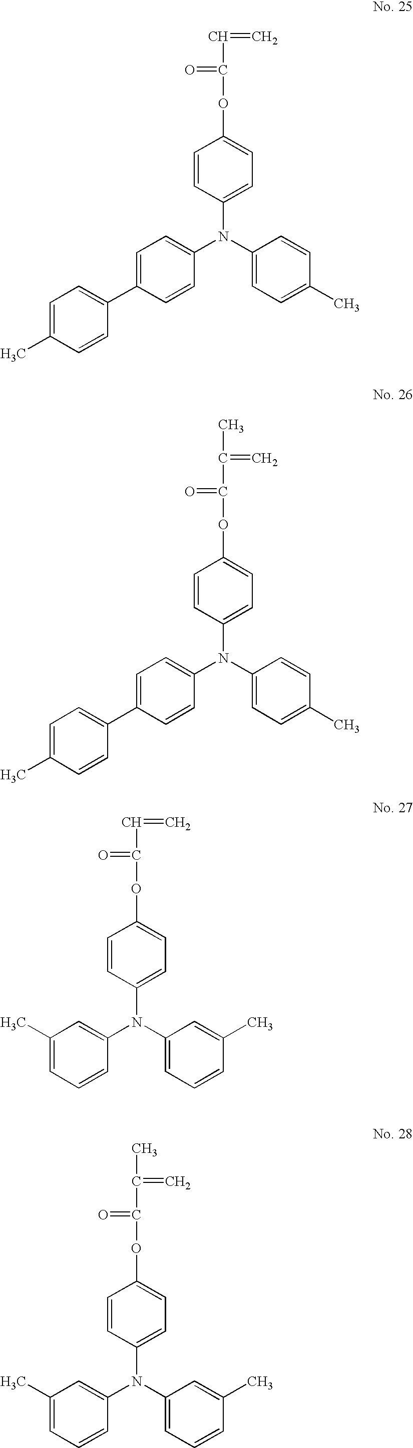

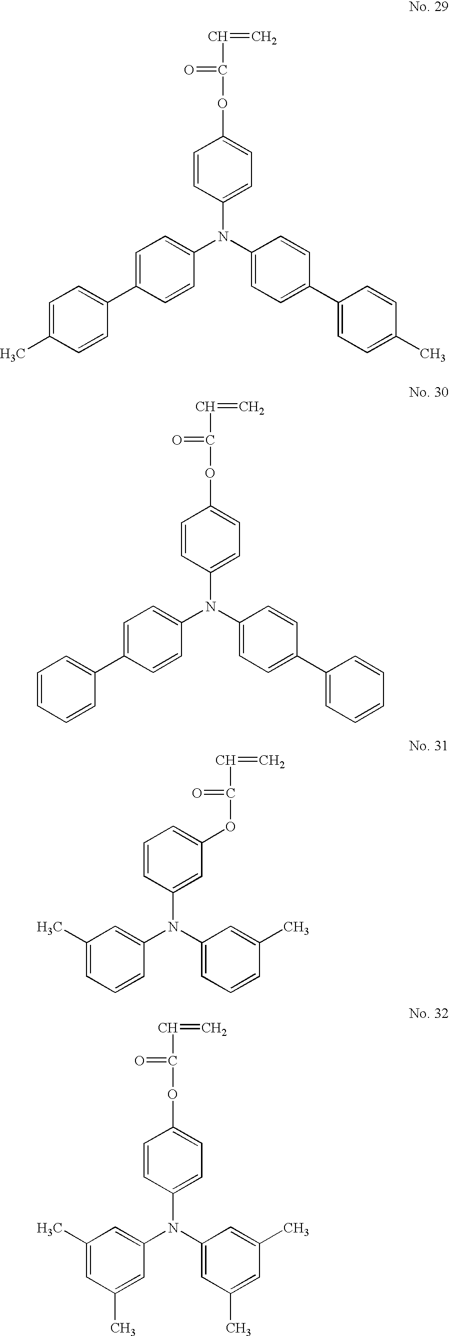

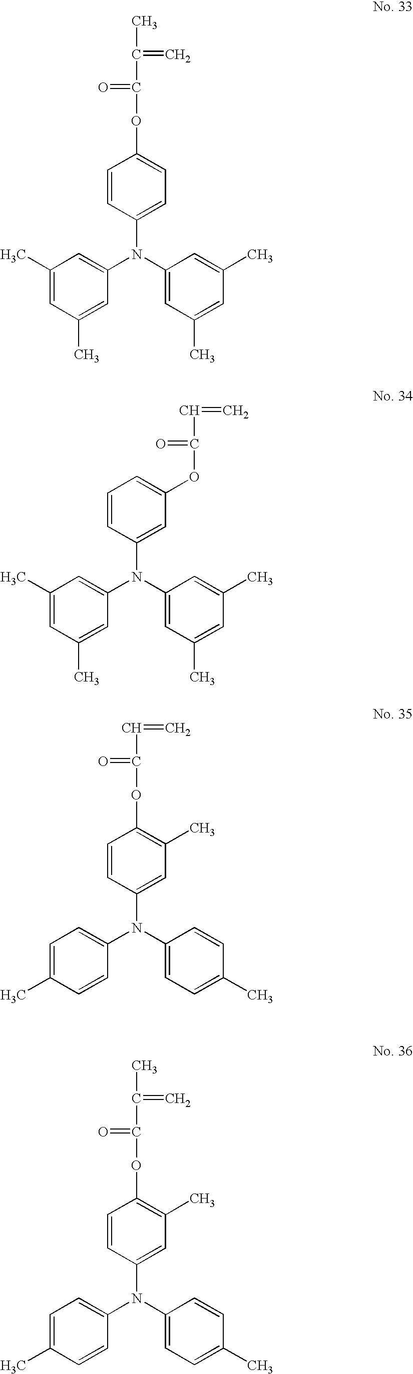

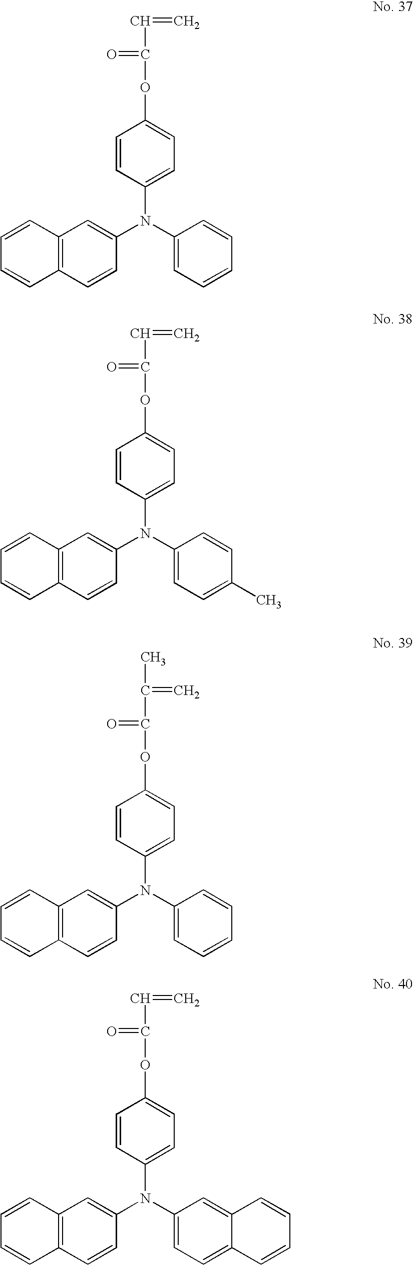

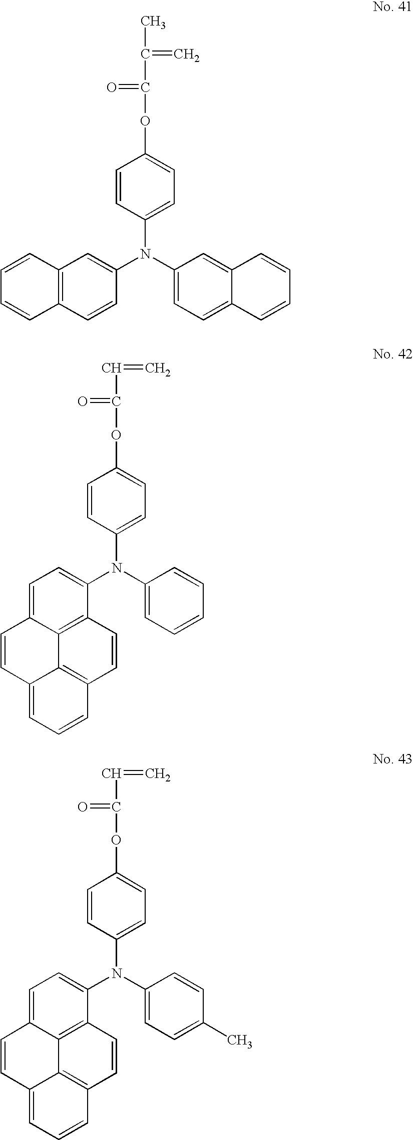

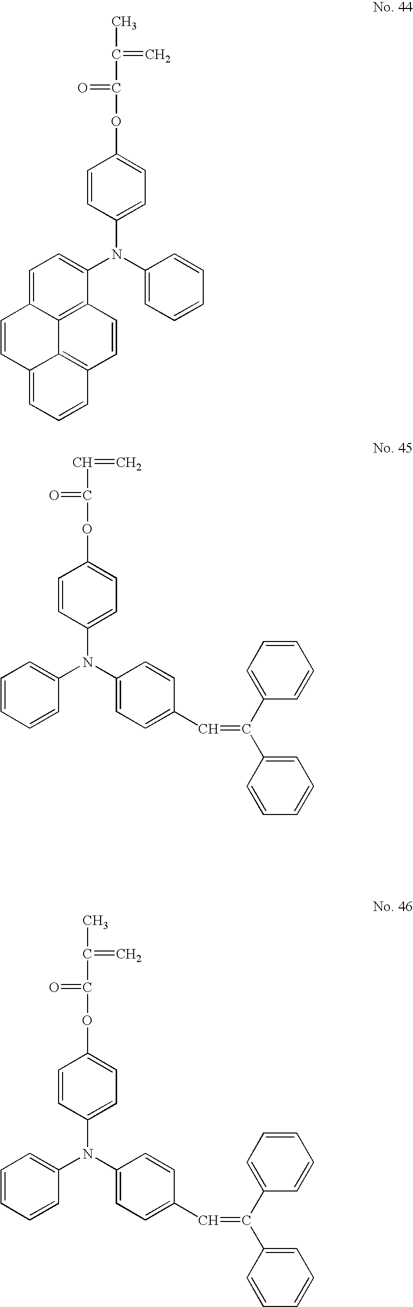

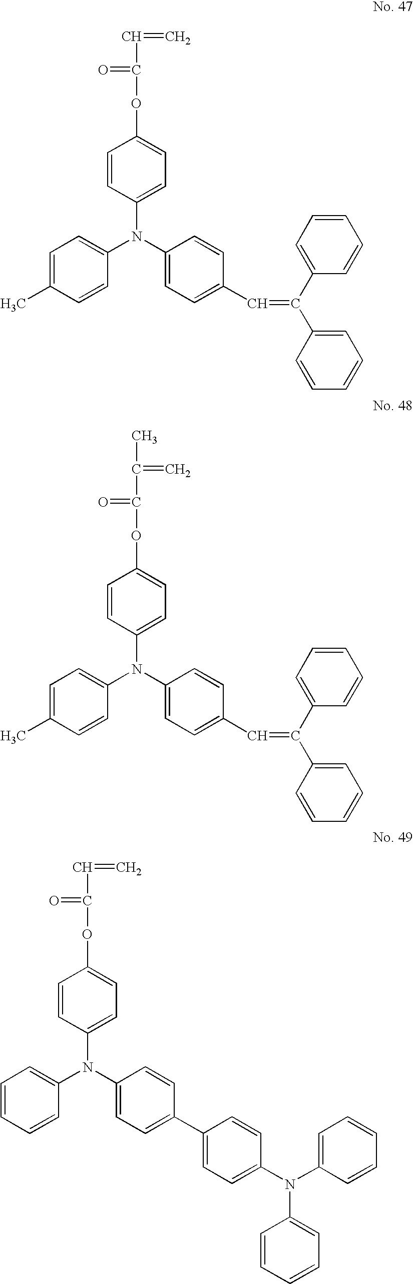

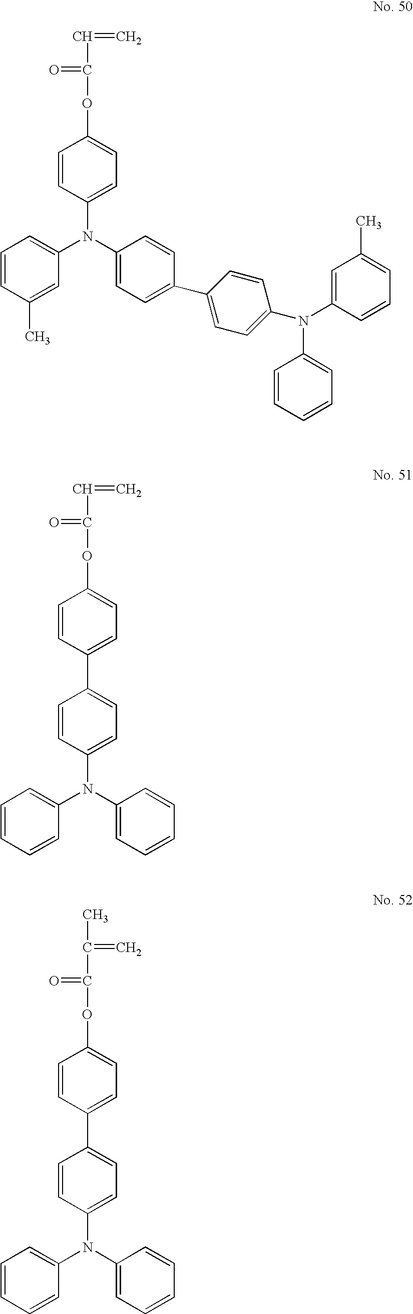

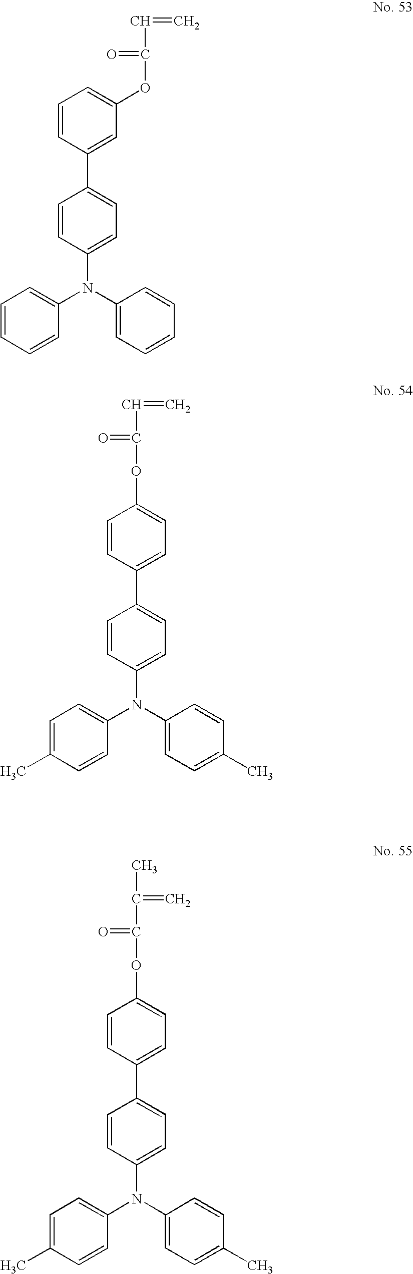

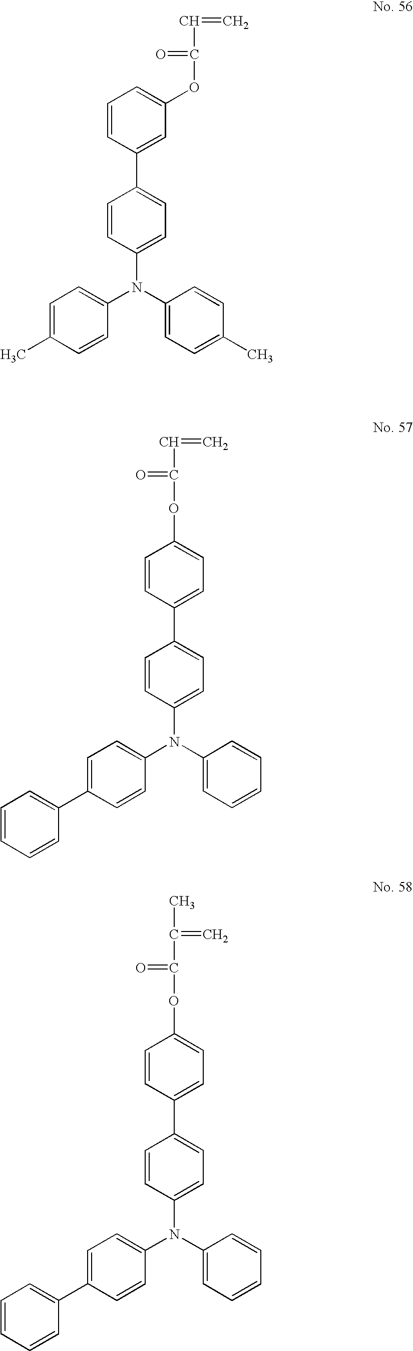

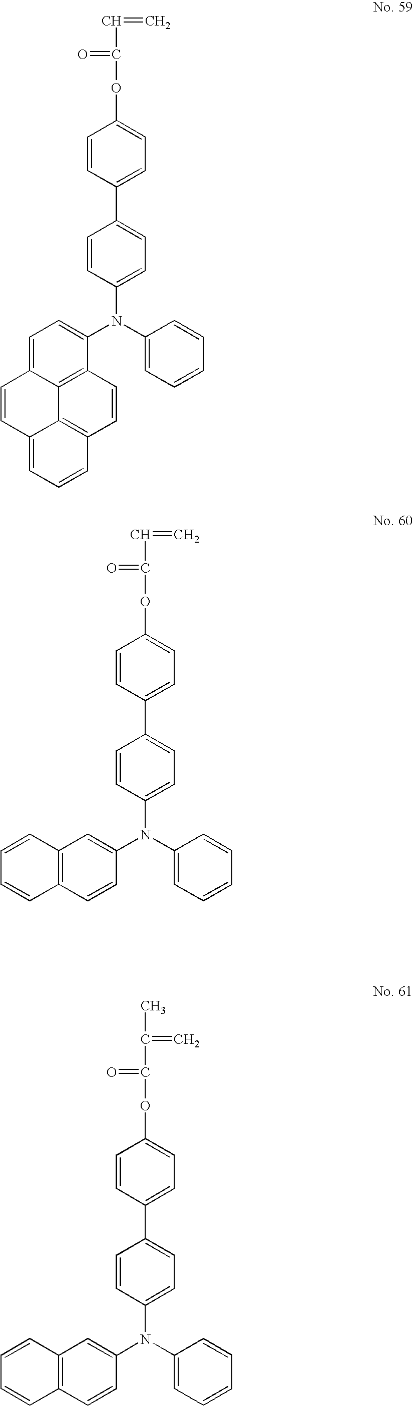

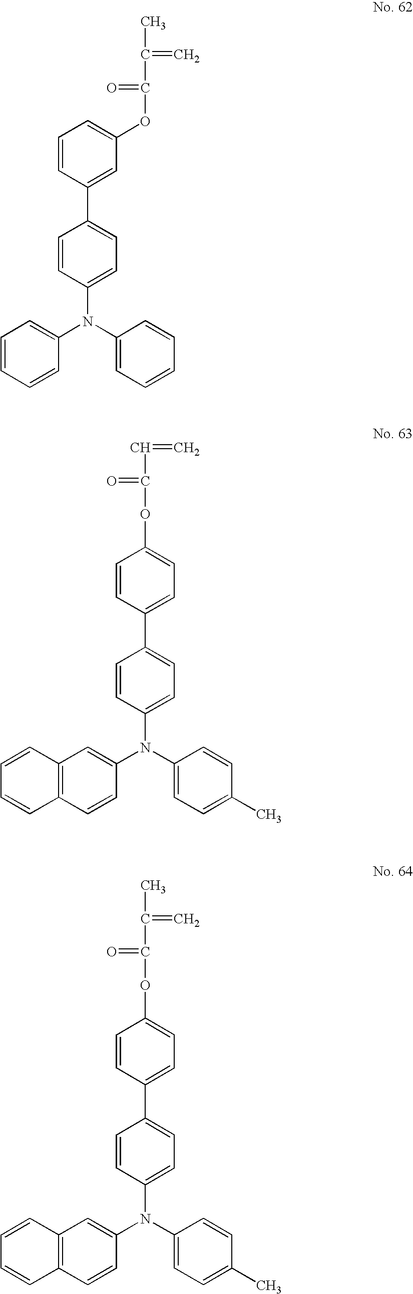

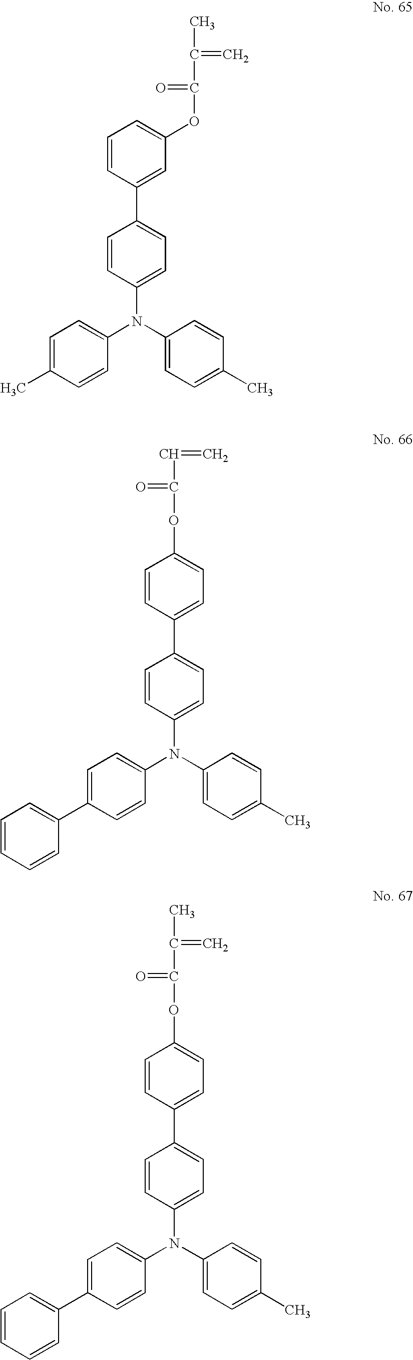

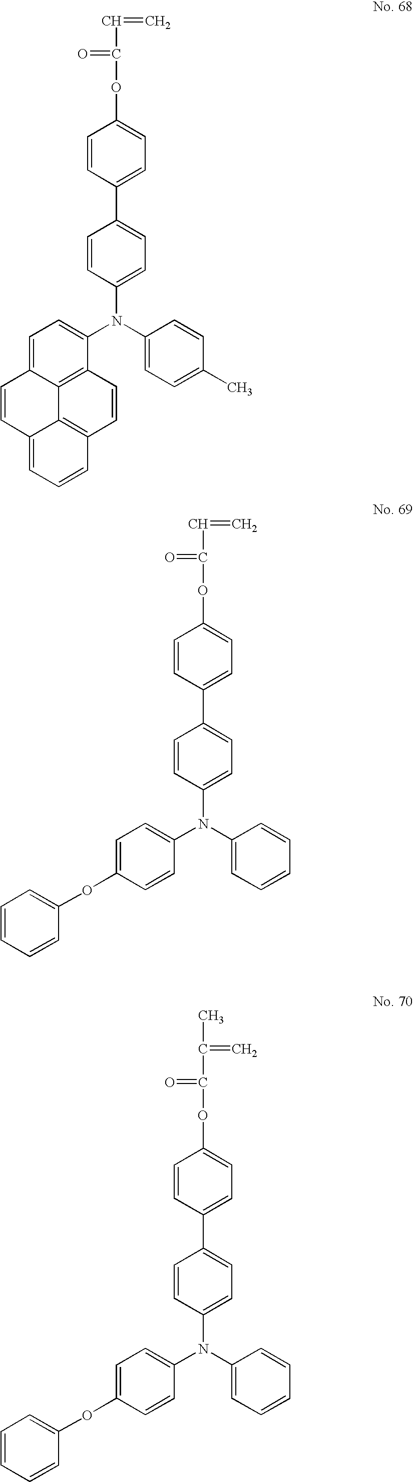

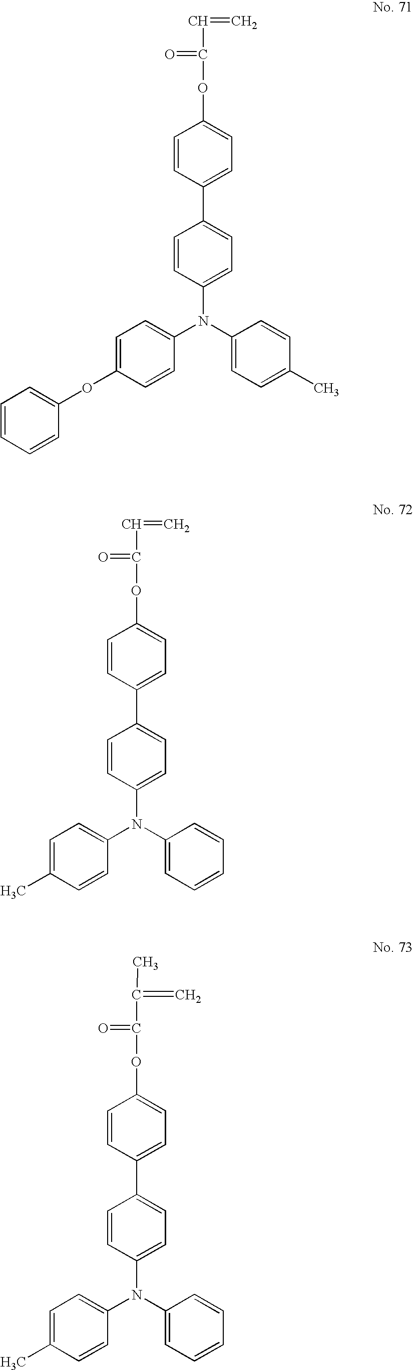

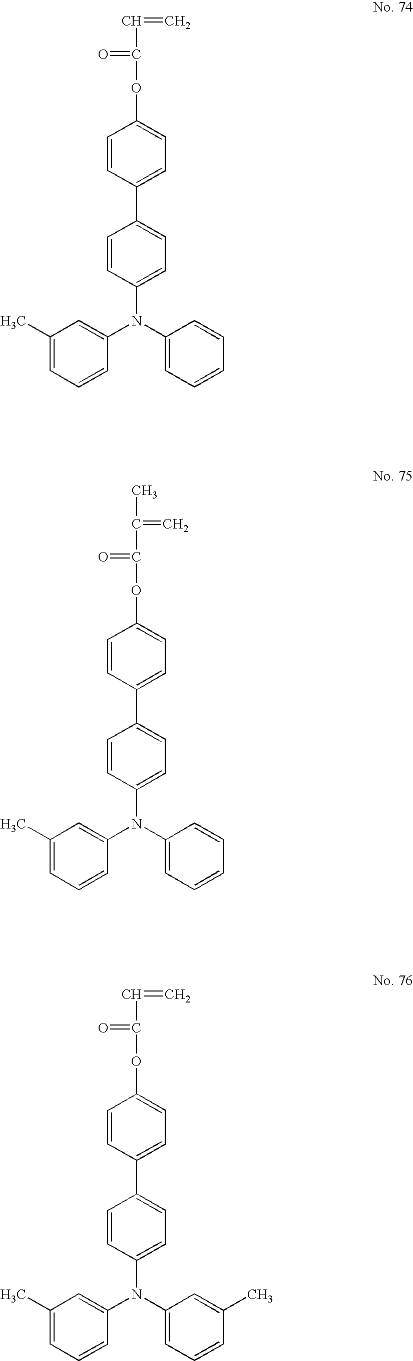

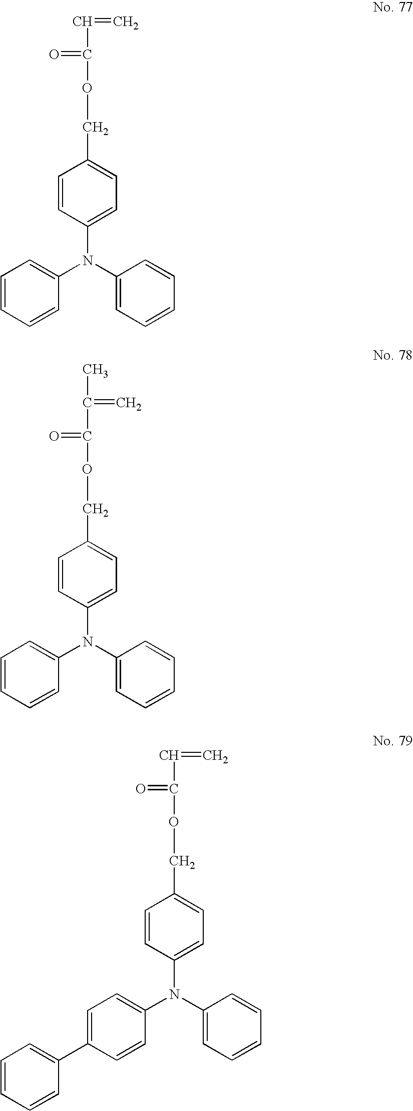

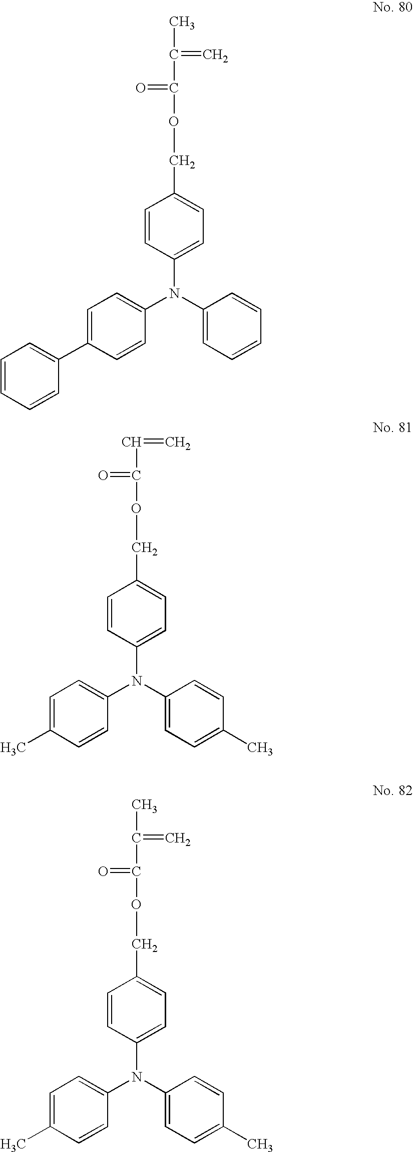

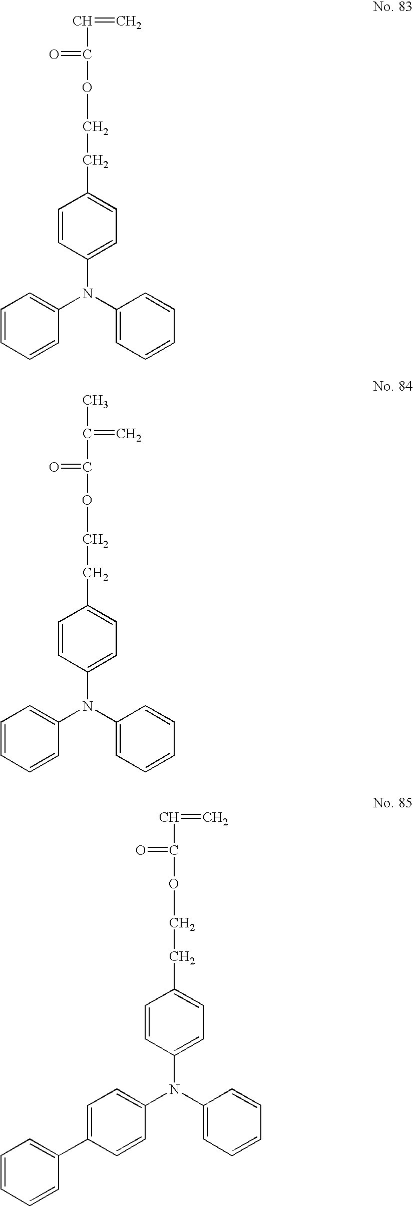

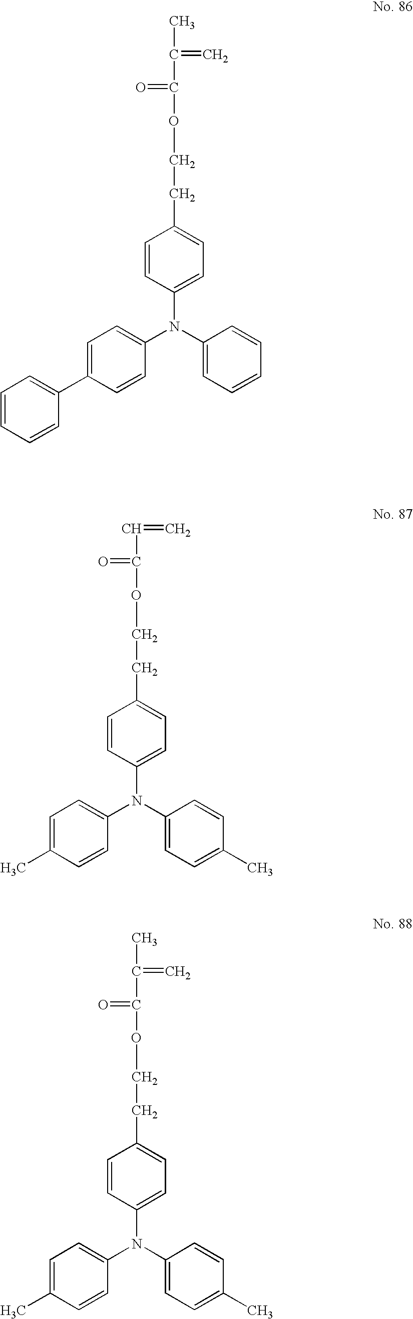

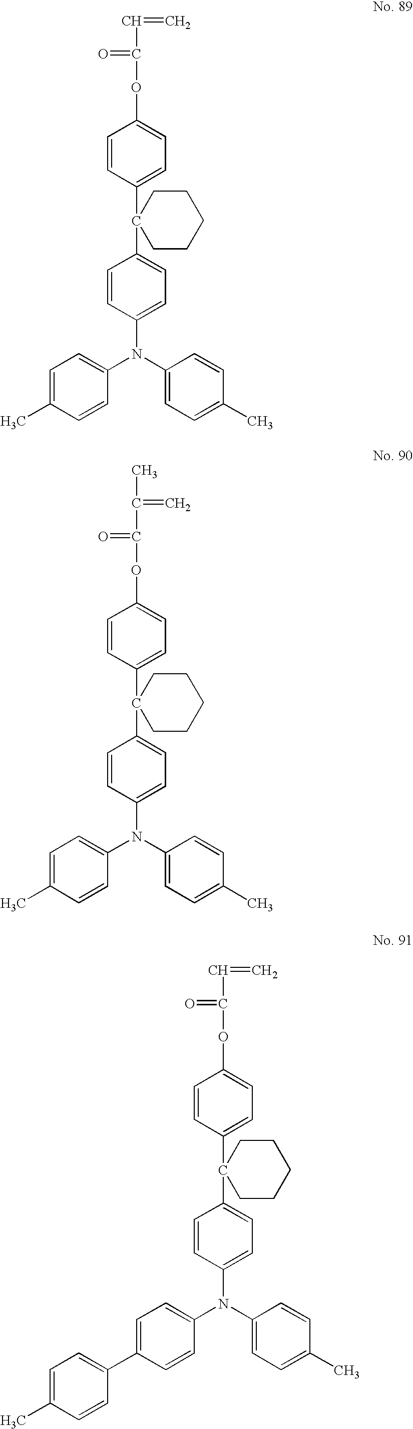

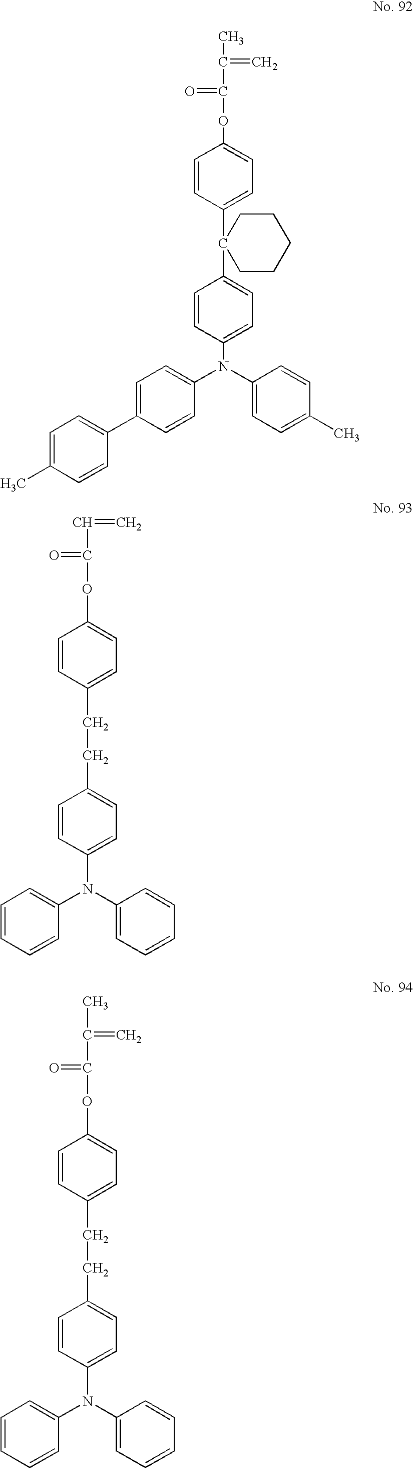

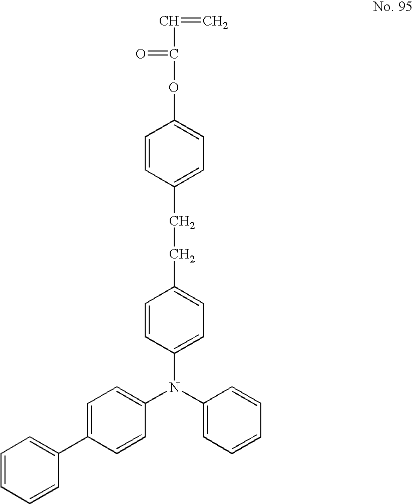

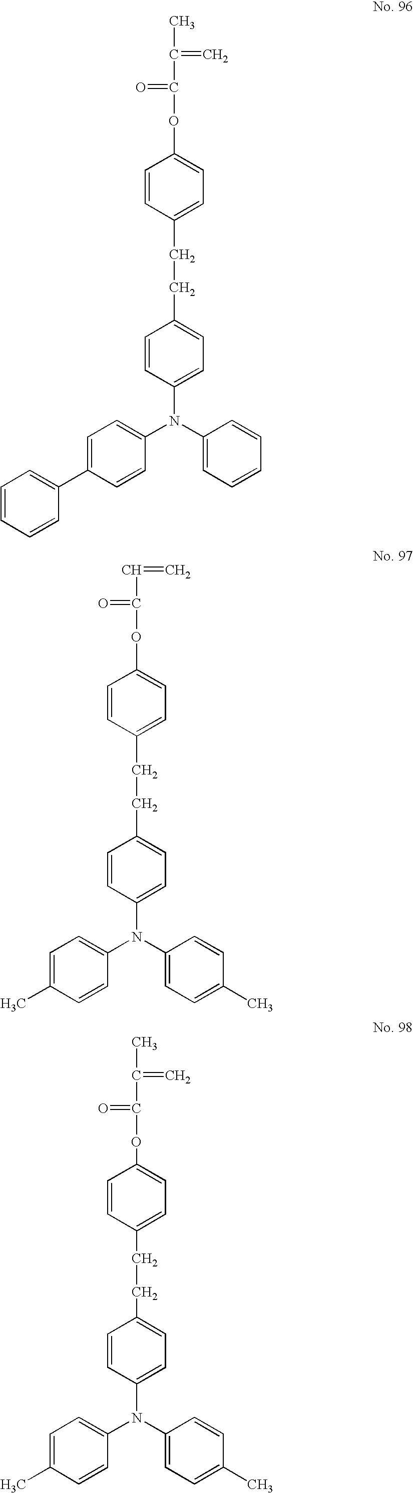

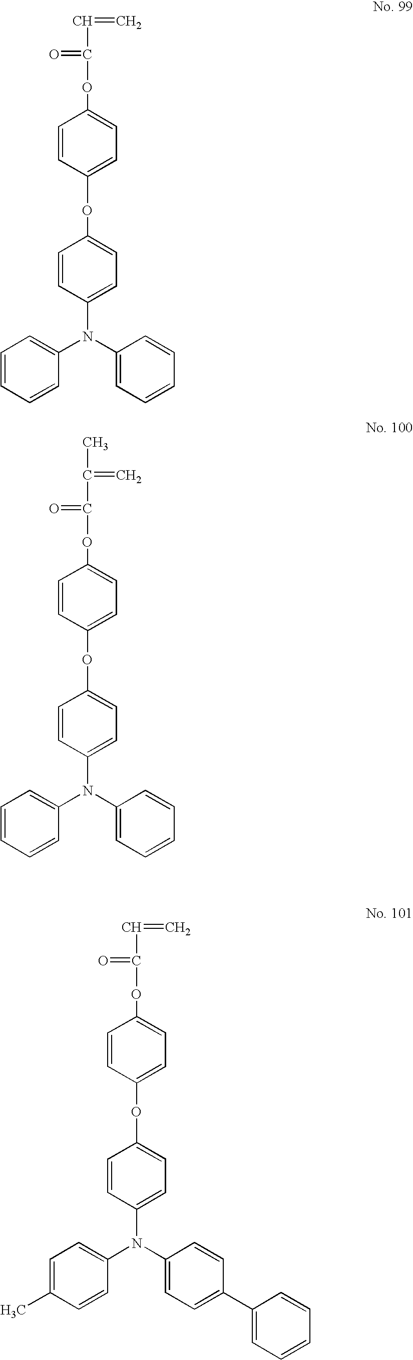

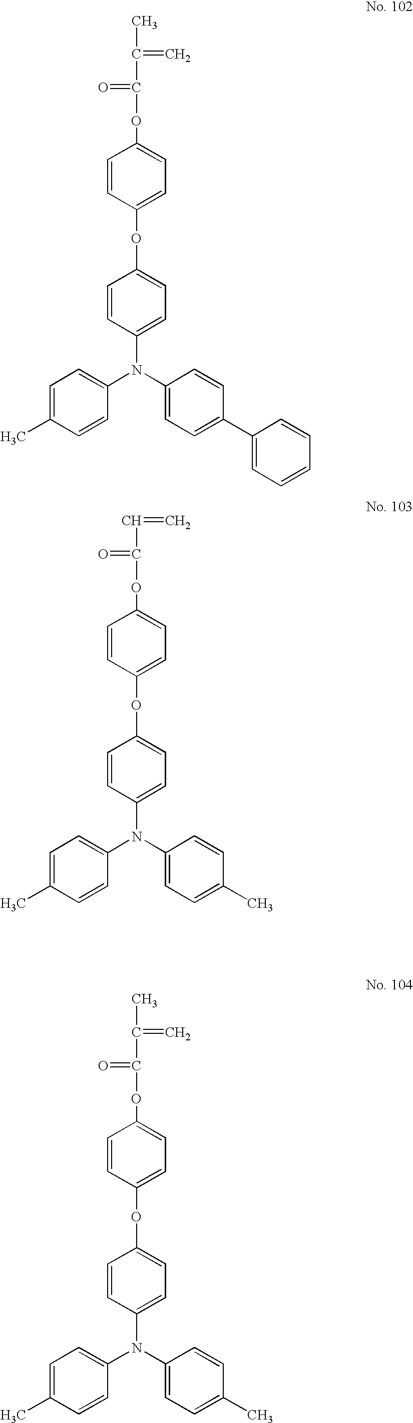

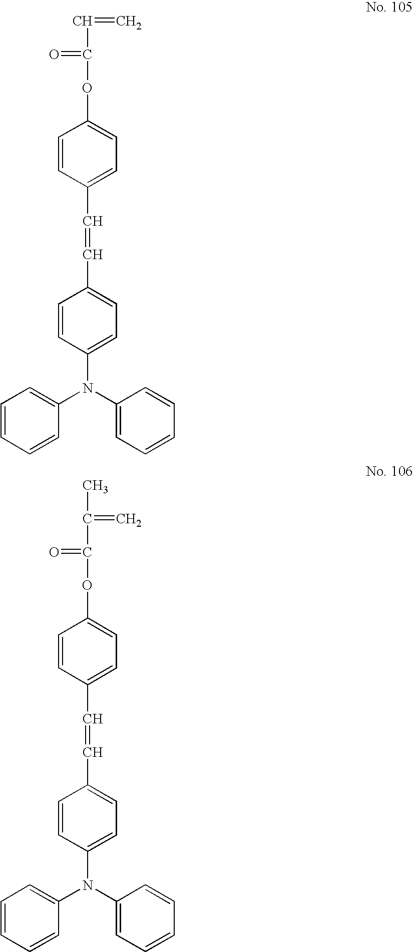

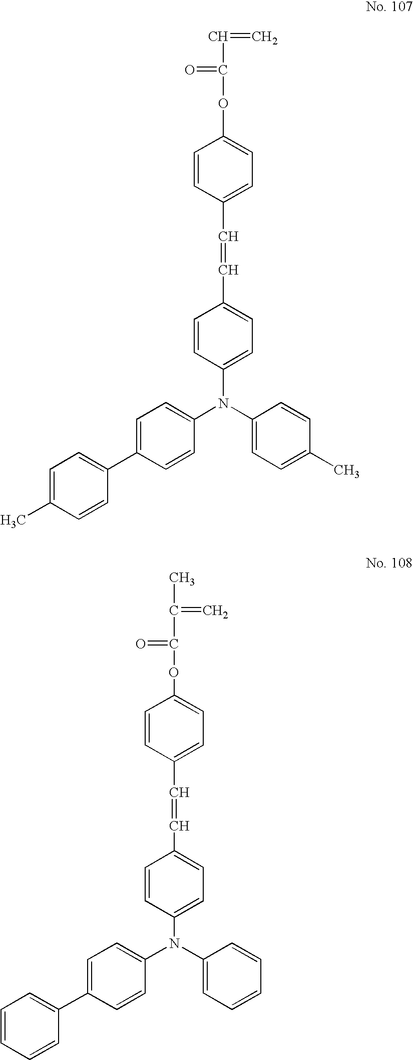

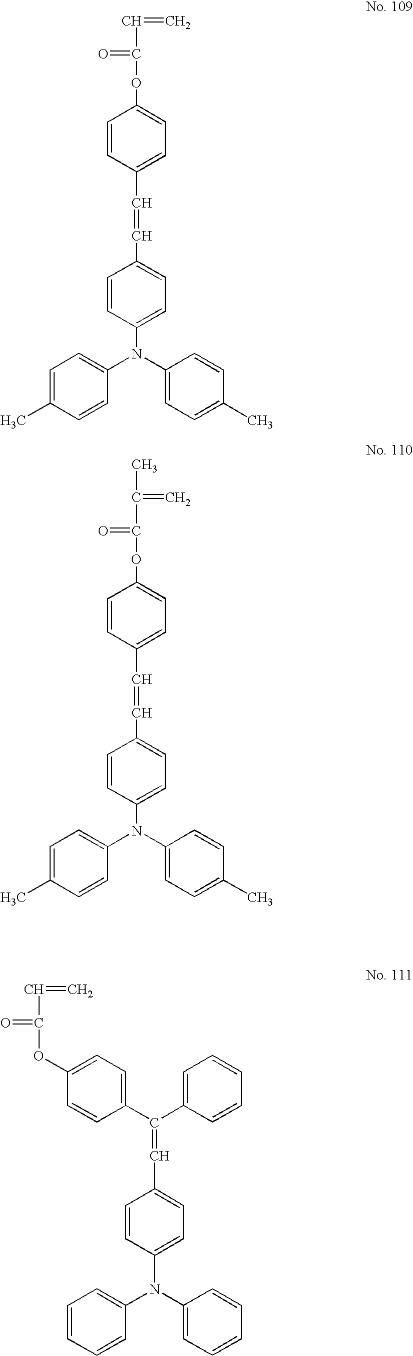

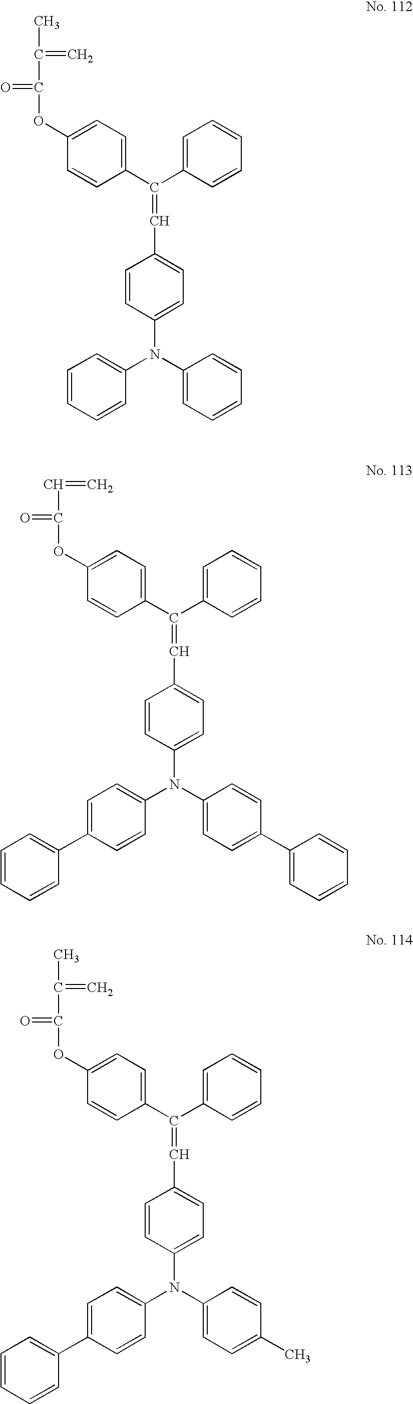

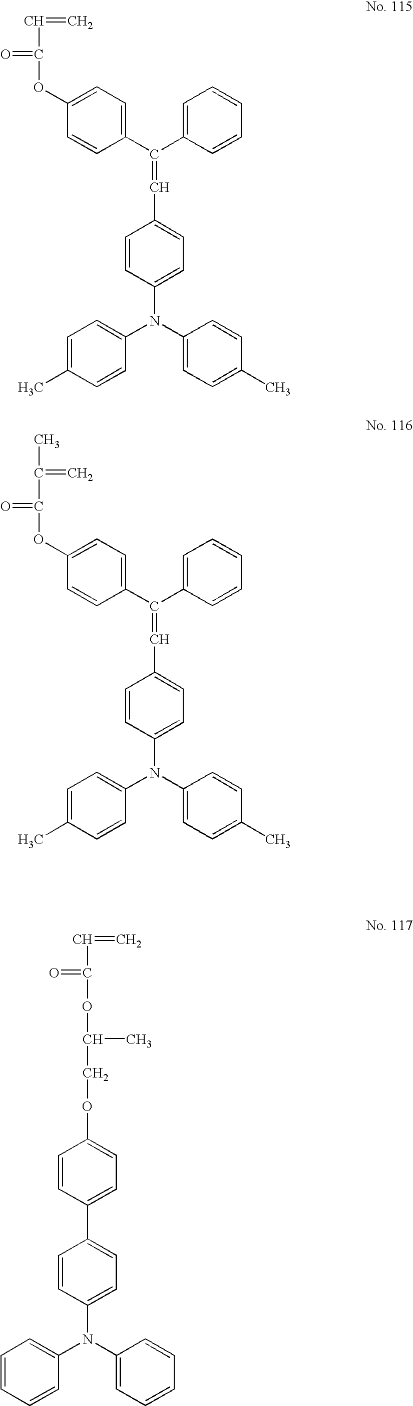

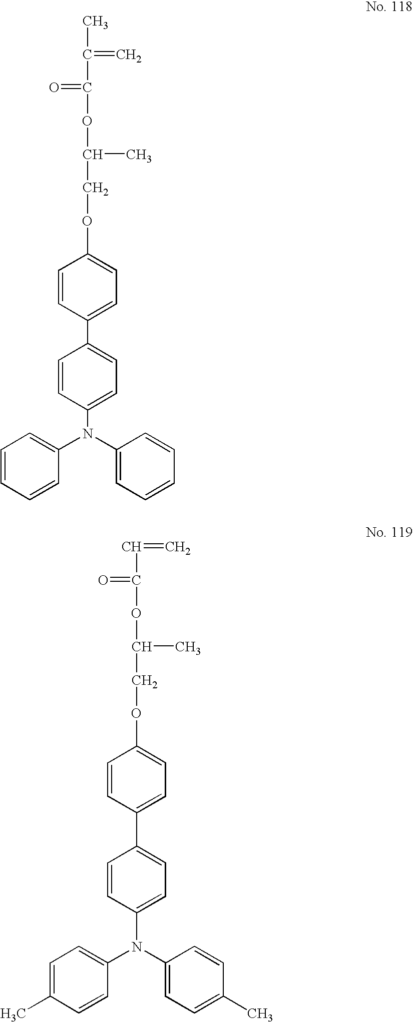

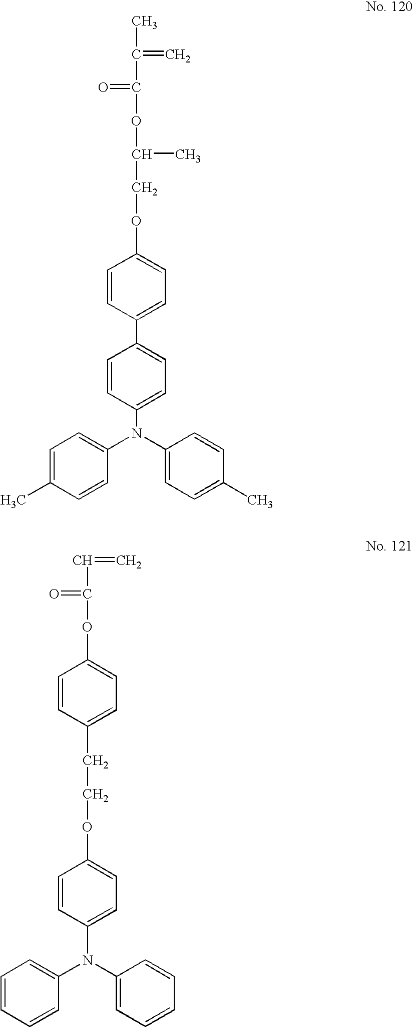

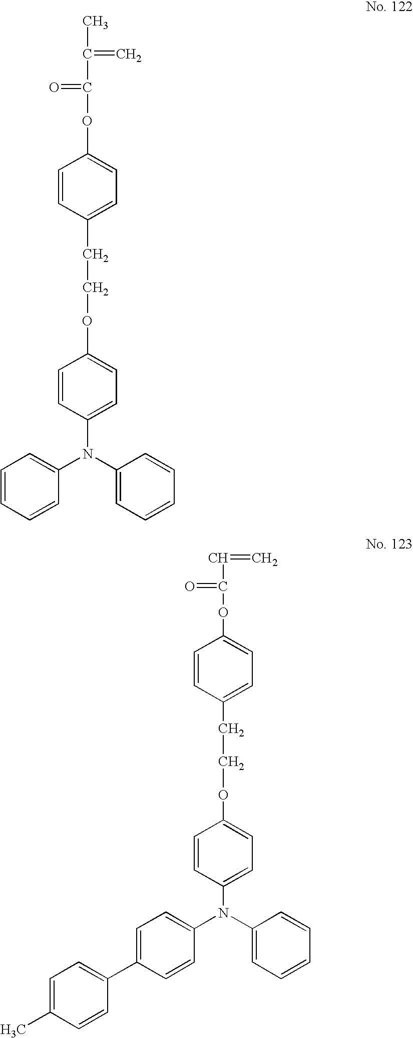

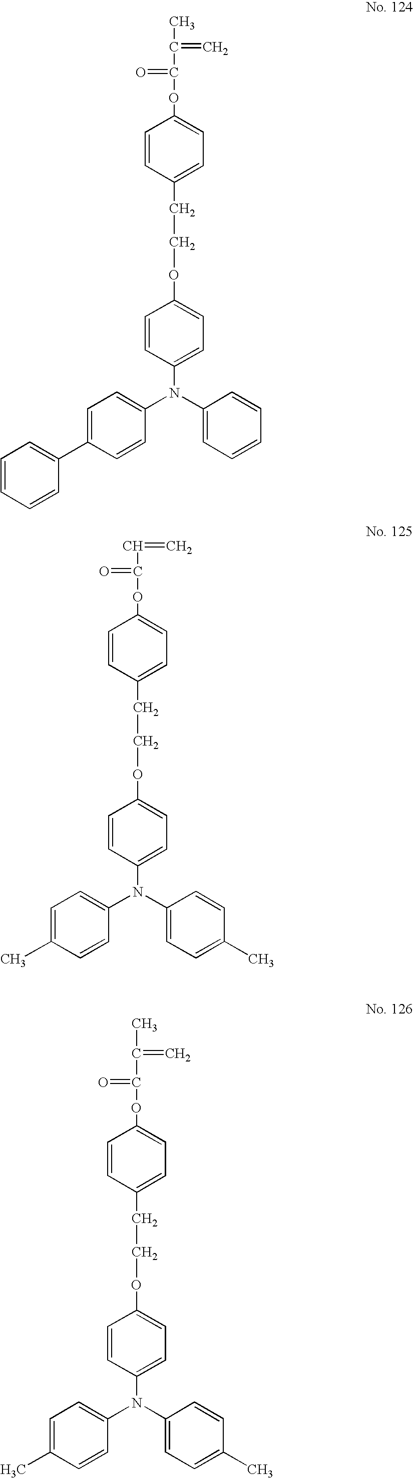

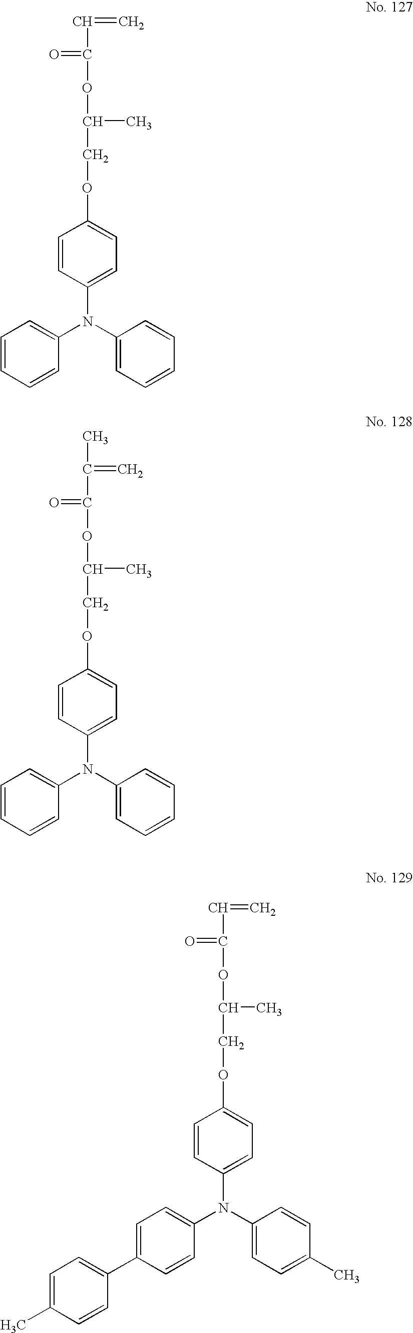

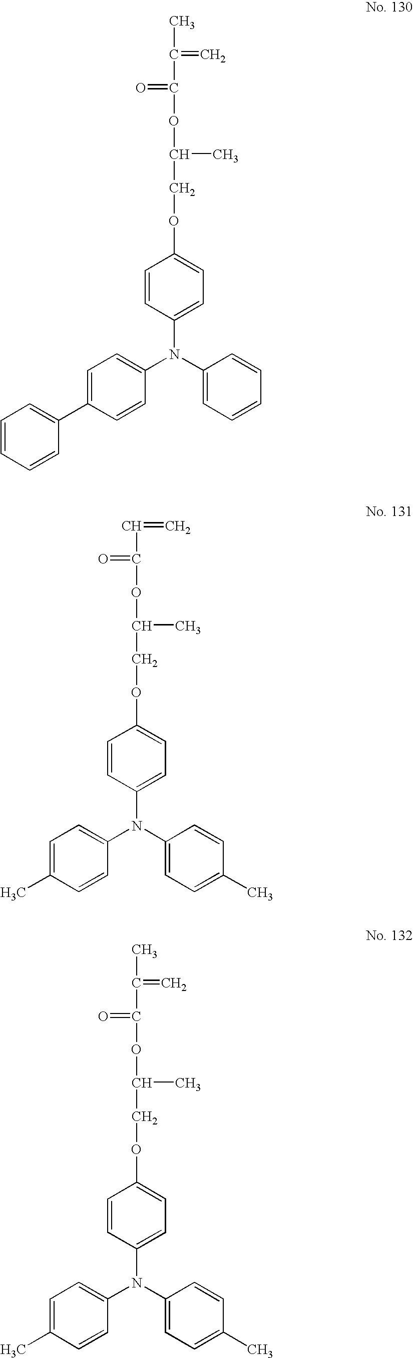

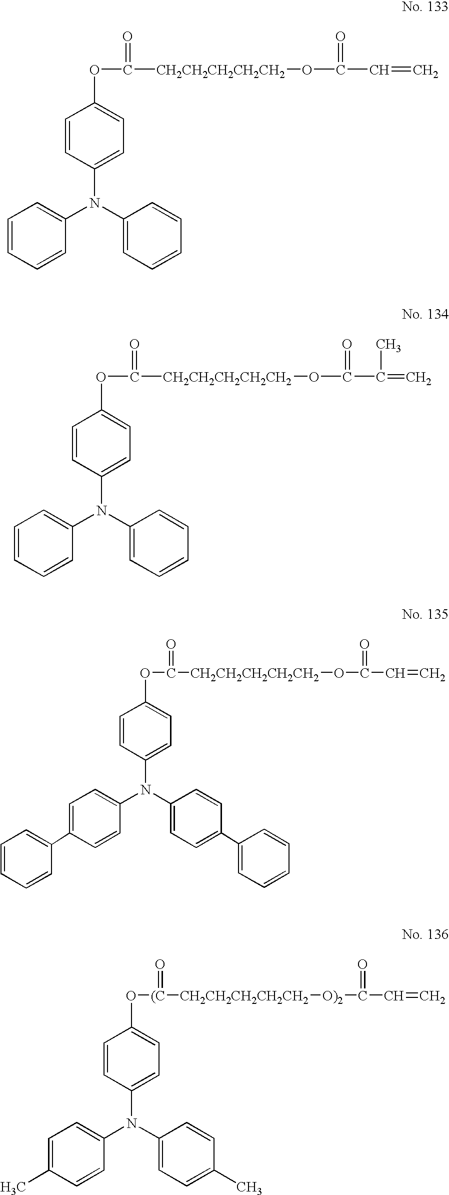

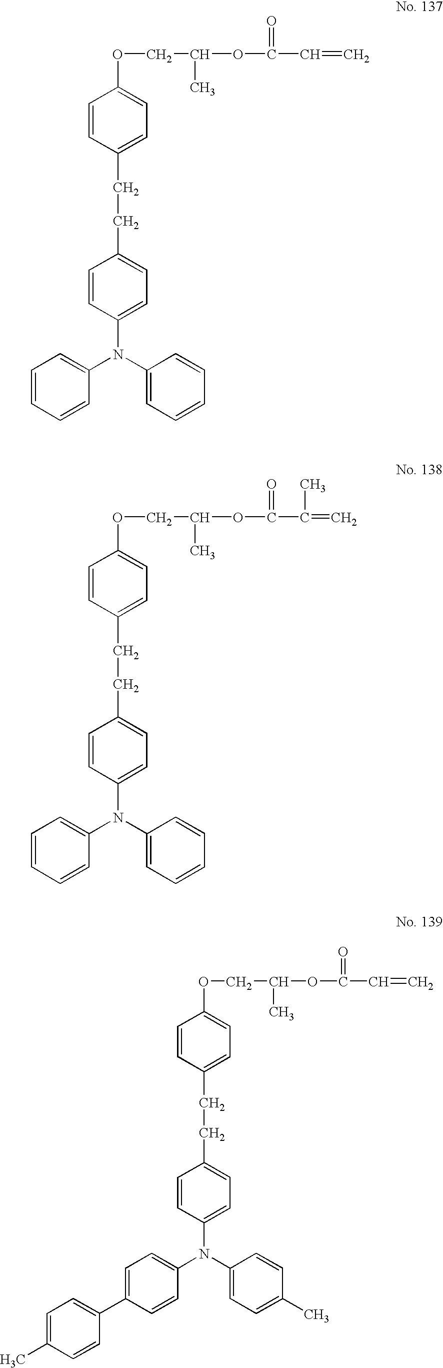

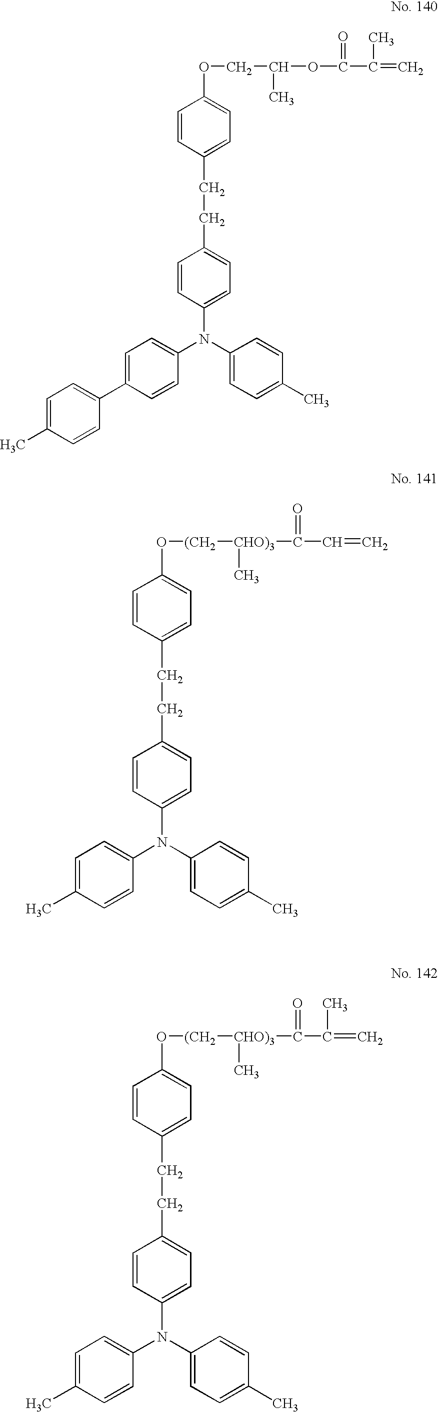

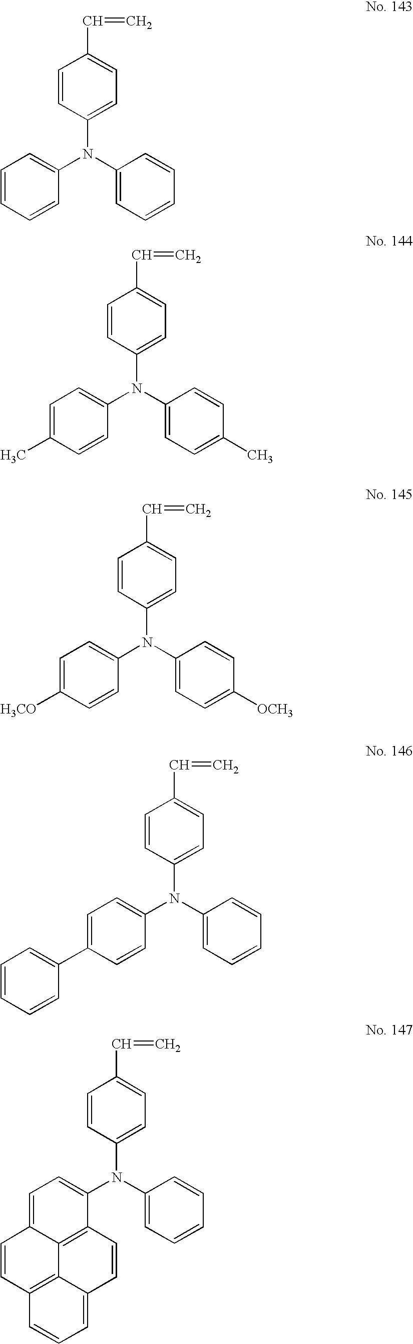

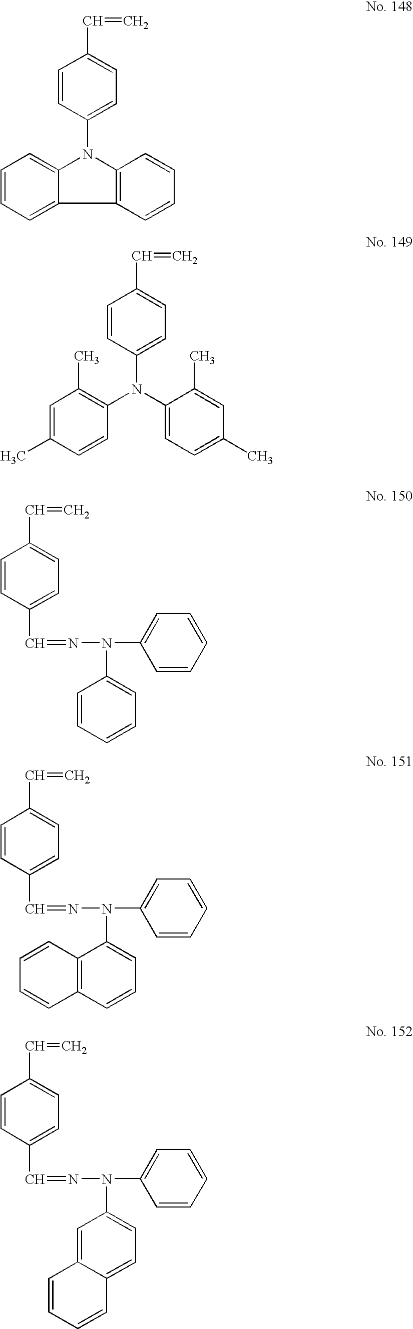

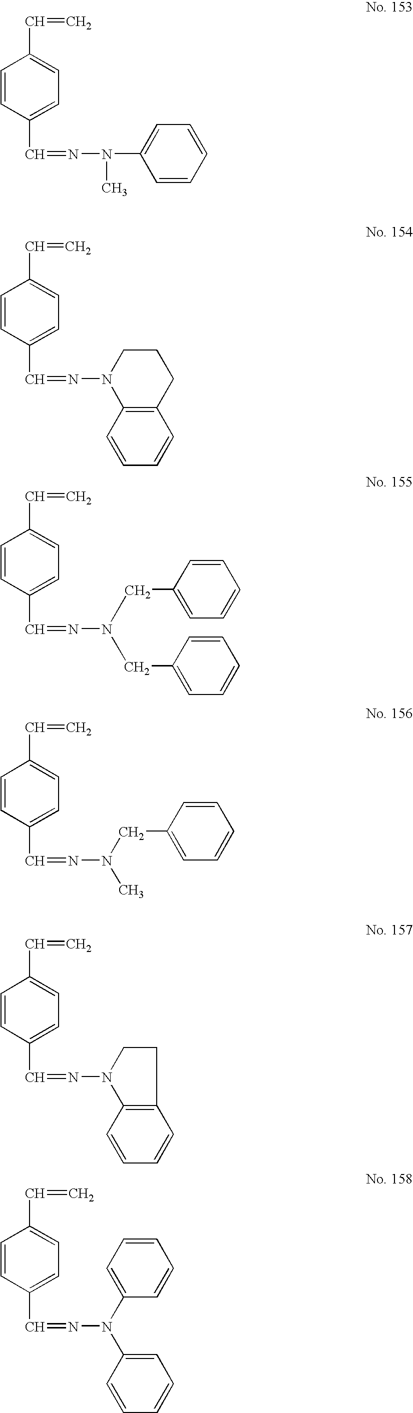

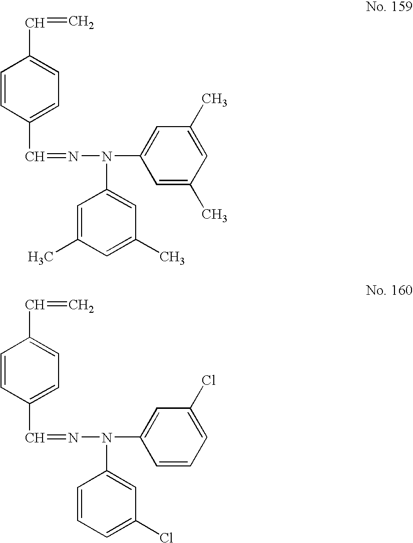

The radical polymerizable monofunctional monomers are used for imparting a charge transport property to the resultant protection layer. The additive amount of the radical polymerizable monofunctional monomers is preferably from 20 to 80% by weight, and more preferably from 30 to 70% by weight, based on the total weight of the protection layer. When the additive amount is too small, good charge transport property cannot be imparted to the resultant polymer, and thereby the electric properties (such as photosensitivity and residual potential) of the resultant photoreceptor deteriorate. In contrast, when the additive amount is too large, the crosslinking density of the resultant protection layer decreases, and thereby the abrasion resistance of the resultant photoreceptor deteriorates. From this point of view, the additive amount of the monofunctional monomers is from 30 to 70% by weight.

The crosslinked protection layer is typically prepared by reacting (crosslinking) at least a radical polymerizable tri- or more-functional monomer and a radical polymerizable monofunctional monomer. However, in order to reduce the viscosity of the coating liquid, to relax the stress of the protection layer, and to reduce the surface energy and friction coefficient of the protection layer, known radical polymerizable mono- or di-functional monomers and radical polymerizable oligomers having no charge transport structure can be used in combination therewith.

Specific examples of the radical polymerizable monofunctional monomers having no charge transport structure include 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethyleneglycol acrylate, phenoxytetraethyleneglycol acrylate, cetyl acrylate, isostearyl acrylate, stearyl acrylate, styrene, etc.

Specific examples of the radical polymerizable difunctional monomers having no charge transport structure include 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, neopentylglycol diacrylate, bisphenol A-ethyleneoxy-modified diacrylate, bisphenol F-ethyleneoxy-modified diacrylate, neopentylglycol diacrylate, etc.

Specific examples of the mono- or di-functional monomers for use in imparting a function such as low surface energy and/or low friction coefficient to the crosslinked protection layer include fluorine-containing monomers such as octafluoropentyl acrylate, 2-perfluorooctylethyl acrylate, 2-perfluorooctylethyl methacrylate, and 2-perfluoroisononylethyl acrylate; and vinyl monomers, acrylates and methacrylates having a polysiloxane group such as siloxane units having a repeat number of from 20 to 70 which are described in Published Examined Japanese Patent Application Nos. 05-60503 and 06-45770 (e.g., acryloylpolydimethylsiloxaneethyl, methacryloylpolydimethylsiloxaneethyl, acryloylpolydimethylsiloxanepropyl, acryloylpolydimethylsiloxanebutyl, and diacryloylpolydimethylsiloxanediethyl).

Specific examples of the radical polymerizable oligomers include epoxyacrylate oligomers, urethane acrylate oligomers, polyester acrylate oligomers, etc.

The additive amount of such mono- and di-functional monomers is preferably not greater than 50 parts by weight, and more preferably not greater than 30 parts by weight, per 100 parts by weight of the tri- or more-functional monomers used. When the additive amount is too large, the crosslinking density decreases, and thereby the abrasion resistance of the resultant protection layer deteriorates.

In addition, in order to efficiently crosslink the protection layer, a polymerization initiator can be added to the protection layer coating liquid. Suitable polymerization initiators include heat polymerization initiators and photo polymerization initiators. The polymerization initiators can be used alone or in combination.

Specific examples of the heat polymerization initiators include peroxide initiators such as 2,5-dimethylhexane-2,5-dihydroperoxide, dicumyl peroxide, benzoyl peroxide, t-butylcumyl peroxide, 2,5-dimethyl-2,5-di(peroxybenzoyl)hexyne-3, di-t-butylperoxide, t-butylhydroperoxide, cumenehydroperoxide, lauroyl peroxide, and 2,2-bis(4,4-di-t-butylperoxycyclohexy)propane; and azo type initiators such as azobisisobutyronitrile, azobiscyclohexanecarbonitrile, azobisbutyricacidmethylester, hydrochloric acid salt of azobisisobutylamidine, and 4,4′-azobis-cyanovaleric acid.

Specific examples of the photopolymerization initiators include acetophenone or ketal type photopolymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoin ether type photopolymerization initiators such as benzoin, benzoin methyl ether, benzoin ethyl ether, benzoin isobutyl ether, and benzoin isopropyl ether; benzophenone type photopolymerization initiators such as benzophenone, 4-hydroxybenzophenone, o-benzoylbenzoic acid methyl ester, 2-benzoyl naphthalene, 4-benzoyl biphenyl, 4-benzoyl phenyl ether, acrylated benzophenone, and 1,4-benzoyl benzene; thioxanthone type photopolymerization initiators such as 2-isopropylthioxanthone, 2-chlorothioxanthone, 2,4-dimethylthioxanthone, 2,4-diethylthioxanthone, and 2,4-dichlorothioxanthone; and other photopolymerization initiators such as ethylanthraquinone, 2,4,6-trimethylbenzoyldiphenylphosphineoxide, 2,4,6-trimethylbenzoylphenylethoxyphosphineoxide, bis(2,4,6-trimethylbenzoyl)phenylphosphineoxide, bis(2,4-dimethoxybenzoyl)-2,4,4-trimethylpentylphosphineoxide, methylphenylglyoxyester, 9,10-phenanthrene, acridine compounds, triazine compounds, imidazole compounds, etc. Photopolymerization accelerators can be used alone or in combination with the above-mentioned photopolymerization initiators. Specific examples of the photopolymerization accelerators include triethanolamine, methyldiethanolamine, ethyl 4-dimethylaminobenzoate, isoamyl 4-dimethylaminobenzoate, 2-dimethylaminoethyl benzoate, 4,4′-dimethylaminobenzophenone, etc.

The additive amount of the polymerization initiators is preferably from 0.5 to 40 parts by weight, and more preferably from 1 to 20 parts by weight, per 100 parts by weight of the total weight of the radical polymerizable monomers used.

In order to relax the stress of the crosslinked protection layer and to improve the adhesion of the protection layer to the CTL, the protection layer coating liquid may include additives such as plasticizers, leveling agent, and low molecular weight charge transport materials having no radical polymerizability. Specific examples of the plasticizers include known plasticizers for use in general resins, such as dibutyl phthalate, and dioctyl phthalate. The additive amount of the plasticizers in the protection layer coating liquid is preferably not greater than 20% by weight, and more preferably not greater than 10% by weight, based on the total solid components included in the coating liquid. Specific examples of the leveling agents include silicone oils (such as dimethylsilicone oils, and methyl phenyl silicon coils), and polymers and oligomers having a perfluoroalkyl group in their side chains. The additive amount of the leveling agents is preferably not greater than 3% by weight based on the total solid components included in the coating liquid.

The crosslinked protection layer is typically prepared by coating a coating liquid including a radical polymerizable tri- or more-functional monomer and a radical polymerizable monofunctional monomer on the CTL and then crosslinking the coated layer. When the monomers are liquid, it may be possible to dissolve other components in the monomers, resulting in preparation of the protection layer coating liquid. The coating liquid can optionally include a solvent to well dissolve the other components and/or to reduce the viscosity of the coating liquid. Specific examples of the solvents include alcohols such as methanol, ethanol, propanol, and butanol; ketones such as acetone, methyl ethyl ketone, methyl isobutyl ketone, and cyclohexanone; esters such as ethyl acetate, and butyl acetate; ethers such as tetrahydrofuran, dioxane, and propyl ether; halogenated solvents such as dichloromethane, dichloroethane, trichloroethane, and chlorobenzene; aromatic solvents such as benzene, toluene, and xylene; cellosolves such as methyl cellosolve, ethyl cellosolve and cellosolve acetate; etc. These solvents can be used alone or in combination. The additive amount of the solvents is determined depending on the solubility of the solid components, the coating method used, and the target thickness of the protection layer. Coating methods such as dip coating methods, spray coating methods, bead coating methods, and ring coating methods can be used for forming the protection layer.

After coating a protection layer coating liquid, energy such as heat energy, photo energy and radiation energy is applied to the coated layer to crosslink the layer. Specific examples of the method for applying heat energy are as follows:

(1) applying heated gas (such as air and nitrogen gas) thereto;

(2) contacting a heated material thereto; and

(3) irradiating the coated layer with light or electromagnetic waves from the coated layer side or the opposite side.

The temperature at which the coated protection layer is heated is preferably from 100 to 170° C. When the temperature is too low, the crosslinking speed becomes too slow, and thereby a problem in that the coated layer is not sufficiently crosslinked is caused. When the temperature is too high, the crosslinking reaction is unevenly performed, and thereby a problem in that the resultant protection layer has a large strain or includes non-reacted functional groups is caused. In order to uniformly perform the crosslinking reaction, a method in which at first the coated layer is heated at a relatively low temperature (not higher than about 100° C.), followed by heating at a relatively high temperature (not lower than about 100° C.) is preferably used. Specific examples of the light source for use in photo-crosslinking the coated layer include ultraviolet light emitting devices such as high pressure mercury lamps and metal halide lamps. In addition, visible light emitting lamps can also be used if the radical polymerizable monomers and the photopolymerization initiators used have absorption in a visible region. The illuminance intensity is preferably from 50 to 1000 mW/cm². When the illuminance intensity is too low, it takes a long time until the coated layer is crosslinked. In contrast, when the illuminance intensity is too high, a problem in that the crosslinking reaction is unevenly performed, thereby forming wrinkles in the resultant protection layer, or the layer includes non-reacted reaction groups therein is caused. In addition, a problem in that due to rapid crosslinking, the resultant protection layer causes cracks or peeling occurs. Specific examples of the radiation energy applying methods include methods using electron beams. Among these methods, the methods using heat or light are preferably used because the reaction speed is high and the energy applying devices have a simple structure.

The thickness of the crosslinked protection layer is preferably from 1 to 10 μm, and more preferably from 2 to 8 μm. When the crosslinked protection layer is too thick, the above-mentioned cracking and peeling problems occurs. When the thickness is not greater than 8 μm, the margin for the cracking and peeling problems can be increased. Therefore, a relatively large amount of energy can be applied to the coated layer, and thereby crosslinking density can be further increased. In addition, flexibility in choosing materials for imparting good abrasion resistance to the protection layer and flexibility in setting crosslinking conditions can be enhanced. In general, radical polymerization reaction is obstructed by oxygen included in the air, namely, crosslinking is not well performed in the surface part (from 0 to about 1 μm in the thickness direction) of the coated layer due to oxygen in the air, resulting in formation of unevenly-crosslinked layer. Therefore, if the crosslinked protection layer is too thin (i.e., the thickness of the protection layer is less than about 1 μm), the layer has poor abrasion resistance. Further, when the protection layer coating liquid is coated directly on a CTL, the components included in the CTL tends to be dissolved in the coated liquid, resulting in migration of the components into the protection layer. In this case, if the protection layer is too thin, the components are migrated into the entire protection layer, resulting in occurrence of a problem in that crosslinking cannot be well performed or the crosslinking density is low. Thus, the thickness of the protection layer is preferably not less than 1 μm so that the protection layer has good abrasion resistance and scratch resistance. However, if the entire protection layer is abraded, the CTL located below the protection layer is abraded more easily than the protection layer. In this case, problems in that the photosensitivity of the photoreceptor seriously changes and uneven half tone images are produced occur. In order that the resultant photoreceptor can produce high quality images for a long period of time, the crosslinked protection layer preferably has a thickness not less than 2 μm.

When the crosslinked protection layer, which is formed as an outermost layer of a photoreceptor having a CGL, and CTL, is insoluble in organic solvents, the resultant photoreceptor has dramatically improved abrasion resistance and scratch resistance. The solvent resistance of a protection layer can be checked by the following method:

(1) dropping a solvent, which can well dissolve polymers, such as tetrahydrofuran and dichloromethane, on the surface of the protection layer;

(2) naturally drying the solvent; and

(3) visually observing the surface of the protection layer to determine whether the condition of the surface part is changed.

If the protection layer has poor solvent resistance, the following phenomena are observed:

(1) the surface part is recessed while the edge thereof is projected;

(2) the charge transport material in the protection layer is crystallized, and thereby the surface part is clouded; or

(3) the surface part is at first swelled, and then wrinkled.

If the protection layer has good solvent resistance, the above-mentioned phenomena are not observed.

In order to prepare a crosslinked protection layer having good resistance to organic solvents, the key points are as follows:

(1) to optimize the formula of the protection layer coating liquid, i.e., to optimize the content of each of the components included in the liquid;

(2) to choose a proper solvent for diluting the protection layer coating liquid, while properly controlling the solid content of the coating liquid;

(3) to use a proper method for coating the protection layer coating liquid;

(4) to crosslink the coated layer under proper crosslinking conditions; and

(5) to form a CTL which located below the protection layer and is hardly insoluble in the solvent included in the protection layer coating liquid.

It is preferable to use one or more of these techniques.

The protection layer coating liquid can include additives such as binder resins having no radical polymerizable group, antioxidants and plasticizers other than the radical polymerizable tri- or more-functional monomers having no charge transport structure and radical polymerizable monofunctional monomers having a charge transport structure. Since the additive amount of these additives is too large, the crosslinking density decreases and the protection layer causes a phase separation problem in that the crosslinked polymer is separated from the additives, and thereby the resultant protection layer becomes soluble in organic solvents. Therefore, the additive amount of the additives is preferably not greater than 20% by weight based on the total weight of the solid components included in the protection layer coating liquid. In addition, in order not to decrease the crosslinking density, the total additive amount of the mono- or di-functional monomers, reactive oligomers and reactive polymers in the protection layer coating liquid is preferably not greater than 20% by weight based on the weight of the radical polymerizable tri- or more-functional monomers. In particular, when the additive amount of the di- or more-functional monomers having a charge transport structure is too large, units having a bulky structure are incorporated in the protection layer while the units are connected with plural chains of the protection layer, thereby generating strain in the protection layer, resulting in formation of aggregates of micro crosslinked materials in the protection layer. Such a protection layer is soluble in organic solvents. The additive amount of a radical polymerizable di- or more-functional monomer having a charge transport structure is determined depending on the species of the monomer used, but is generally not greater than 10% by weight based on the weight of the radical polymerizable monofunctional monomer having a charge transport structure included in the protection layer.

When an organic solvent having a low evaporating speed is used for the protection layer coating liquid, problems which occur are that the solvent remaining in the coated layer adversely affects crosslinking of the protection layer; and a large amount of the components included in the CTL is migrated into the protection layer, resulting in deterioration of crosslinking density or formation of an unevenly crosslinked protection layer (i.e., the crosslinked protection layer becomes soluble in organic solvents). Therefore, it is preferable to use solvents such as tetrahydrofuran, mixture solvents of tetrahydrofuran and methanol, ethyl acetate, methyl ethyl ketone, and ethyl cellosolve. It is preferable that one or more proper solvents are chosen among the solvents in consideration of the coating method used. When the solid content of the protection layer coating liquid is too low, similar problems occur. The upper limit of the solid content is determined depending on the target thickness of the protection layer and the target viscosity of the protection layer coating liquid, which is determined depending on the coating method used, but in general, the solid content of the protection layer coating liquid is preferably from 10 to 50% by weight. Suitable coating methods for use in preparing the crosslinked protection layer include methods in which the weight of the solvent included in the coated layer is as low as possible, and the time during which the solvent in the coated layer contacts the CTL on which the coating liquid is coated is as short as possible. Specific examples of such coating methods include spray coating methods and ring coating methods in which the weight of the coated layer is controlled so as to be light. In addition, in order to control the amount of the components of the CTL migrating into the protection layer so as to be as small as possible, it is preferable to use a charge transport polymer for the CTL and/or to form an intermediate layer, which is hardly soluble in the solvent used for the protection layer coating liquid, between the CTL and the protection layer.

When the heating or irradiating energy is low in the crosslinking process, the coated layer is not completely crosslinked. In this case, the resultant layer becomes soluble in organic solvents. In contrast, when the energy is too high, uneven crosslinking is performed, resulting in increase of non-crosslinked parts or parts at which radical is terminated, or formation of aggregates of micro crosslinked materials. In this case, the resultant protection layer is soluble in organic solvents. In order to make a protection layer insoluble in organic solvents, the crosslinking conditions are preferably as follows:

### Heat Crosslinking Conditions

Temperature: 100 to 170° C.

Heating time: 10 minutes to 3 hours

### UV Light Crosslinking Conditions

Illuminance intensity: 50 to 1000 mW/cm²

Irradiation time: 5 seconds to 5 minutes

Temperature of coated material: 50° C. or less

In order to make a protection layer insoluble in organic solvents in a case where an acrylate monomer having three acryloyloxy group and a triarylamine compound having one acryloyloxy group are used for the protection layer coating liquid, the weight ratio (A/T) of the acrylate monomer (A) to the triarylamine compound (T) is preferably 7/3 to 3/7. The additive amount of a polymerization initiator is preferably from 3 to 20% by weight based on the total weight of the acrylate monomer (A) and the triarylamine compound (T). In addition, a proper solvent is preferably added to the coating liquid. Provided that the CTL, on which the protection layer coating liquid is coated, is formed of a triarylamine compound (serving as a CTM) and a polycarbonate resin (serving as a binder resin), and the protection layer coating liquid is coated by a spray coating method, the solvent of the protection layer coating liquid is preferably selected from tetrahydrofuran, 2-butanone, and ethyl acetate. The additive amount of the solvent is preferably from 300 to 1000 parts by weight per 100 parts by weight of the acrylate monomer (A).

After the protection layer coating liquid is prepared, the coating liquid is coated by a spray coating method on a peripheral surface of a drum, which includes, for example, an aluminum cylinder and an undercoat layer, a CGL and a CTL which are formed on the aluminum cylinder. Then the coated layer is naturally dried, followed by drying for a short period of time (from 1 to 10 minutes) at a relatively low temperature (from 25 to 80° C.) Then the dried layer is heated or exposed to UV light to be crosslinked.

When crosslinking is performed using UV light, metal halide lamps are preferably used. In this case, the illuminance intensity of UV light is preferably from 50 mW/cm² to 1000 mW/cm². Provided that plural UV lamps emitting UV light of 200 mW/cm² are used, it is preferable that plural lamps uniformly irradiate the coated layer with UV light along the peripheral surface of the coated drum for about 30 seconds. In this case, the temperature of the drum is controlled so as not to exceed 50° C.

When heat crosslinking is performed, the temperature is preferably from 100 to 170° C., and the heating device is preferably an oven with an air blower. When the heating temperature is 150° C., the heating time is preferably from 20 minutes to 3 hours.

It is preferable that after the crosslinking operation, the thus prepared photoreceptor is heated for a time of from 10 minutes to 30 minutes at a temperature of from 100 to 150° C. to remove the solvent remaining in the protection layer. Thus, a photoreceptor (i.e., an image bearer) of the present invention is prepared.

In addition, protection layers in which an amorphous carbon layer or an amorphous SiC layer is formed by a vacuum thin film forming method such as sputtering can also be used for the photoreceptor for use in the present invention.

When a protection layer is formed as an outermost layer of the photoreceptor, there is a case where the discharging light hardly reaches the photosensitive layer if the protection layer greatly absorbs the discharging light, resulting in increase of residual potential and deterioration of the protection layer. Therefore, the protection layer preferably has a transmission of not less than 30%, more preferably not less than 50% and even more preferably not less than 85% against the discharging light.

The transmission of the protection layer is measured as follows:

forming only a protection layer;

measuring a spectral absorption thereof with a marketed spectral photometer; and

determining the transmission thereof against discharging light from the spectral absorption.

When discharging light is irradiated to the surface of a photoreceptor including a photosensitive layer including a CGL and CTL and a protection layer, the discharging light is irradiated to the CGL through the protection layer and CTL. Therefore, the transmission of a combination of a CTL and a protection layer is substantially important, and the combination thereof preferably has a transmission of not less than 30%, more preferably not less than 50% and even more preferably not less than 85% against the discharging light.

The transmission of the combination of a CTL and a protection layer can be measured by the above-mentioned method, except for forming a CTL and a protection layer.

As mentioned above, by using a charge transport polymer for the CTL and/or forming a protection layer as an outermost layer, the durability of the photoreceptor can be improved. In addition, when such a photoreceptor is used for the below-mentioned tandem type full color image forming apparatus, a new effect can be produced.

In the photoreceptor for use in the present invention, the following antioxidants can be added to the protection layer, CTL, CGL, charge blocking layer, anti-moiré layer, etc., to improve the stability to withstand environmental conditions (particularly, to avoid deterioration of sensitivity and increase of residual potential). Suitable antioxidants for use in the layers of the photoreceptor include the following compounds but are not limited thereto.

(a) Phenolic Compounds

2,6-di-t-butyl-p-cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)b enzene, tetrakis-[methylene-3-(3′,5′-di-t-butyl-4′-hydroxyphenyl)pr opionate]methane, bis[3,3′-bis(4′-hydroxy-3′-t-butylphenyl)butyric acid]glycol ester, tocopherol compounds, and the like.

(b) Paraphenylenediamine Compounds

N-phenyl-N1-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, and the like.

(c) Hydroquinone Compounds

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone and the like.

(d) Organic Sulfur-Containing Compounds

dilauryl-3,3′-thiodipropionate, distearyl-3,3′-thiodipropionate, ditetradecyl-3,3′-thiodipropionate, and the like.

(e) Organic Phosphorus-Containing Compounds

triphenylphosphine, tri(nonylphenyl)phosphine, tri(dinonylphenyl)phosphine, tricresylphosphine, tri(2,4-dibutylphenoxy)phosphine and the like.

These compounds have been used as antioxidants for rubbers, resins and oils and fats, and commercially available. The content of the antioxidants in a layer is from 0.01 to 10% by weight based on the total weight of the layer.

When full color images are formed, color images of various patterns are produced. In this case, all the parts of the photoreceptor are subjected to image forming processes such as imagewise irradiating and developing. In contrast, there are original documents having a fixed color image (such as stamp of approval). Stamp of approval is typically located on an edge part of a document, and the color thereof is limited. When such images are formed on a photoreceptor, a specific part of a photoreceptor is mainly used for image formation. In this case, the part is deteriorated faster than the other parts of the photoreceptor. If a photoreceptor having insufficient durability (i.e., insufficient physical, chemical and mechanical durability) is used therefor, an image problem tends to be caused. However, the photoreceptor for use in the present invention has good durability, and therefore such an image problem is hardly caused.

### Electrostatic Latent Image Former

After the image bearer (i.e., the photoreceptor) is charged with a charger, a light irradiator irradiates the charged photoreceptor with imagewise light to form an electrostatic latent image on the photoreceptor, wherein the charger and the light irradiator serve as an electrostatic latent image former.

The electrostatic latent image former typically includes a charger configured to uniformly charge the photoreceptor and a light irradiator.

The charger for use in the image forming apparatus of the present invention is not particularly limited, and known chargers can be used. Specific examples thereof include contact chargers (e.g., conductive or semi-conductive rollers, brushes, films, and rubber blades); short-range chargers which a charging member charges a photoreceptor with a gap on the order of 100 μm; non-contact chargers such as chargers utilizing corona discharging (e.g., corotrons and scorotrons); etc. The strength of the electric field formed on a photoreceptor by a charger is preferably from 20 to 60 V/μm and more preferably from 30 to 50 V/μm. In this regard, the greater the electric field strength, the better dot reproducibility the resultant image has. However, when the electric field strength is too high, problems in that the photoreceptor causes dielectric breakdown and carrier particles are adhered to an electrostatic latent image occur.

The electric field strength (E) is represented by the following equation.

E(V/μm)=SV/G

wherein SV represents the potential (V) of a non-lighted part of a photoreceptor at a developing position; and G represents the thickness of the photosensitive layer of the photoreceptor, which includes at least a CGL and a CTL.

Image irradiation is performed by irradiating the charged photoreceptor with imagewise light using a light irradiator. Known light irradiators can be used and a proper light irradiator is chosen and used for the image forming apparatus for which the toner of the present invention is used. Specific examples thereof include optical systems for use in reading images in copiers; optical systems using rod lens arrays; optical systems using laser; and optical systems using a liquid crystal shutter. It is possible to irradiate the photoreceptor from the backside of the photoreceptor.

Specific examples of the light sources for use in the light irradiator include light emitting diodes (LEDs), laser diodes (LDs) and electroluminescence devices (ELs).

Published Unexamined Japanese Patent Applications Nos. 9-275242, 9-189930 and 5-313033 disclose a method of reducing a wavelength of a laser beam to half using a second harmonic generation (SHG) with a nonlinear optical material. This method can use GaAs LD and YAG laser having long lives and producing large powers.

A wide gap semiconductor can make an image forming apparatus smaller than a device using the second harmonic generation (SHG).

LDs using ZnSe semiconductors disclosed in Published Unexamined Japanese Patent Applications Nos. 7-321409 and 6-334272, and GaN semiconductors disclosed in Published Unexamined Japanese Patent Applications Nos. 8-88441 and 7-335975 have been studied because of their high luminous efficiency. Further, recently, Nichia Corp. has put a LD using GaN semiconductors and emitting light having a wavelength of 405 nm to practical use, which is more highly advanced than the above-mentioned materials and can be used in the present invention. In addition, marketed LED lamps using the above-mentioned materials can also be used.

At present, a CTM fully transparent to light having a wavelength shorter than approximately 350 nm is not available. This is because almost all CTMs have triarylamine structures having an absorption end of from approximately 300 to 350 nm. Therefore, the light source for use in the present invention could emit light having shorter wavelength if a CTM were more transparent.

The resolution of an electrostatic latent image (and a toner image) depends on the resolution of the image writing light. Namely, the higher the resolution of the image writing light, the better the resolution of the resultant electrostatic latent image. However, when the resolution of the image writing light is high, it takes a long time to write an image. When only one light source is used for image writing, the image processing speed (i.e., the speed of the image bearer) depends on the image writing speed. Therefore, when only one light source is used for image writing, the upper limit of the resolution is about 1,200 dpi (dots per inch) and preferably 2,400 dpi. When plural light sources (n pieces) are used, the upper limit of the resolution is 1,200 (or 2,400) dpi×n. Among these light sources, LEDs and LDs are preferably used.

### Image Developer

The electrostatic latent image formed on the photoreceptor is developed with a image developer using a developer including a toner, and a toner image is formed on the photoreceptor. In this regard, a nega-posi developing method is typically used. Therefore a toner having the same polarity as that of the charges formed on the photoreceptor is used. Both one-component developers including only a toner, and two-component developers including a toner and a carrier can be used for the image forming apparatus of the present invention.

### Transferer

The transferer transfers the toner image onto a receiving material. The transfer method is classified into a direct transfer method in which the toner image is directly transferred to a receiving material; and an indirect transfer method in which the toner image is transferred to an intermediate transfer medium (primary transfer) and then transferred to a receiving material (secondary transfer). Both the transfer methods can be used for the image forming apparatus of the present invention. When high resolution images are produced, the direct transfer method is preferably used.

When a toner image is transferred, the photoreceptor is typically charged with a transfer charger which is included in the transferring device. The transferer is not limited thereto, and known transferers such as transfer belts and rollers can also be used.

Suitable transferers (primary and secondary transferers) of the image forming apparatus of the present invention include transferers which charge toner images so as to be easily transferred to a receiving material. Specific examples of the transferers include corona-charge transferers, transfer belts, transfer rollers, pressure transfer rollers, adhesion transferers, etc. The transferer may be one or more. The receiving material is not particularly limited, and known receiving materials such as papers and films can be used.

Suitable transfer chargers include transfer belt chargers and transfer roller chargers. In this regard, in view of the amount of ozone generated, contact type transfer belt chargers and transfer roller chargers are preferably used. Both constant voltage type charging methods and constant current type charging methods can be used in the present invention, but constant current type charging methods are preferably used because constant transfer charges can be applied and thereby charging can be stably performed.

As mentioned above, the quantity of charges passing through the photoreceptor in one image formation cycle largely changes depending on the residual potential of the photoreceptor after the transfer process. Namely, the higher residual potential a photoreceptor has, the faster the photoreceptor deteriorates.

In this regard, the charge quantity means the quantity of charges passing in the thickness direction of the photoreceptor. Specifically, the photoreceptor is (negatively) charged with a main charger so as to have a predetermined potential. Then imagewise light irradiation is performed on the charged photoreceptor. In this case, the lighted part of the photoreceptor generates photo-carriers, and thereby the charges on the surface of the photoreceptor are decayed. In this case, a current corresponding to the quantity of the generated carriers flows in the thickness direction of the photoreceptor. In contrast, a non-lighted part of the photoreceptor is fed to the discharging position after the developing and transferring processes (and optionally a cleaning process). If the potential of the non-lighted part is near the potential thereof just after the charging process, charges whose quantity is almost the same as that of charges passing through the photoreceptor in the imagewise light irradiation process pass through the photoreceptor in the discharging process. In general, images to be produced have a small image area propart, and therefore almost all charges pass through the photoreceptor in the discharging process in one image formation cycle. Provided that the image area propart is 10%, 90% of the current flown in the discharging process.

The electrostatic properties of a photoreceptor are largely influenced by the charges passing through the photoreceptor if the materials constituting the photoreceptor are deteriorated by the charges. Specifically, the residual potential of the photoreceptor increases depending on the quantity of the charges passing through the photoreceptor. If the residual potential increases, a problem in that the image density of the resultant toner image decreases occurs when a nega-posi developing method is used. Therefore, in order to prolong the life of a photoreceptor, the quantity of charges passing through the photoreceptor has to be reduced.

There is a proposal that image forming is performed without performing a discharging process. In this case, it is impossible to uniformly charge all the parts of the photoreceptor (which results in formation of a ghost image) unless a high power charger is used.

In order to reduce the quantity of charges passing through a photoreceptor, it is preferable to discharge the charges on the photoreceptor without using light. Accordingly, it is effective to reduce the potential of a non-lighted part of the photoreceptor by controlling the transfer bias. Specifically, it is preferable to reduce the potential of a non-lighted part of the photoreceptor to about (−)100V (preferably 0V) before the discharging process. In this case, the quantity of charges passing through the photoreceptor can be reduced. It is more preferable to charge the photoreceptor so as to have a potential with a polarity opposite to that of charges formed on the photoreceptor in the main charging process because photo-carriers are not generated in this case. However, in this case problems in that the toner image is scattered and the photoreceptor cannot be charged so as to have the predetermined potential unless a high power charger is used as the main charger occur. Therefore, the potential of the photoreceptor is preferably not greater than 100V after the transferring process.

### Fixer

When plural color images are transferred to form a multi-color (or full color) image, the fixing operation can be performed on each color image or on overlaid color images.

Known fixers can be used for the image forming apparatus of the present invention. Among the fixers, heat/pressure fixing devices including a combination of a heat roller and a pressure roller or a combination of a heat roller, a pressure roller and an endless belt are preferably used. The temperature of the heating member is preferably from 80 to 200° C. The fixer is not limited thereto, and known light fixers can also be used.

### Discharger

The discharger for use in the image forming apparatus of the present invention is not particularly limited, and known devices such as a fluorescent lamps, a tungsten lamp, a halogen lamp, a mercury lamps, a sodium lamp, and a xenon lamp, a LED, a LD and an EL. An optical filter capable of selectively obtaining light having a desired wavelength, such as a sharp-cut filter, a band pass filter, a near-infrared cutting filter, a dichroic filter, an interference filter and a color temperature converting filter can be used.

### Others

The image forming apparatus of the present invention can include a cleaner removing toner particles remaining on the surface of the photoreceptor even after the transfer process. The cleaner is not particularly limited, and known cleaners such as a magnetic brush cleaner, an electrostatic brush cleaner, a magnetic roller cleaner, a blade cleaner, a brush cleaner and a web cleaner can be used.

The image forming apparatus of the present invention can include a toner recycler feeding the toner particles collected by the cleaner to the image developer. The toner recycler is not particularly limited, and known powder feeders can be used therefor.

The image forming apparatus of the present invention can include a controller controlling the processes mentioned above. Any known controllers such as sequencers and computers can be used therefor.

The image forming apparatus of the present invention will be explained referring to drawings.

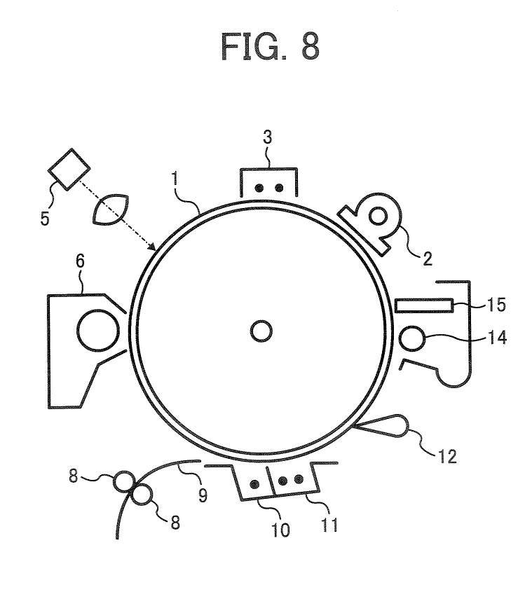

FIG. 8 is a schematic view illustrating an embodiment of the image forming apparatus. The image forming apparatus includes a photoreceptor 1 which includes at least an electroconductive substrate, a CGL including an organic CGM and located overlying the substrate and a CTL located overlying the CGL. Although a photoreceptor 1 has a drum-form, the shape is not limited thereto and sheet-form and endless belt-form photoreceptors can also be used.

Around the photoreceptor 1, a discharging lamp 2 discharging the charges remaining on the photoreceptor 1, a charger 3 charging the photoreceptor 1, a light irradiator 5 irradiating the photoreceptor 1 with imagewise light to form an electrostatic latent image on the photoreceptor 1, an image developer 6 developing the latent image with a toner to form a toner image on the photoreceptor 1, and a cleaner including a fur brush 14 and a cleaning blade 15 cleaning the surface of the photoreceptor 1 are arranged while contacting or being set closely to the photoreceptor 1. The toner image formed on the photoreceptor 1 is transferred on a receiving paper 9 fed by a pair of registration rollers 8 at a transferer (i.e., a pair of a transfer charger 10 and a separating charger 11). The receiving paper 9 having the toner image thereon is separated from the photoreceptor 1 by a separating pick 12.

As the charger 3, wire chargers and roller chargers are preferably used. When high speed charging is needed, scorotron chargers are preferably used. Roller chargers are preferably used for compact image forming apparatuses and tandem type image forming apparatuses because the amount of acidic gases such as NOx and SOx and ozone generated by charging is small. The strength of the electric field formed on the photoreceptor by the charger is preferably not less than 20 V/μm. In this regard, the greater the electric field strength, the better dot reproducibility the resultant image has. However, when the electric field strength is too high, problems in that the photoreceptor causes dielectric breakdown and carrier particles are adhered to an electrostatic latent image occur. Therefore, the electric field strength is preferably not greater than 60 V/μm and more preferably not greater than 50 V/μm.

Suitable light sources for use in the light irradiator 5 include light emitting diodes (LEDs), laser diodes (LDs) and electroluminescence devices (ELs) having high intensity light sources and emitting writing light having a wavelength shorter than 450 nm (a metal oxide in the intermediate layer does not absorb). The resolution of an electrostatic latent image (and a toner image) depends on the resolution of the image writing light. Namely, the higher the resolution of the image writing light, the better the resolution of the resultant electrostatic latent image. However, when the resolution of the image writing light is high, it takes a long time to write an image. When only one light source is used for image writing, the image processing speed (i.e., the speed of the image bearer) depends on the image writing speed. Therefore, when only one light source is used for image writing, the upper limit of the resolution is about 1,200 dpi (dots per inch). When plural light sources (n pieces) are used, the upper limit of the resolution is substantially 1,200 dpi×n. Among these light sources, LEDs and LDs are preferably used because of having high illuminance.

The image developer 6 includes at least one developing sleeve. The developing device develops an electrostatic latent image formed on the photoreceptor with a developer including a toner, using a nega-posi developing method. The current digital image forming apparatus uses a nega-posi developing method in which a toner is adhered to a lighted part because the image area propart of original images is low and therefore it is preferable for the light irradiating device to irradiate the image part of a photoreceptor with light in view of the life of the light irradiator. With respect to the developer, both one-component developers including only a toner, and two-component developers including a toner and a carrier can be used for the image forming apparatus of the present invention.

With respect to the transfer charger 10, transfer belts and transfer rollers can also be used therefor. Particularly, contact transfer belts and transfer rollers are preferably used because the amount of ozone generated during the transferring process is small. Both constant voltage type charging methods and constant current type charging methods can be used in the present invention, but constant current type charging methods are preferably used because constant transfer charges can be applied and thereby charging can be stably performed. In the transferring process, it is preferable to control the current flowing in the photoreceptor through the transfer member in the transferring process when a voltage is applied from a power source to the transferer.

The transfer current is flown due to application of charges to remove the toner, which is electrostatically adhered to the photoreceptor, from the photoreceptor and transfer the toner to a receiving material. In order to prevent occurrence of a transfer problem in that a part of a toner image is not transferred, the transfer current is increased. However, when a nega-posi developing method is used, a voltage having a polarity opposite to that of the charge formed on the photoreceptor is applied in the transferring process, and thereby the photoreceptor suffers a serious electrostatic fatigue. In the transferring process, the higher the transfer current, the better the transfer efficiency of a toner image, but a discharging phenomenon occurs between the photoreceptor and the receiving material if the current is greater than a threshold, resulting in formation of scattered toner images. Therefore, the transfer current is preferably controlled so as not to exceed the threshold current. The threshold current changes depending on the factors such as distance between the photoreceptor and the receiving material, and materials constituting the photoreceptor and the receiving material, but is generally about 200 μA to prevent occurrence of a discharging phenomenon.

The transfer method is classified into a direct transfer method in which the toner image is directly transferred to a receiving material; and an indirect transfer method in which the toner image is transferred to an intermediate transfer medium (primary transfer) and then transferred to a receiving material (secondary transfer). Both the transfer methods can be used for the image forming apparatus of the present invention.

As mentioned above, it is preferable to control the transfer current to decrease the potential of an unirradiated part of the photoreceptor, which results in decrease of quantity of charges passing through the photoreceptor in one image forming cycle.

Suitable light sources for use in the discharger 2 include known light sources such as a fluorescent lamps, a tungsten lamp, a halogen lamp, a mercury lamps, a sodium lamp, and a xenon lamp, a LED, a LD and an EL, particularly emitting light having a wavelength a metal oxide included the intermediate layer does no absorb. An optical filter capable of selectively obtaining light having a desired wavelength, such as a sharp-cut filter, a band pass filter, a near-infrared cutting filter, a dichroic filter, an interference filters and a color temperature converting filter can be used.

In FIG. 8 the cleaner uses a fur brush and a cleaning blade, but cleaning may be performed only by a cleaning brush. Known brushes such as a fur brush and a mag-fur brush can be used for the cleaning brush.

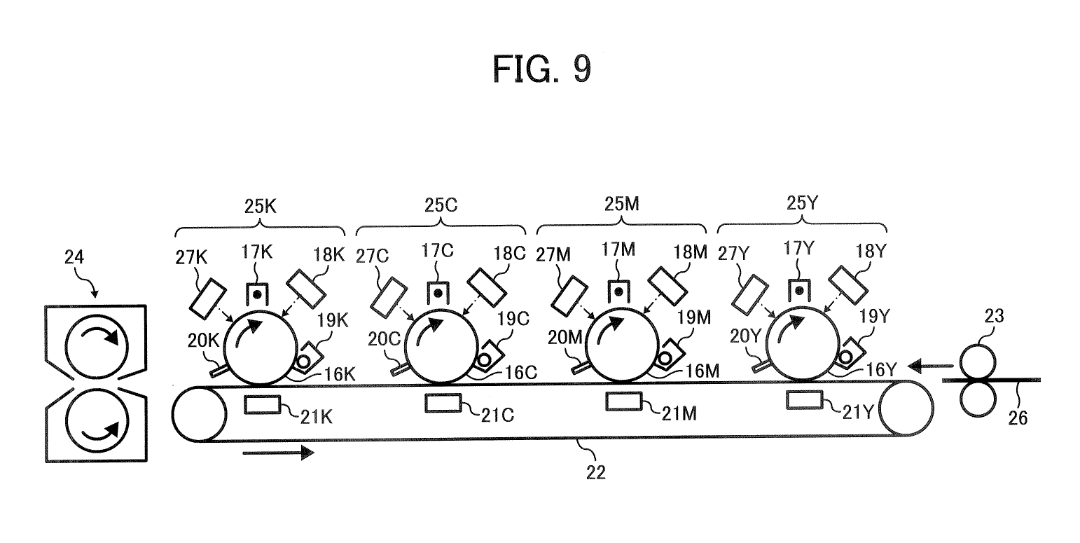

FIG. 9 is a schematic view illustrating another embodiment of the image forming apparatus (i.e., a tandem type image forming apparatus) of the present invention. In FIG. 9, the tandem type image forming apparatus has a yellow image forming unit 25Y, a magenta image forming unit 25M, a cyan image forming unit 25C, and a black image forming unit 25K. Drum photoreceptors 16Y, 16M, 16C and 16K, which are the photoreceptors mentioned above, each including at least an organic CGM in the CGL, and at least one of charge transport materials having the formulae (I) to (IV) in the CTL, rotate in the direction indicated by respective arrows. Around the photoreceptors 16Y, 16M, 16C and 16K, chargers 17Y, 17M, 17C and 17K, light irradiators 18Y, 18M, 18C and 18K, developing devices 19Y, 19M, 19C and 19K, cleaners 20Y, 20M, 20C and 20K and discharging devices 27Y, 27M, 27C and 27K are arranged respectively in this order in the clockwise direction. As the chargers, the above-mentioned chargers which can uniformly charge the surfaces of the photoreceptors are preferably used. The light irradiators 18Y, 18M, 18C and 18K irradiate the surfaces of the respective photoreceptors with laser light beams at points between the chargers and the image developers to form electrostatic latent images on the respective photoreceptors. The four image forming units 25, 25M, 25C and 25K are arranged along a transfer belt 22. The transfer belt 22 contacts the respective photoreceptors 16 at image transfer points located between the respective image developers and the respective cleaners to receive color images formed on the photoreceptors. At the backsides of the image transfer points of the transfer belt 22, transfer brushes 21Y, 21M, 21C and 21K are arranged to apply a transfer bias to the transfer belt 22. The image forming units have substantially the same configuration except that the color of the toner is different from each other.

The image forming process will be explained referring to FIG. 9.

At first, in each of the image forming units 25Y, 25M, 25C and 25K, the photoreceptors 16Y, 16M, 16C and 16K rotating in the direction indicated by the arrows are charged with the chargers 17Y, 17M, 17C and 17K so as to have electric fields of from 20 to 60 V/μm, and preferably from 20 to 50 V/μm. Then the light irradiators 18Y, 18M, 18C and 18K irradiate the photoreceptors 16Y, 16M, 16C and 16K with imagewise laser beams having a wavelength shorter than 450 nm, which is not absorbed in a metal oxide in the intermediate layer to form electrostatic latent images on each photoreceptor, which typically have a resolution of not less than 1,200 dpi (and preferably not less than 2,400 dpi).

Then the electrostatic latent image formed on the photoreceptor is developed with the developing devices 19Y, 19M, 19C and 19K using a yellow, a magenta, a cyan or a black toner to form different color toner images on the respective photoreceptors. The thus prepared color toner images are transferred onto a receiving material 26, which has been fed to a pair of registration roller 23 from a paper tray and which is timely fed to the transfer belt 22 by the registration rollers 23. Each of the toner images on the photoreceptors is transferred onto the receiving material 26 at the contact point (i.e., the transfer position) of each of the photoreceptors 16Y, 16M, 16C and 16K and the receiving material 26.

The toner image on each photoreceptor is transferred onto the receiving material 26 due to an electric field which is formed due to the difference between the transfer bias voltage applied to the transfer members 21Y, 21M, 21C and 21K and the potential of the respective photoreceptors 16Y, 16M, 16C and 16K. After passing through the four transfer positions, the receiving material 26 having the color toner images thereon is then transported to a fixer 24 so that the color toner images are fixed to the receiving material 26. Then the receiving material 26 is discharged from the main body of the image forming apparatus. Toner particles, which remain on the photoreceptors even after the transfer process, are collected by the respective cleaners 20Y, 20M, 20C and 20K.

Then the discharging devices 27Y, 27M, 27C and 27K remove residual potentials from the respective photoreceptors 16Y, 16M, 16C and 16K such that the photoreceptors 16Y, 16M, 16C and 16K are ready for the next image forming operation.

In the image forming apparatus, the image forming units 25Y, 25M, 25C and 25K are arranged in this order in the paper feeding direction, but the order is not limited thereto. In addition, when a black color image is produced, the operation of the photoreceptors 16Y, 16M and 16C other than the photoreceptor 16K may be stopped.

As mentioned above, it is preferable for the photoreceptors 16 to have a potential of not higher than 100V (i.e., −100V when the photoreceptor is negatively charged by a main charger). More preferably, the photoreceptor is charged so as to have a potential of not lower than +100V in the transferring process when the photoreceptor is negatively charged by a main charger (i.e., 100V with a polarity opposite to that of the charge formed on the photoreceptor). In this case, occurrence of the residual potential increasing problem can be well prevented.

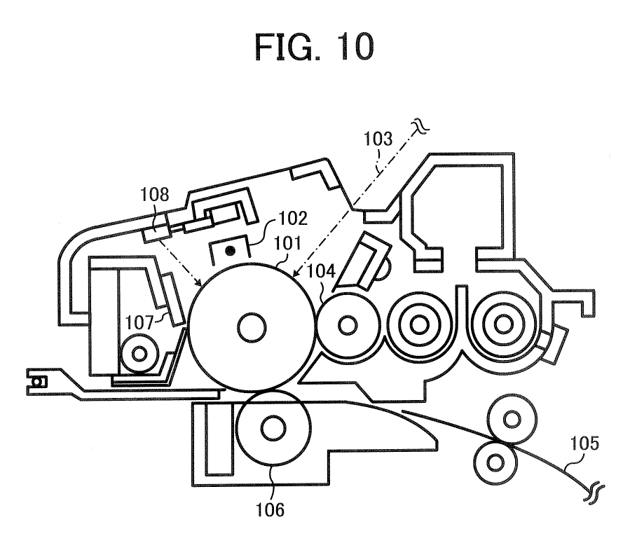

The above-mentioned image forming unit may fixedly be set in an image forming apparatus such as copiers, facsimiles and printers. However, the image forming unit may be set therein as a process cartridge. The process cartridge means an image forming unit which includes at least the photoreceptor mentioned above and one or more of the charging device, light irradiating device, a developing device, a transferring device, a cleaning device and a discharging device. FIG. 10 is a schematic view illustrating an embodiment of the process cartridge of the present invention. In FIG. 10, the process cartridge includes a photoreceptor 101 formed of a photosensitive layer including at least an intermediate layer including a metal oxide, a CGL including an organic CGM and a CTL including a charge transport material on a substrate.

A charger 102 charges the photoreceptor 101, a light irradiating device 103 irradiates the photoreceptor 101 with imagewise light having a wavelength shorter than 450 nm, which is not absorbed in the metal oxide in the intermediate layer to form an electrostatic latent image on the photoreceptor 101. A developing device 104 including a developing sleeve develops the latent image with a toner, an image transfer device 106 transfers the toner image onto a receiving paper 105, a cleaning device 107 cleans the surface of the photoreceptor 101, and a discharging device 108 discharges the photoreceptor 101.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

First, methods of synthesizing the azo pigments and titanylphthalocyanine crystals for use in the present invention will be explained. The azo pigments were prepared according to the methods disclosed in Published Examined Japanese Patent Application No. 60-29109 and Japanese Patent No. 3026645. The titanylphthalocyanine crystals were prepared according to the methods disclosed in Published Unexamined Japanese Patent Application Nos. 2001-19871 and 2004-83859.

### Synthesis of Titanylphthalocyanine Crystal

### Synthesis Example 1

A titanylphthalocyanine crystal was prepared by the method disclosed in Synthesis Example 1 of Published Unexamined Japanese Patent Application No. 2001-19871. Specifically, at first 29.2 g of 1,3-diiminoisoindoline and 200 ml of sulfolane were mixed. Then 20.4 g of titanium tetrabutoxide was dropped into the mixture under a nitrogen gas flow. The mixture was then heated to 180° C. and a reaction was performed for 5 hours at a temperature of from 170 to 180° C. while agitating. After the reaction, the reaction product was cooled, followed by filtering. The thus prepared wet cake was washed with chloroform until the cake colored blue. Then the cake was washed several times with methanol, followed by washing several times with hot water heated to 80° C. and drying. Thus, a crude titanylphthalocyanine was prepared. One part of the thus prepared crude titanylphthalocyanine was dropped into 20 parts of concentrated sulfuric acid to be dissolved therein. The solution was dropped into 100 parts of ice water while stirred, to precipitate a titanylphthalocyanine pigment. The pigment was obtained by filtering. The pigment was washed with ion-exchange water having a pH of 7.0 and a specific conductivity of 1.0 μS/cm until the filtrate became neutral. In this case, the pH and specific conductivity of the filtrate was 6.8 and 2.6 μS/cm. Thus, an aqueous paste of a titanylphthalocyanine pigment was obtained. Forty (40) grams of the thus prepared aqueous paste of the titanylphthalocyanine pigment, which has a solid content of 15% by weight, was added to 200 g of tetrahydrofuran (THF) and the mixture was stirred for about 4 hours. The weight ratio of the titanylphthalocyanine pigment to the crystal changing solvent (i.e., THF) was 1/33. Then the mixture was filtered and the wet cake was dried to prepare a titanylphthalocyanine powder (Pigment 1) The materials used therefor do not include a halogenated compound.

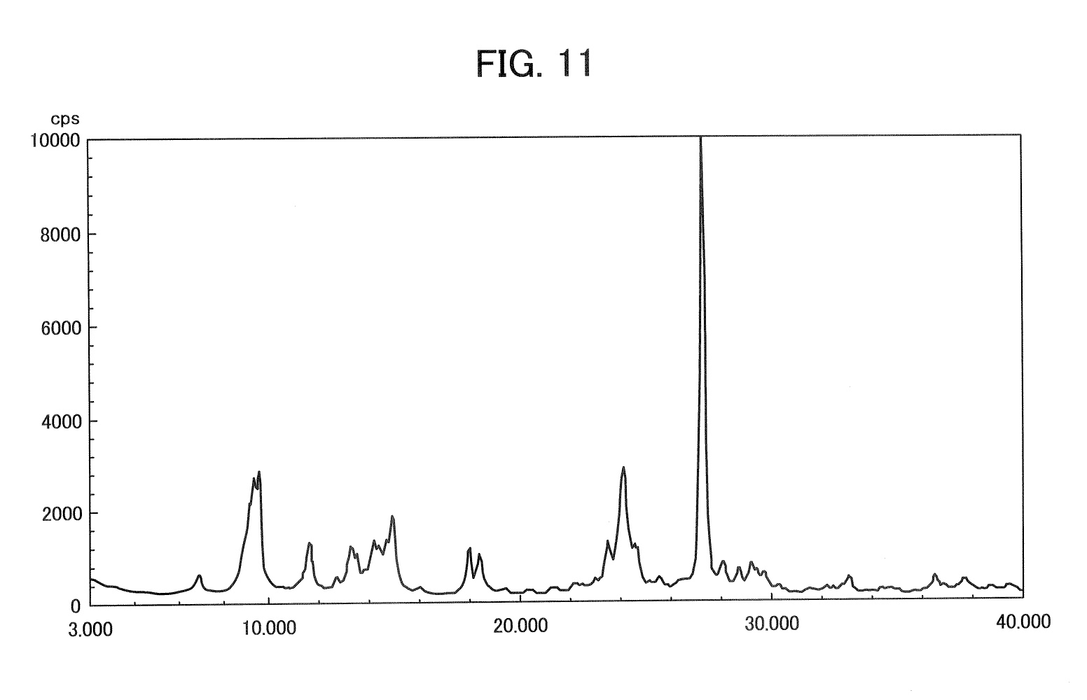

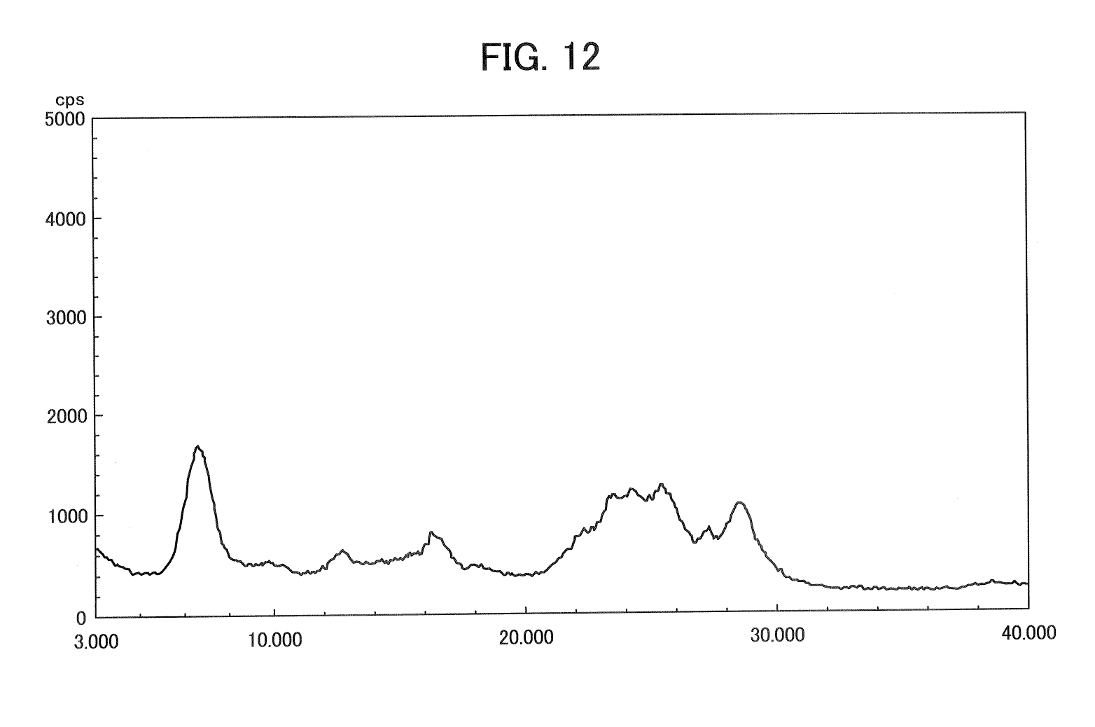

When the thus prepared titanylphthalocyanine powder was subjected to the X-ray diffraction analysis using a marketed X-ray diffraction analyzer RINT 1100 from Rigaku Corp. under the following conditions, it was confirmed that the titanylphthalocyanine powder has an X-ray diffraction spectrum such that a maximum peak is observed at a Bragg (2θ) angle of 27.2±0.2°, a lowest angle peak at an angle of 7.3±0.2°, and a main peak at each of angles of 9.4±0.2°, 9.6±0.2°, and 24.0±0.2°, wherein no peak is observed between the peaks of 7.3° and 9.4° and at an angle of 26.3. The X-ray diffraction spectrum thereof is illustrated in FIG. 11.

In addition, a part of the aqueous paste prepared above was dried at 80° C. for 2 days under a reduced pressure of 5 mmHg, to prepare a titanylphthalocyanine pigment, which has a low crystallinity. The X-ray diffraction spectrum of the titanylphthalocyanine pigment is illustrated in FIG. 12.

### X-Ray Diffraction Spectrum Measuring Conditions

X-ray tube: Cu

X-ray used: Cu—K_{α} having a wavelength of 1.542 Å

Voltage: 50 kV

Current: 30 mA

Scanning speed: 2°/min

Scanning range: 3° to 40°

Time constant: 2 seconds

### Synthesis Example 2

A titanylphthalocyanine crystal was prepared by the method disclosed in Example 1 of Published Unexamined Japanese Patent Application No. 2004-83859.

Specifically, 60 parts of the thus prepared aqueous paste of the titanylphthalocyanine pigment prepared in Synthesis Example 1 was added to 400 g of tetrahydrofuran (THF) and the mixture was strongly agitated with a HOMOMIXER (MARK IIf from Kenis Ltd.) at a revolution of 2,000 rpm until the color of the paste was changed from navy blue to light blue. The color was changed after the agitation was performed for about 20 minutes. In this regard, the ratio of the titanylphthalocyanine pigment to the crystal change solvent (THF) is 44. The dispersion was then filtered under a reduced pressure. The thus obtained cake on the filter was washed with tetrahydrofuran to prepare a wet cake of a titanylphthalocyanine crystal. The crystal was dried for 2 days at 70° C. under a reduced pressure of 5 mmHg. Thus, 8.5 parts of a titanylphthalocyanine crystal (Pigment 2) was prepared. No halogen-containing raw material was used for synthesizing the phthalocyanine crystal. The solid content of the wet cake was 15% by weight, and the weight ratio (S/C) of the solvent (S) used for crystal change to the wet cake (C) was 44.

A part of the aqueous paste of the titanylphthalocyanine pigment prepared above in Synthesis Example 1, which had not been subjected to a crystal change treatment, was diluted with ion-exchange water such that the resultant dispersion has a solid content of 1% by weight. The dispersion was placed on a 150-mesh copper net covered with a continuous collodion membrane and a conductive carbon layer. The titanylphthalocyanine pigment was observed with a transmission electron microscope (H-9000NAR from Hitachi Ltd., hereinafter referred to as a TEM) of 75,000 power magnification to measure the average particle size of the titanylphthalocyanine pigment. The average particle diameter thereof was determined as follows.

The image of particles of the titanylphthalocyanine pigment in the TEM was photographed. Among the particles (needle form particles) of the titanylphthalocyanine pigment in the photograph, 30 particles were randomly selected to measure the lengths of the particles in the long axis direction of the particles. The lengths were arithmetically averaged to determine the average particle diameter of the titanylphthalocyanine pigment. As a result, it was confirmed that the titanylphthalocyanine pigment in the aqueous paste prepared in Synthesis Example 5 has an average primary particle diameter of 0.06 μm.

Similarly, each of the phthalocyanine crystals prepared in Synthesis Examples 1 and 2, which had been subjected to the crystal change treatment but was not filtered, was diluted with tetrahydrofuran such that the resultant dispersion has a solid content of 1% by weight. The average particle diameters of Pigments 1 and 2 were determined by the method mentioned above. The results are shown in Table 1. In this regard, the form of the crystals was not uniform and includes triangle forms, quadrangular forms, etc. Therefore, the maximum lengths of the diagonal lines of the particles were arithmetically averaged.

TABLE 1

| | Average | |
|---|---|---|
| | particle | |
| Phthalocyanine | diameter | |
| crystal | (μm) | Note |
| Crystal 5 | 0.31 | Coarse particles having a particle |
| (Syn. Ex. 5) | | diameter of from 0.3 to 0.4 μm are |
| | | included, |
| Crystal 6 | 0.12 | The particle diameters of the crystal |
| (Syn. Ex. 6) | | are almost uniform. |

Pigment 2 was also subjected to the X-ray diffraction spectrum mentioned above. As a result, it was confirmed that the X-ray diffraction spectrum thereof is the same as that of Pigment 1.

### Dispersion Preparation Example 1

Formula of dispersion

| | |
|---|---|
| Titanylphthalocyanine (Pigment 1) | 15 |
| Polyvinyl butyral | 10 |
| (BX-1 from Sekisui Chemical Co., Ltd.) | |
| 2-butanone | 280 |

At first, the polyvinyl butyral resin was dissolved in the solvent. The solution was mixed with phthalocyanine crystal and the mixture was subjected to a dispersion treatment for 30 minutes using a bead mill DISPERMAT SL-05C1-EX from VMA-Getzmann GmbH, including PSZ balls having a diameter of 0.5 mm and rotating at a revolution of 1200 rpm to prepare a dispersion 1.

### Dispersion Preparation Example 2

The procedure for preparation of dispersion 1 was repeated to prepare a dispersion 2 except for replacing the Pigment 1 with the Pigment 2

### Dispersion Preparation Example 3

The procedure for preparation of dispersion 1 was repeated to prepare a dispersion 3 except for being filtered with a cotton wind cartridge filter (TCW-1-CS from Advantech Co., Ltd.) having an effective pore diameter of 1 μm under pressure using a pump.

### Dispersion Preparation Example 4

The procedure for preparation of dispersion 3 was repeated to prepare a dispersion 4 except for being filtered with a cotton wind cartridge filter (TCW-3-CS from Advantech Co., Ltd.) having an effective pore diameter of 3 μm under pressure using a pump.

### Dispersion Preparation Example 5

Formula of dispersion

| | |
|---|---|
| Azo pigment having the following formula | 5 |

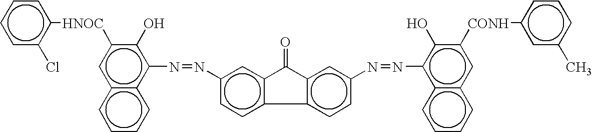

| | |
|---|---|
| Polyvinyl butyral (BX-1 from Sekisui Chemical Co., Ltd.) | 2 |
| Cyclohexanone | 250 |
| 2-butanone | 100 |

At first, the polyvinyl butyral resin was dissolved in the solvents. The solution was mixed with the azo pigment and the mixture was subjected to a dispersion treatment for 7 days using a ball mill which includes PSZ balls having a diameter of 10 mm and which is rotated at a revolution of 85 rpm to prepare a dispersion 5.

### Dispersion Preparation Example 6

The procedure for preparation of dispersion 5 in Dispersion Preparation Example 5 was repeated to prepare a dispersion 6except for replacing the azo pigment with an azo pigment having the following formula.

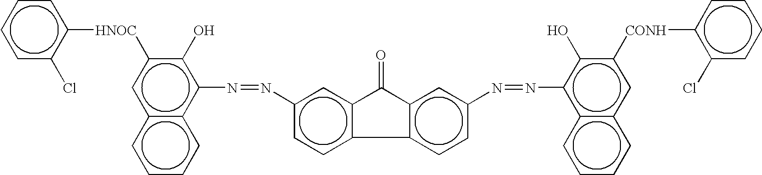

The particle diameter distributions of the pigments in the thus prepared dispersions 1 to 6 were measured with a particle diameter measuring instrument (CAPA-700 from Horiba Ltd.) The results are shown in Table 2.

TABLE 2

| | Average | Standard deviation |
|---|---|---|
| | particle diameter | of particle diameter |
| Dispersion | (μm) | (μm) |
| Dispersion 1 | 0.29 | 0.18 |
| Dispersion 2 | 0.19 | 0.13 |
| Dispersion 3 | 0.22 | 0.16 |
| Dispersion 4 | 0.24 | 0.17 |
| Dispersion 5 | 0.26 | 0.18 |
| Dispersion 6 | 0.27 | 0.17 |

### Photoreceptor Preparation Example 1

On an aluminum drum of JIS 1050 having a diameter of 30 mm, the following intermediate layer coating liquid, CGL coating liquid, and CTL coating liquid were coated and dried one by one to prepare a multi-layered photoreceptor (Photoreceptor 1) having an intermediate transfer layer having a thickness of 3.5 μm, a CGL and a CTL having a thickness of 25 μm.

The thickness of the CGL was adjusted to have a transmission of 20% when formed as follows:

winding a polyethyleneterephthalate film around an aluminum drum having a diameter of 30 mm to prepare a substrate,

coating the substrate with the CGL coating liquid, and

measuring the transmission against light having a wavelength of 445 nm with a marketed spectral photometer UV-3100 from Shimadzu Corp.

The CTL had a transmission of 98% against light having a wavelength of 445 nm when measured by the same method.

Formula of intermediate layer coating liquid

| | |
|---|---|
| Surface-untreated | 120.6 |
| anatase-type titanium oxide | |
| (KA-10 from Titan Kogyo K.K., having an average particle | |
| diameter of 0.40 μm) | |
| Alkyd resin | 33.6 |
| (BEKKOLITEM6401-50-S from Dainippon Ink & Chemicals, Inc., | |
| solid content of 50%) | |
| Melamine resin | 18.7 |
| (SUPER BEKKAMIN L-121-60 from Dainippon Ink & Chemicals, | |
| Inc., solid content of 60%) | |
| 2-Butanone | 260 |

### Formula of CGL Coating Liquid

Dispersion 1 prepared above was used as the CGL coating liquid.

Formula of CTL coating liquid

| | |
|---|---|
| Polycarbonate (TS2050 from Teijin Chemicals Ltd.) | 10 |
| CTM having the following formula: | 7 |

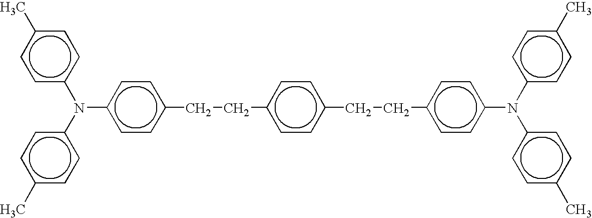

| | |
|---|---|
| Methylene chloride | 80 |

The intermediate layer coating liquid was coated on an aluminum plate having a thickness of 1 mm to form an intermediate layer thereon. The spectral reflectance of the intermediate layer was measured with a marketed spectral photometer UV-3100 from Shimadzu Corp. The absorption end of the anatase-type titanium oxide was determined to be about 390 nm from the spectral reflectance.

### Photoreceptor Preparation Example 2

The procedure for preparation of photoreceptor 1 in Photoreceptor Preparation Example 1 was repeated to prepare a photoreceptor 2 except for replacing the surface-untreated anatase-type titanium oxide in the intermediate coating liquid with aluminum-treated anatase-type titanium oxide.

The surface-untreated anatase-type titanium oxide in Photoreceptor Preparation Example 1 was surface-treated with an aluminum coupling agent in an amount of 2% by weight to form prepare the aluminum-treated anatase-type titanium oxide.

The intermediate layer coating liquid was coated on an aluminum plate having a thickness of 1 mm to form an intermediate layer thereon. The spectral reflectance of the intermediate layer was measured with a marketed spectral photometer UV-3100 from Shimadzu Corp. The absorption end of the anatase-type titanium oxide was determined to be about 390 nm from the spectral reflectance.

### Photoreceptor Preparation Example 3

The procedure for preparation of photoreceptor 1 in Photoreceptor Preparation Example 1 was repeated to prepare a photoreceptor 3 except for replacing the surface-untreated anatase-type titanium oxide in the intermediate coating liquid with 112 parts of surface-untreated rutile-type titanium oxide (CR-EL from Ishihara Sangyo Kaisha Ltd., having an average particle diameter of 0.25 μm)

The intermediate layer coating liquid was coated on an aluminum plate having a thickness of 1 mm to form an intermediate layer thereon. The spectral reflectance of the intermediate layer was measured with a marketed spectral photometer UV-3100 from Shimadzu Corp. The absorption end of the rutile-type titanium oxide was determined to be about 410 nm from the spectral reflectance.

### Photoreceptor Preparation Example 4

The procedure for preparation of photoreceptor 1 in Photoreceptor Preparation Example 1 was repeated to prepare a photoreceptor 4 except for replacing the surface-untreated rutile-type titanium oxide in the intermediate coating liquid with 112 parts of siloxane-treated rutile-type titanium oxide.

The surface-untreated rutile-type titanium oxide in Photoreceptor Preparation Example 3 was surface-treated with siloxane in an amount of 2% by weight to form prepare the aluminum-treated anatase-type titanium oxide.

The intermediate layer coating liquid was coated on an aluminum plate having a thickness of 1 mm to form an intermediate layer thereon. The spectral reflectance of the intermediate layer was measured with a marketed spectral photometer UV-3100 from Shimadzu Corp. The absorption end of the rutile-type titanium oxide was determined to be about 410 nm from the spectral reflectance.

### Photoreceptor Preparation Example 5

The procedure for preparation of photoreceptor 1 in Photoreceptor Preparation Example 1 was repeated to prepare a photoreceptor 5 except for replacing the surface-untreated rutile-type titanium oxide in the intermediate coating liquid with 112 parts of surface-untreated zinc oxide (SAZEX#2000 from Sakai Chemical Industry Co., Ltd.)

The intermediate layer coating liquid was coated on an aluminum plate having a thickness of 1 mm to form an intermediate layer thereon. The spectral reflectance of the intermediate layer was measured with a marketed spectral photometer UV-3100 from Shimadzu Corp. The absorption end of the zinc oxide was determined to be about 388 nm from the spectral reflectance.

### Photoreceptor Preparation Example 6

The procedure for preparation of photoreceptor 2 in Photoreceptor Preparation Example 2 was repeated to prepare a photoreceptor 6 except for changing the thickness of the CGL so as to have a transmission of 12% against light having a wavelength of 445 nm.

### Photoreceptor Preparation Example 7

The procedure for preparation of photoreceptor 2 in Photoreceptor Preparation Example 2 was repeated to prepare a photoreceptor 7 except for changing the thickness of the CGL so as to have a transmission of 8% against light having a wavelength of 445 nm.

### Photoreceptor Preparation Example 8

The procedure for preparation of photoreceptor 2 in Photoreceptor Preparation Example 2 was repeated to prepare a photoreceptor 8 except for changing the thickness of the CGL so as to have a transmission of 26% against light having a wavelength of 445 nm.

### Photoreceptor Preparation Example 9

The procedure for preparation of photoreceptor 5 in Photoreceptor Preparation Example 5 was repeated to prepare a photoreceptor 9 except for changing the thickness of the CGL so as to have a transmission of 12% against light having a wavelength of 445 nm.

### Photoreceptor Preparation Example 10

The procedure for preparation of photoreceptor 5 in Photoreceptor Preparation Example 5 was repeated to prepare a photoreceptor 10 except for changing the thickness of the CGL so as to have a transmission of 8% against light having a wavelength of 445 nm.

### Photoreceptor Preparation Example 11

The procedure for preparation of photoreceptor 5 in Photoreceptor Preparation Example 5 was repeated to prepare a photoreceptor 11 except for changing the thickness of the CGL so as to have a transmission of 26% against light having a wavelength of 445 nm.

### Photoreceptor Preparation Example 12

The procedure for preparation of photoreceptor 2 in Photoreceptor Preparation Example 2 was repeated to prepare a photoreceptor 12 except for changing the CTM in the CTL to a CTM having the following formula:

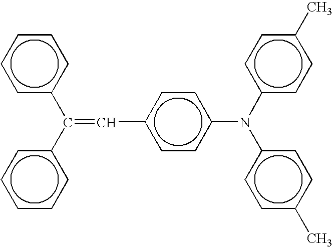

The CTL had a transmission of 40% against light having a wavelength of 445 nm when measured by the same method in Photoreceptor Preparation Example 1.

### Photoreceptor Preparation Example 13

The procedure for preparation of photoreceptor 12 in Photoreceptor Preparation Example 12 was repeated to prepare a photoreceptor 13 except for changing the CTL coating liquid to a CTL coating liquid having the following formula:

| | |
|---|---|
| Polycarbonate | 10 |
| (TS2050 from Teijin Chemicals Ltd.) | |
| CTM having the following formula: | 10 |
| 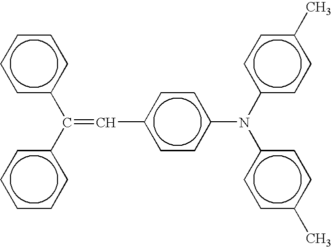 | |
| Methylene chloride | 80 |

The CTL had a transmission of 25% against light having a wavelength of 445 nm when measured by the same method in Photoreceptor Preparation Example 1.

### Example 1

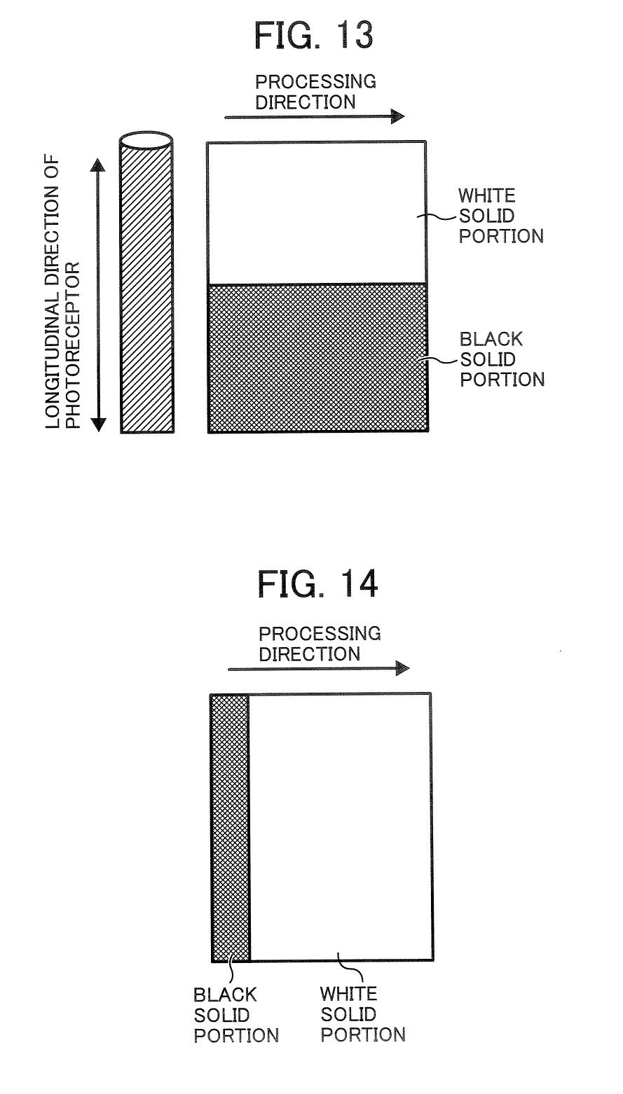

The photoreceptor 1 was set in an image forming apparatus having a structure illustrated in FIG. 9, and a running test in which 50,000 copies of a chart in FIG. 13 are continuously produced was performed under the following conditions.

Light irradiator: Irradiator having a writing light source including a laser diode emitting light having a wavelength of 445 nm, and a polygon mirror used

Charger: Scorotron charger

Transferer: Transfer belt

Discharger: Discharging lamp including a LED (from Rohm Co., Ltd.) which emits light having a wavelength of 660 nm

Potential of charged photoreceptor: −900 V

(potential of non-lighted part)

Developing method: Nega-posi developing method

Developing bias: −650 V

Potential of non-lighted part of photoreceptor after discharging process: −120 V

The potentials of a lighted part and a non-lighted part of the photoreceptor were measured at the beginning of the running test and after the running test. Even after the running test the charging and irradiating conditions were same as those of the beginning thereof. Specifically, the photoreceptor was charged so as to have a potential of −900 V, and then the light irradiator irradiates the charged photoreceptor to form a solid electrostatic latent image. Then the potential of the lighted part and a non-lighted part of the black and blank of the chart in FIG. 13 were measured with an electrometer set in the developing position illustrated in FIG. 9. The evaluation results are shown in Table 3.

After the running test, a halftone image of the chart in FIG. 13 was produced to observe the black and blank parts thereof.

### Example 2

The procedure for evaluation of the photoreceptor 1 in Example 1 was repeated to evaluate the photoreceptor 2 except for replacing the photoreceptor 1 with the photoreceptor 2. The evaluation results are shown in Table 3.

### Example 3

The procedure for evaluation of the photoreceptor 1 in Example 1 was repeated to evaluate the photoreceptor 3 except for replacing the photoreceptor 1 with the photoreceptor 3. The evaluation results are shown in Table 3.

### Example 4

The procedure for evaluation of the photoreceptor 1 in Example 1 was repeated to evaluate the photoreceptor 4 except for replacing the photoreceptor 1 with the photoreceptor 4. The evaluation results are shown in Table 3.

### Example 5

The procedure for evaluation of the photoreceptor 1 in Example 1 was repeated to evaluate the photoreceptor 5 except for replacing the photoreceptor 1 with the photoreceptor 5. The evaluation results are shown in Table 3.

### Example 6

The procedure for evaluation of the photoreceptor 1 in Example 1 was repeated to evaluate the photoreceptor 1 except for changing the writing light source to a LD emitting light having a wavelength of 407 nm. The CTL had a transmission of 98% against the light having a wavelength of 407 nm. The evaluation results are shown in Table 3.

### Example 7

The procedure for evaluation of the photoreceptor 1 in Example 6 was repeated to evaluate the photoreceptor 2 except for replacing the photoreceptor 1 with the photoreceptor 2. The evaluation results are shown in Table 3.

### Comparative Example 1

The procedure for evaluation of the photoreceptor 1 in Example 6 was repeated to evaluate the photoreceptor 3 except for replacing the photoreceptor 1 with the photoreceptor 3. The evaluation results are shown in Table 3.

### Comparative Example 2

The procedure for evaluation of the photoreceptor 1 in Example 6 was repeated to evaluate the photoreceptor 4 except for replacing the photoreceptor 1 with the photoreceptor 4. The evaluation results are shown in Table 3.

### Example 8

The procedure for evaluation of the photoreceptor 1 in Example 6 was repeated to evaluate the photoreceptor 5 except for replacing the photoreceptor 1 with the photoreceptor 5. The evaluation results are shown in Table 3.

### Comparative Example 3

The procedure for evaluation of the photoreceptor 1 in Example 1 was repeated to evaluate the photoreceptor 1 except for changing the writing light source to a LD emitting light having a wavelength of 375 nm. The evaluation results are shown in Table 3.

### Comparative Example 4

The procedure for evaluation of the photoreceptor 1 in Comparative Example 3 was repeated to evaluate the photoreceptor 2 except for replacing the photoreceptor 1 with the photoreceptor 2. The evaluation results are shown in Table 3.

### Comparative Example 5

The procedure for evaluation of the photoreceptor 1 in Comparative Example 3 was repeated to evaluate the photoreceptor 3 except for replacing the photoreceptor 1 with the photoreceptor 3. The evaluation results are shown in Table 3.

### Comparative Example 6

The procedure for evaluation of the photoreceptor 1 in Comparative Example 3 was repeated to evaluate the photoreceptor 4 except for replacing the photoreceptor 1 with the photoreceptor 4. The evaluation results are shown in Table 3.

### Comparative Example 7

The procedure for evaluation of the photoreceptor 1 in Comparative Example 3 was repeated to evaluate the photoreceptor 5 except for replacing the photoreceptor 1 with the photoreceptor 5. The evaluation results are shown in Table 3.

### Example 9

The procedure for evaluation of the photoreceptor 2 in Example 2 was repeated to evaluate the photoreceptor 6 except for replacing the photoreceptor 2 with the photoreceptor 6. The evaluation results are shown in Table 3.

### Example 10

The procedure for evaluation of the photoreceptor 2 in Example 2 was repeated to evaluate the photoreceptor 7 except for replacing the photoreceptor 2 with the photoreceptor 7. The evaluation results are shown in Table 3.

### Example 11

The procedure for evaluation of the photoreceptor 2 in Example 2 was repeated to evaluate the photoreceptor 8 except for replacing the photoreceptor 2 with the photoreceptor 8. The evaluation results are shown in Table 3.

### Example 12

The procedure for evaluation of the photoreceptor 5 in Example 5 was repeated to evaluate the photoreceptor 9 except for replacing the photoreceptor 5 with the photoreceptor 9. The evaluation results are shown in Table 3.

### Example 13

The procedure for evaluation of the photoreceptor 5 in Example 5 was repeated to evaluate the photoreceptor 10 except for replacing the photoreceptor 5 with the photoreceptor 10. The evaluation results are shown in Table 3.

### Example 14

The procedure for evaluation of the photoreceptor 5 in Example 5 was repeated to evaluate the photoreceptor 11 except for replacing the photoreceptor 5 with the photoreceptor 11. The evaluation results are shown in Table 3.

### Example 15

The procedure for evaluation of the photoreceptor 2 in Example 2 was repeated to evaluate the photoreceptor 12 except for replacing the photoreceptor 2 with the photoreceptor 12. The evaluation results are shown in Table 3.

### Example 16

The procedure for evaluation of the photoreceptor 2 in Example 2 was repeated to evaluate the photoreceptor 13 except for replacing the photoreceptor 2 with the photoreceptor 13. The evaluation results are shown in Table 3.

TABLE 3

| | | | Initial | | After 50,000 | |
|---|---|---|---|---|---|---|
| | | | Non-lighted | Lighted | Non-lighted | Lighted |
| | | Image FIG. | part | part | part | part |
| | Wavelength | 13 | potential | potential | potential | potential |
| Ex. 1 | 445 | Black | 900 | 120 | 900 | 135 |
| | | Blank | 900 | 120 | 900 | 135 |
| Ex. 2 | 445 | Black | 900 | 120 | 900 | 140 |
| | | Blank | 900 | 120 | 900 | 140 |
| Ex. 3 | 445 | Black | 900 | 120 | 900 | 135 |
| | | Blank | 900 | 120 | 900 | 135 |
| Ex. 4 | 445 | Black | 900 | 120 | 890 | 135 |
| | | Blank | 900 | 120 | 890 | 135 |
| Ex. 5 | 445 | Black | 900 | 120 | 890 | 130 |
| | | Blank | 900 | 120 | 890 | 130 |
| Ex. 6 | 407 | Black | 900 | 120 | 900 | 135 |
| | | Blank | 900 | 120 | 900 | 135 |
| Ex. 7 | 407 | Black | 900 | 120 | 900 | 140 |
| | | Blank | 900 | 120 | 900 | 140 |
| Com. | 407 | Black | 900 | 120 | 850 | 125 |
| Ex. 1 | | Blank | 900 | 120 | 900 | 135 |
| Com. | 407 | Black | 900 | 120 | 870 | 130 |
| Ex. 2 | | Blank | 900 | 120 | 900 | 135 |
| Ex. 8 | 407 | Black | 900 | 120 | 890 | 135 |
| | | Blank | 900 | 120 | 890 | 135 |
| Com. | 375 | Black | 900 | 120 | 860 | 130 |
| Ex. 3 | | Blank | 900 | 120 | 900 | 135 |
| Com. | 375 | Black | 900 | 120 | 870 | 130 |
| Ex. 4 | | Blank | 900 | 120 | 900 | 140 |
| Com. | 375 | Black | 900 | 120 | 830 | 125 |
| Ex. 5 | | Blank | 900 | 120 | 900 | 135 |
| Com. | 375 | Black | 900 | 120 | 850 | 130 |
| Ex. 6 | | Blank | 900 | 120 | 890 | 135 |
| Com. | 375 | Black | 900 | 120 | 870 | 130 |
| Ex. 7 | | Blank | 900 | 120 | 890 | 130 |
| Ex. 9 | 445 | Black | 900 | 120 | 900 | 130 |
| | | Blank | 900 | 120 | 900 | 130 |
| Ex. 10 | 445 | Black | 900 | 120 | 890 | 125 |
| | | Blank | 900 | 120 | 890 | 125 |
| Ex. 11 | 445 | Black | 900 | 120 | 900 | 160 |
| | | Blank | 900 | 120 | 900 | 160 |
| Ex. 12 | 445 | Black | 900 | 120 | 890 | 120 |
| | | Blank | 900 | 120 | 890 | 120 |
| Ex. 13 | 445 | Black | 900 | 120 | 880 | 115 |
| | | Blank | 900 | 120 | 880 | 115 |
| Ex. 14 | 445 | Black | 900 | 120 | 900 | 150 |
| | | Blank | 900 | 120 | 900 | 150 |
| Ex. 15 | 445 | Black | 900 | 120 | 900 | 150 |
| | | Blank | 900 | 120 | 900 | 150 |
| Ex. 16 | 445 | Black | 900 | 120 | 900 | 165 |
| | | Blank | 900 | 120 | 900 | 165 |

The photoreceptors in Examples 1 to 8, wherein each of the writing light has a wavelength shorter than 450 nm and is not absorbed in a metal oxide in the intermediate layer, vary less in electrostatic properties than those in Comparative Examples 1 to 7 after repeatedly used.

The photoreceptors in Comparative Examples 2, 4 and 6, wherein each of the metal oxide is surface-treated, vary slightly less in electrostatic properties than those in Comparative Examples 1, 3 and 5.

In addition, the photoreceptors in Examples 1 to 8 did not produce abnormal halftone images even after producing 50,000 images, but Comparative Examples 1 to 7 produced halftone images wherein the black parts had density higher than the blank parts.

The photoreceptors in Examples 10 and 13, the CGLs each of which has a transmission less than 10% slightly deteriorate the non-lighted part potential after repeatedly used more than Examples 2, 5, 9 and 12, the CGLs each of which has a transmission of from 10 to 25%. Meanwhile, the photoreceptors in Examples 11 and 14, the CGLs each of which has a transmission greater than 25% slightly increase the lighted part potential after repeatedly used more than Examples 2, 5, 9 and 12, the CGLs each of which has a transmission of from 10 to 25%.

The photoreceptor in Example 16, the CTL of which has a transmission less than 30% slightly increase the lighted part potential after repeatedly used more than Examples 2 and 15, the CTLs each of which has a transmission not less than 30%.

### Photoreceptor Preparation Example 14

The procedure for preparation of photoreceptor 2 in Photoreceptor Preparation Example 2 was repeated to prepare a photoreceptor 14 except for changing the CGL coating liquid to the dispersion 2. The thickness of the CGL was adjusted to have a transmission of 20% against light having a wavelength of 445 nm.

### Photoreceptor Preparation Example 15

The procedure for preparation of photoreceptor 2 in Photoreceptor Preparation Example 2 was repeated to prepare a photoreceptor 15 except for changing the CGL coating liquid to the dispersion 3. The thickness of the CGL was adjusted to have a transmission of 20% against light having a wavelength of 445 nm.

### Photoreceptor Preparation Example 16

The procedure for preparation of photoreceptor 2 in Photoreceptor Preparation Example 2 was repeated to prepare a photoreceptor 16 except for changing the CGL coating liquid to the dispersion 4. The thickness of the CGL was adjusted to have a transmission of 20% against light having a wavelength of 445 nm.

### Example 17

The procedure for evaluation of the photoreceptor 2 in Example 2 was repeated to evaluate the photoreceptor 14 except for replacing the photoreceptor 2 with the photoreceptor 14. A blank image was produced after 50,000 images were produced to evaluate background fouling. The evaluation results are shown in Table 4 together with those of Example 2.

### Example 18

The procedure for evaluation of the photoreceptor 2 in Example 2 was repeated to evaluate the photoreceptor 15 except for replacing the photoreceptor 2 with the photoreceptor 15. A blank image was produced after 50,000 images were produced to evaluate background fouling. The evaluation results are shown in Table 4.

### Example 19

The procedure for evaluation of the photoreceptor 2 in Example 2 was repeated to evaluate the photoreceptor 16 except for replacing the photoreceptor 2 with the photoreceptor 16. A blank image was produced after 50,000 images were produced to evaluate background fouling. The evaluation results are shown in Table 4.

The background fouling was evaluated from the number and sizes of black spots, and classified to the following 4 grades.

TABLE 4

| | | Initial | | After 50,000 | | |
|---|---|---|---|---|---|---|
| | | Non-lighted | Lighted | Non-lighted | Lighted | |
| | | part | part | part | part | Background |
| | | potential | potential | potential | potential | fouling |
| Ex. 1 | Black | 900 | 120 | 900 | 140 | Δ~◯ |
| | Blank | 900 | 120 | 900 | 140 | Δ~◯ |
| Ex. 17 | Black | 900 | 110 | 900 | 130 | ⊚ |
| | Blank | 900 | 110 | 900 | 130 | ⊚ |
| Ex. 18 | Black | 900 | 110 | 900 | 130 | ⊚ |
| | Blank | 900 | 110 | 900 | 130 | ⊚ |
| Ex. 19 | Black | 900 | 110 | 890 | 135 | ◯ |
| | Blank | 900 | 110 | 890 | 130 | ◯ |

When the pigment in the CGL coating liquid (in Examples 17 to 19) has an average particle diameter not greater than 0.25 μm, the initial surface potential of the resultant photoreceptor can be lowered and background fouling can be prevented without electrostatic fatigue after repeatedly used.

### Photoreceptor Preparation Example 17

The procedure for preparation of photoreceptor 2 in Photoreceptor Preparation Example 2 was repeated to prepare a photoreceptor 17 except for changing the thickness of the CTL to 23 μm and forming a protection layer having a thickness of 2 μm with a protection layer coating liquid having the following formula on the CTL.

Formula of protection layer coating liquid

| | |
|---|---|
| Polycarbonate (TS2050 from Teijin Chemicals Ltd.) | 10 |
| CTM having the following formula: | 7 |

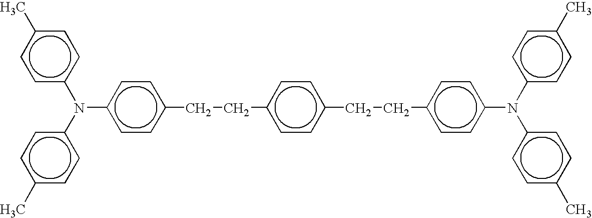

| | |
|---|---|
| Particulate alumina | 4 |
| (having a specific resistivity of 2.5 × 10¹² Ω · cm and an average primary particle | |
| diameter of 0.4 μm) | |
| Cyclohexanone | 500 |
| Tetrahydrofuran | 150 |

The transmission of the protection layer was measured as follows:

winding a polyethyleneterephthalate film around an aluminum drum having a diameter of 30 mm to prepare a substrate,

coating the substrate with the protection layer coating liquid, and

measuring the transmission against light having a wavelength of 407 nm with a marketed spectral photometer UV-3100 from Shimadzu Corp.

The protection layer had a transmission of 98% against light having a wavelength of 407 nm and the CTL had also the same transmission of 98%.

### Photoreceptor Preparation Example 18

The procedure for preparation of photoreceptor 17 in Photoreceptor Preparation Example 17 was repeated to prepare a photoreceptor 18 except for changing the particulate alumina in the protection layer coating liquid to a particulate titanium oxide having a specific resistivity of 1.5×10¹⁰ Ω·cm and an average primary particle diameter of 0.5 μm. The protection layer had a transmission of 95% against light having a wavelength of 407 nm when measured by the same method in Photoreceptor Preparation Example 17.

### Photoreceptor Preparation Example 19

The procedure for preparation of photoreceptor 17 in Photoreceptor Preparation Example 17 was repeated to prepare a photoreceptor 19 except for changing the particulate alumina in the protection layer coating liquid to a tin oxide-antimony oxide powder having a specific resistivity of 10⁶ Ω·cm and an average primary particle diameter of 0.4 μm. The protection layer had a transmission of 90% against light having a wavelength of 407 nm when measured by the same method in Photoreceptor Preparation Example 17.

### Photoreceptor Preparation Example 20

The procedure for preparation of photoreceptor 17 in Photoreceptor Preparation Example 17 was repeated to prepare a photoreceptor 20 except for changing the protection layer coating liquid to a protection layer coating liquid having the following formula:

Formula of protection layer coating liquid

| | |
|---|---|
| Charge transport polymer material | 17 |
| having a weight-average molecular weight of about 140,000 and the following | |
| formula: | |

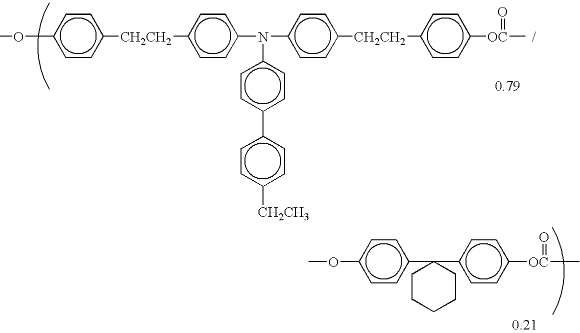

| | |
|---|---|
| Particulate alumina | 4 |
| (having a specific resistivity of 2.5 × 10^{12 Ω} · cm and an average primary particle | |
| diameter of 0.4 μm) | |
| Cyclohexanone | 500 |
| Tetrahydrofuran | 150 |

The protection layer had a transmission of 90% against light having a wavelength of 407 nm when measured by the same method in Photoreceptor Preparation Example 17.

### Photoreceptor Preparation Example 21

The procedure for preparation of photoreceptor 17 in Photoreceptor Preparation Example 17 was repeated to prepare a photoreceptor 21 except for changing the protection layer coating liquid to a protection layer coating liquid having the following formula:

Formula of protection layer coating liquid

| | |
|---|---|
| Methyltrimethoxysilane | 100 |
| Acetic acid having a concentration of 3% | 20 |
| Charge transport material | 35 |
| having the following formula: | |

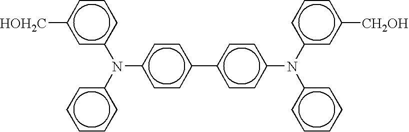

| | |
|---|---|
| Antioxidant | 1 |
| (Sanol LS2626 from SANKYO LIFETECH CO., LTD.) | |
| Hardener (dibutyltinacetate) | 1 |
| 2-propanol | 200 |

The protection layer had a transmission of 38% against light having a wavelength of 407 nm when measured by the same method in Photoreceptor Preparation Example 17.

### Photoreceptor Preparation Example 22

The procedure for preparation of photoreceptor 17 in Photoreceptor Preparation Example 17 was repeated to prepare a photoreceptor 22 except for changing the protection layer coating liquid to a protection layer coating liquid having the following formula:

Formula of protection layer coating liquid

| | |
|---|---|
| Methyltrimethoxysilane | 100 |
| Acetic acid having a concentration of 3% | 20 |
| Charge transport material | 35 |
| having the following formula: | |

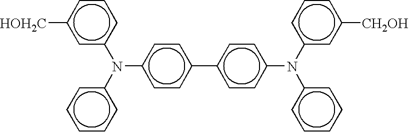

| | |
|---|---|
| Particulate alumina | 15 |
| (having a specific resistivity of 2.5 × 10^{12 Ω} · cm and an average | |
| average primary particle diameter of 0.4 μm) | |
| Antioxidant | 1 |
| (Sanol LS2626 from SANKYO LIFETECH CO., LTD.) | |
| Polycarboxylic compound | 0.4 |
| (BYK P104 from BYK-Chemie GmbH) | |
| Hardener (dibutyltinacetate) | 1 |
| 2-propanol | 200 |

The protection layer had a transmission of 32% against light having a wavelength of 407 nm when measured by the same method in Photoreceptor Preparation Example 17.

### Photoreceptor Preparation Example 23

The procedure for preparation of photoreceptor 17 in Photoreceptor Preparation Example 17 was repeated to prepare a photoreceptor 23 except for changing the protection layer coating liquid to a protection layer coating liquid having the following formula:

Formula of protection layer coating liquid

| | |
|---|---|
| Tri- or more-functional radical polymerizable monomer | 10 |
| having no charge transport structure | |
| (trimethylolpropane triacrylate, KAYARAD TMPTA from Nippon | |
| Kayaku Co., Ltd., having a molecular weight (M) of 296, three | |
| functional groups (F) and ratio (M/F) of 99) | |
| Monofunctional radical polymerizable monomer | 10 |
| having a charge transport structure and the following formula | |
| (i.e., compound No. 54 mentioned above): | |
| 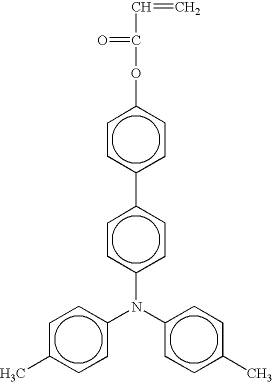 | |
| Photopolymerization initiator | 1 |
| (1-hydroxycycolhexyl-phenyl-ketone, IRGACURE 184 from | |
| Ciba Specialty Chemicals) | |
| Tetrahydrofuran | 100 |

The protection layer coating liquid was coated by a spray coating method and the coated liquid was naturally dried for 20 minutes. Then the coated layer was irradiated with a metal halide lamp at power of 160 W/cm to be hardened. The hardening conditions are as follows.

Light intensity: 500 mW/cm²

Irradiation time: 60 seconds

The protection layer had a transmission of 74% against light having a wavelength of 407 nm when measured by the same method in Photoreceptor Preparation Example 17.

### Photoreceptor Preparation Example 24

The procedure for preparation of photoreceptor 23 in Photoreceptor Preparation Example 23 was repeated to prepare a photoreceptor 24 except for changing the tri- or more-functional radical polymerizable monomer in the protection layer coating liquid to a trifunctional radical polymerizable monomer having no charge transport structure, pentaerythritol tetraacrylate (SR-295 from Sartomer Company Inc., having molecular weight (M) of 352, four functional groups (F) and ratio (M/F) of 88). The protection layer had a transmission of 73% against light having a wavelength of 407 nm when measured by the same method in Photoreceptor Preparation Example 17.

### Photoreceptor Preparation Example 25

The procedure for preparation of photoreceptor 23 in Photoreceptor Preparation Example 23 was repeated to prepare a photoreceptor 25 except for changing the tri- or more-functional radical polymerizable monomer in the protection layer coating liquid to a bifunctional radical polymerizable monomer having no charge transport structure, 1,6-hexanediol diacrylate (Wako Pure Chemical Industries Ltd., having molecular weight (M) of 226, two functional groups (F) and ratio (M/F) of 113). The protection layer had a transmission of 74% against light having a wavelength of 407 nm when measured by the same method in Photoreceptor Preparation Example 17.

### Photoreceptor Preparation Example 26

The procedure for preparation of photoreceptor 23 in Photoreceptor Preparation Example 23 was repeated to prepare a photoreceptor 26 except for changing the tri- or more-functional radical polymerizable monomer in the protection layer coating liquid to a hexafunctional radical polymerizable monomer having no charge transport structure, caprolactone-modified dipentaerythritol hexaacrylate (KAYARAD DPCA-120 from Nippon Kayaku Co., Ltd., having molecular weight (M) of 1946, six functional groups (F) and ratio (M/F) of 325). The protection layer had a transmission of 71% against light having a wavelength of 407 nm when measured by the same method in Photoreceptor Preparation Example 17.

### Photoreceptor Preparation Example 27

The procedure for preparation of photoreceptor 23 in Photoreceptor Preparation Example 23 was repeated to prepare a photoreceptor 27 except for changing the monofunctional polymerizable monomer having a charge transport structure in the protection layer coating liquid to a bifunctional radical polymerizable monomer having a charge transport structure and the following formula:

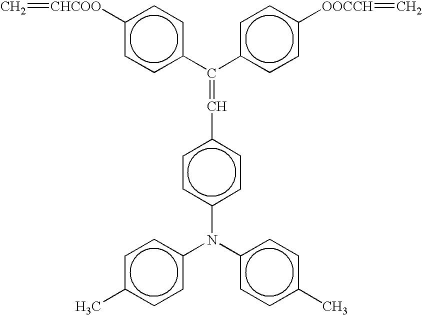

### Photoreceptor Preparation Example 28

The procedure for preparation of photoreceptor 23 in Photoreceptor Preparation Example 23 was repeated to prepare a photoreceptor 28 except for changing the protection layer coating liquid to a protection layer coating liquid having the following formula:

Formula of protection layer coating liquid

| | |
|---|---|
| Tri- or more-functional radical polymerizable monomer | 6 |
| having no charge transport structure | |
| (trimethylolpropane triacrylate, KAYARAD TMPTA fro Nippon | |
| Kayaku Co., Ltd., having a molecular weight (M) of 296, three | |
| functional groups (F) and ratio (M/F) of 99) | |
| Monofunctional radical polymerizable monomer | 14 |
| having a charge transport structure and the following formula | |
| (i.e., compound No. 54 mentioned above): | |
| 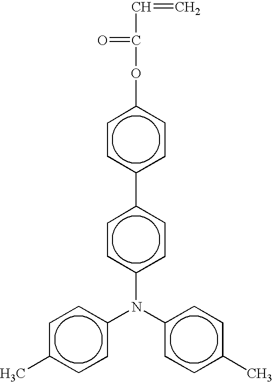 | |
| Photopolymerization initiator | 1 |
| (1-hydroxycycolhexyl-phenyl-ketone, IRGACURE 184 from | |
| Ciba Specialty Chemicals) | |
| Tetrahydrofuran | 100 |

The protection layer had a transmission of 72% against light having a wavelength of 407 nm when measured by the same method in Photoreceptor Preparation Example 17.

### Photoreceptor Preparation Example 29

The procedure for preparation of photoreceptor 23 in Photoreceptor Preparation Example 23 was repeated to prepare a photoreceptor 29 except for changing the protection layer coating liquid to a protection layer coating liquid having the following formula:

Formula of protection layer coating liquid

| | |
|---|---|
| Tri- or more-functional radical polymerizable monomer | 14 |
| having no charge transport structure | |
| (trimethylolpropane triacrylate, KAYARAD TMPTA fro Nippon | |
| Kayaku Co., Ltd., having a molecular weight (M) of 296, three | |
| functional groups (F) and ratio (M/F) of 99) | |
| Monofunctional radical polymerizable monomer | 6 |
| having a charge transport structure and the following formula | |
| (i.e., compound No. 54 mentioned above): | |
| 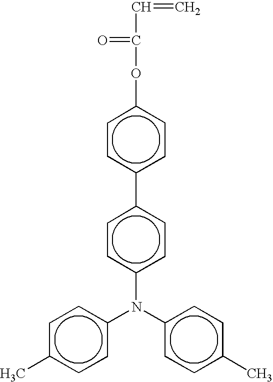 | |
| Photopolymerization initiator | 1 |
| (1-hydroxycycolhexyl-phenyl-ketone, IRGACURE 184 from | |
| Ciba Specialty Chemicals) | |
| Tetrahydrofuran | 100 |

The protection layer had a transmission of 74% against light having a wavelength of 407 nm when measured by the same method in Photoreceptor Preparation Example 17.

### Photoreceptor Preparation Example 30

The procedure for preparation of photoreceptor 23 in Photoreceptor Preparation Example 23 was repeated to prepare a photoreceptor 30 except for changing the protection layer coating liquid to a protection layer coating liquid having the following formula:

Formula of protection layer coating liquid

| | |
|---|---|
| Tri- or more-functional radical polymerizable monomer | 2 |
| having no charge transport structure | |
| (trimethylolpropane triacrylate, KAYARAD TMPTA fro Nippon | |
| Kayaku Co., Ltd., having a molecular weight (M) of 296, three | |
| functional groups (F) and ratio (M/F) of 99) | |
| Monofunctional radical polymerizable monomer | 18 |
| having a charge transport structure and the following formula | |
| (i.e., compound No. 54 mentioned above): | |
| 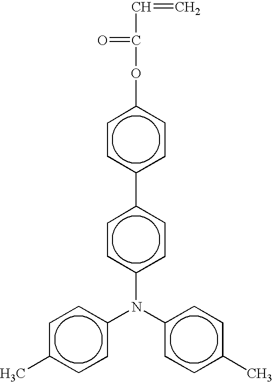 | |
| Photopolymerization initiator | 1 |
| (1-hydroxycycolhexyl-phenyl-ketone, IRGACURE 184 from | |
| Ciba Specialty Chemicals) | |
| Tetrahydrofuran | 100 |

The protection layer had a transmission of 74% against light having a wavelength of 407 nm when measured by the same method in Photoreceptor Preparation Example 17.

### Photoreceptor Preparation Example 31

The procedure for preparation of photoreceptor 23 in Photoreceptor Preparation Example 23 was repeated to prepare a photoreceptor 31 except for changing the protection layer coating liquid to a protection layer coating liquid having the following formula:

Formula of protection layer coating liquid

| | |
|---|---|
| Tri- or more-functional radical polymerizable monomer | 18 |
| having no charge transport structure | |
| (trimethylolpropane triacrylate, KAYARAD TMPTA fro Nippon | |
| Kayaku Co., Ltd., having a molecular weight (M) of 296, three | |
| functional groups (F) and ratio (M/F) of 99) | |
| Monofunctional radical polymerizable monomer | 2 |
| having a charge transport structure and the following formula | |
| (i.e., compound No. 54 mentioned above): | |
| 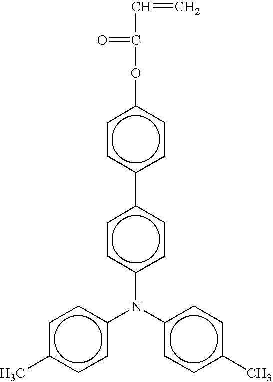 | |
| Photopolymerization initiator | 1 |
| (1-hydroxycycolhexyl-phenyl-ketone, IRGACURE 184 from | |
| Ciba Specialty Chemicals) | |
| Tetrahydrofuran | 100 |

The protection layer had a transmission of 73% against light having a wavelength of 407 nm when measured by the same method in Photoreceptor Preparation Example 17.

### Example 20

The photoreceptor 2 was set in an image forming apparatus having a structure illustrated in FIG. 8, and a running test in which 70,000 copies of a chart in FIG. 13 are continuously produced was performed under the following conditions.

Light irradiator: Irradiator having a writing light source including a laser diode emitting light having a wavelength of 407 nm, and a polygon mirror used

Charger: Scorotron charger

Transferer: Transfer belt

Discharger: Discharging lamp including a LED (from Rohm Co., Ltd.) which emits light having a wavelength of 660 nm

Potential of charged photoreceptor: −900 V

(potential of non-lighted part)

Developing method: Nega-posi developing method

Developing bias: −650 V

Potential of non-lighted part of photoreceptor after discharging process: −120 V

### <Evaluation Items>

### (1) Halftone Image (HT)

After the running test, a halftone image of the chart in FIG. 13 was produced to observe the black and blank parts thereof.

◯: No difference

X: There is a difference

The results are shown in Table 5.

### (2) Background Fouling (BF)

After the running test, a white solid image was produced under an environmental condition of 22° C. and 50% RH and observed to determine whether the white solid image has background fouling The quality is classified into the following four grades.

⊚: Excellent

◯: Good

Δ: Acceptable

X: Poor

The results are shown in Table 5.

### (3) Cleanability of Photoreceptor (CL)

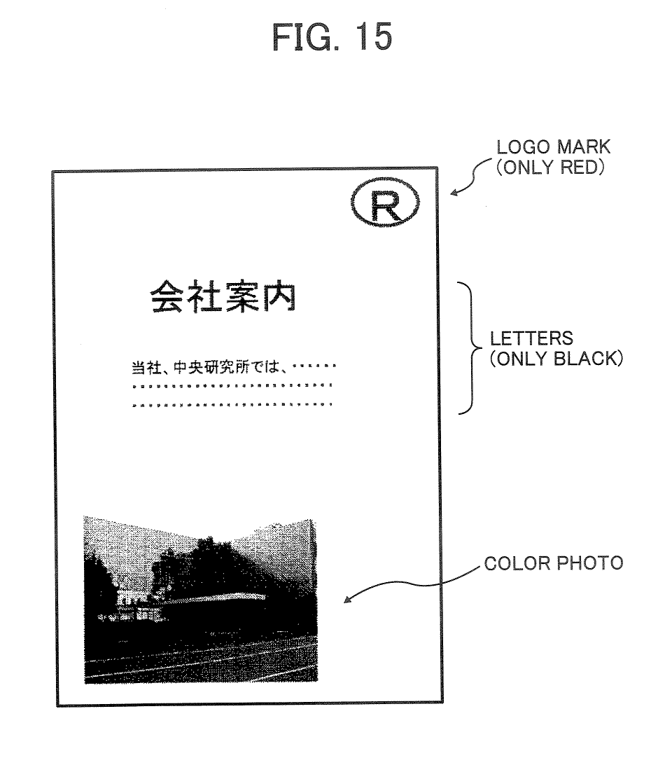

After the evaluation of background fouling, 50 copies of an original image illustrated in FIG. 15 were produced under an environmental condition of 10° C. and 15% RH and the white solid image portion of the 50^{th} image was visually observed to evaluate the cleanability of the photoreceptor. The cleanability of the photoreceptor is classified into the following four grades.

⊚: Excellent (no streak image was observed in the white solid image)

◯: Good (one or two slight black streaks were observed in the white solid image)

Δ: Acceptable (three or four slight black streaks were observed in the white solid image)

X: Poor (clear black streaks were observed in the white solid image)

The results are shown in Table 5.

### (4) Dot Reproducibility (DOT)

After the evaluation of cleanability, 1,000 copies of the original character image were produced a high temperature and high humidity condition of 30° C. and 90% RH and then an image including one dot images was produced. The one dot images were observed with a microscope with 150 power magnification whether the outline of the one dot images is clear. The dot reproducibility of the photoreceptor is classified into the following four grades.

⊚: Excellent

◯: Good

Δ: Acceptable

X: Poor

The results are shown in Table 5.

### (5) Abrasion Loss (AL)

The thickness of the photosensitive layer (including the protective layer and the intermediate layer) of each photoreceptor before the running test and after the tests mentioned above in (1) to (4) was measured to determine the thickness difference, i.e., the abrasion loss of the photoreceptor. The thickness of several points of the photoreceptor in the longitudinal direction thereof was measured at intervals of 1 cm except for both the edge portions having a width of 5 cm, and the thickness data were averaged.

The results are shown in Table 5.

### Examples 21 to 35

The procedure for evaluation of the photoreceptor 2 in Example 20 was repeated to evaluate the photoreceptors 17 to 31 except for replacing the photoreceptor 2 with the photoreceptors 17 to 31. The results are shown in Table 5. The photoreceptor Nos. (PH No.) are also shown therein.

### Comparative Example 8

The procedure for evaluation of the photoreceptor 2 in Example 20 was repeated to evaluate the photoreceptor 2 except for changing the writing light source to a LD emitting light having a wavelength of 375 nm.

### Comparative Example 8

The procedure for evaluation of the photoreceptor 2 in Comparative Example 8 was repeated to evaluate the photoreceptors 17 to 31 except for replacing the photoreceptor 2 with the photoreceptors 17 to 31. The results are shown in Table 5.

TABLE 5

| | PH No. | HT | BF | CL | DOT | AL (μm) |
|---|---|---|---|---|---|---|
| Ex. 20 | 2 | ◯ | Δ | ◯ | ⊚ | 9.7 |
| Com. Ex. 8 | 2 | X | Δ~◯ | ◯ | ◯ | 9.7 |
| Ex. 21 | 17 | ◯ | ⊚ | Δ~◯ | ⊚~◯ | 2.7 |
| Com. Ex. 9 | 17 | X | ◯ | Δ~◯ | ◯ | 2.7 |
| Ex. 22 | 18 | ◯ | ⊚ | Δ~◯ | ◯ | 2.4 |
| Com. Ex. 10 | 18 | X | ◯ | Δ~◯ | Δ~◯ | 2.4 |
| Ex. 23 | 19 | ◯ | ◯ | Δ~◯ | Δ~◯ | 2.7 |
| Com. Ex. 11 | 19 | X | Δ~◯ | Δ~◯ | Δ | 2.7 |
| Ex. 24 | 20 | ◯ | ⊚ | Δ~◯ | ◯ | 2.1 |
| Com. Ex. 12 | 20 | X | ◯ | Δ~◯ | Δ~◯ | 2.1 |
| Ex. 25 | 21 | ◯ | ⊚~◯ | ◯ | ◯ | 3.4 |
| Com. Ex. 13 | 21 | X | ◯ | ◯ | Δ~◯ | 3.4 |
| Ex. 26 | 22 | ◯ | ⊚ | Δ~◯ | Δ~◯ | 2.1 |
| Com. Ex. 14 | 22 | X | ◯ | Δ~◯ | Δ | 2.1 |
| Ex. 27 | 23 | ◯ | ⊚ | ⊚ | ⊚ | 1.9 |
| Com. Ex. 15 | 23 | X | ◯ | ⊚ | ◯ | 1.9 |
| Ex. 28 | 24 | ◯ | ◯ | ⊚ | ⊚ | 1.6 |
| Com. Ex. 16 | 24 | X | Δ~◯ | ⊚ | ◯ | 1.6 |
| Ex. 29 | 25 | ◯ | ⊚ | Δ~◯ | ⊚ | 3.5 |
| Com. Ex. 17 | 25 | X | ◯ | Δ~◯ | ◯ | 3.5 |
| Ex. 30 | 26 | ◯ | ⊚ | ⊚ | ⊚ | 1.9 |
| Com. Ex. 18 | 26 | X | ◯ | ⊚ | ◯ | 1.9 |
| Ex. 31 | 27 | ◯ | ⊚ | Δ~◯ | Δ~◯ | 1.6 |
| Com. Ex. 19 | 27 | X | ◯ | Δ~◯ | Δ | 1.6 |
| Ex. 32 | 28 | ◯ | ⊚~◯ | ⊚ | ⊚ | 2.1 |
| Com. Ex. 20 | 28 | X | ◯ | ⊚ | ◯ | 2.1 |
| Ex. 33 | 29 | ◯ | ⊚ | ⊚ | ⊚ | 1.9 |
| Com. Ex. 21 | 29 | X | ◯ | ⊚ | ◯ | 1.9 |
| Ex. 34 | 30 | ◯ | ⊚~◯ | ⊚ | ⊚ | 2.4 |
| Com. Ex. 22 | 30 | X | ◯ | ⊚ | ◯ | 2.4 |
| Ex. 35 | 31 | ◯ | ⊚ | ⊚ | ⊚ | 1.9 |
| Com. Ex. 23 | 31 | X | ◯ | ⊚ | ◯ | 1.9 |

The photoreceptors each having an intermediate layer including an anatase-type titanium oxide not absorbing writing light having a wavelength of 407 nm (Examples 30 to 35) do not produce halftone images having uneven image density even when each having a protection layer while the photoreceptors (Comparative Examples 8 to 23) each having an intermediate layer including an anatase-type titanium oxide absorbing the light do.

The photoreceptors each having a protection layer (Examples 21 to 27) have more abrasion resistance than the photoreceptor not having a protection layer (Example 20).

Among the photoreceptors each having a protection layer including an inorganic pigment (metal oxide) (Examples 21 to 23), the photoreceptors each having a protection layer including an inorganic pigment (metal oxide) having a specific resistivity not less than 10¹⁰ Ω·cm do not largely deteriorate in dot reproducibility even in an environment of high-temperature and high-humidity (Examples 22 and 23).

The photoreceptors each having a protection layer including a crosslinked structure have more abrasion resistance than those each having a protection layer not including a crosslinked structure.

The protection layers each formed by hardening a tri- or more-functional radical polymerizable monomer having no charge transport structure and a monofunctional radical polymerizable monomer having a charge transport structure have more abrasion resistance (Examples 24, 27, 30 and 32 to 35), and good cleanability.

The photoreceptors each having a protection layer having a transmission less than 30% against writing light deteriorate more in dot reproducibility than those each having a protection layer having a transmission not less than 30% against the writing light.

### Photoreceptor Preparation Example 32

The procedure for preparation of photoreceptor 2 in Photoreceptor Preparation Example 2 was repeated to prepare a photoreceptor 32 except for replacing the intermediate layer with a combination of a charge blocking layer with a thickness of 1.0 μm and an anti-moiré layer with a thickness of 3.5 μm located on the charge blocking layer, which were formed by coating the respective coating liquids having the following formulae, followed by drying.

Formula of charge blocking layer coating liquid

| | |
|---|---|
| N-methoxymethylated nylon | 4 |
| (FINE RESIN FR-101 from Namariichi Co., Ltd.) | |
| Methanol | 70 |
| n-Butanol | 30 |

Formula of anti-moiré layer coating liquid

| | |
|---|---|
| Aluminum surface-treated | 135.7 |
| anatase-type titanium oxide | |
| (KA-10 from Titan Kogyo K.K., having an average particle | |
| diameter of 0.40 μm) | |
| Alkyd resin | 33.6 |
| (BEKKOLITEM6401-50-S from Dainippon Ink & Chemicals, Inc., | |
| solid content of 50%) | |
| Melamine resin | 18.7 |
| (SUPER BEKKAMIN L-121-60 from Dainippon Ink & | |
| Chemicals, Inc., solid content of 60%) | |
| 2-butanone | 100 |

In the anti-moiré layer, the volume ratio (P/R) of the inorganic pigment (P) to the binder resin (R) is 1.5/1, and the weight ratio (A/M) of the alkyd resin (A) to the melamine resin (M) is 6/4.

### Photoreceptor Preparation Example 33

The procedure for preparation of photoreceptor 32 in Photoreceptor Preparation Example 32 was repeated to prepare a photoreceptor 33 except for changing the thickness of the charge blocking layer to 0.3 μm.

### Photoreceptor Preparation Example 34

The procedure for preparation of photoreceptor 32 in Photoreceptor Preparation Example 32 was repeated to prepare a photoreceptor 34 except for changing the thickness of the charge blocking layer to 1.8 μm.

### Photoreceptor Preparation Example 35

The procedure for preparation of photoreceptor 32 in Photoreceptor Preparation Example 32 was repeated to prepare a photoreceptor 35 except for replacing the charge blocking layer coating liquid with a charge blocking layer coating liquid having the following formula.

Formula of charge blocking layer coating liquid

| | |
|---|---|
| Alcohol-soluble nylon | 4 |
| (AMILAN CM8000 from Toray Industries Inc.) | |
| Methanol | 70 |
| n-Butanol | 30 |

### Photoreceptor Preparation Example 36

The procedure for preparation of photoreceptor 32 in Photoreceptor Preparation Example 32 was repeated to prepare a photoreceptor 36 except for replacing the anti-moiré layer coating liquid with an anti-moiré layer coating liquid having the following formula.

Formula of anti-moiré layer coating liquid

| | |
|---|---|
| Aluminum surface-treated | 271.4 |
| anatase-type titanium oxide | |
| (KA-10 from Titan Kogyo K.K., having an average particle | |
| diameter of 0.40 μm) | |
| Alkyd resin | 33.6 |
| (BEKKOLITEM6401-50-S from Dainippon Ink & Chemicals, Inc., | |
| solid content of 50%) | |
| Melamine resin | 18.7 |
| (SUPER BEKKAMIN L-121-60 from Dainippon Ink & Chemicals, | |
| Inc., solid content of 60%) | |
| 2-butanone | 100 |

In the moiré preventing layer, the volume ratio (P/R) of the inorganic pigment (P) to the binder resin (R) is 3/1, and the weight ratio (A/M) of the alkyd resin (A) to the melamine resin (M) is 6/4.

### Photoreceptor Preparation Example 37

The procedure for preparation of photoreceptor 32 in Photoreceptor Preparation Example 32 was repeated to prepare a photoreceptor 37 except for replacing the anti-moiré layer coating liquid with an anti-moiré layer coating liquid having the following formula.

Formula of anti-moiré layer coating liquid

| | |
|---|---|
| Aluminum surface-treated | 90.5 |
| anatase-type titanium oxide | |
| (KA-10 from Titan Kogyo K.K., having an average particle | |
| diameter of 0.40 μm) | |
| Alkyd resin | 33.6 |
| (BEKKOLITEM6401-50-S from Dainippon Ink & Chemicals, Inc., | |
| solid content of 50%) | |
| Melamine resin | 18.7 |
| (SUPER BEKKAMIN L-121-60 from Dainippon Ink & Chemicals, | |
| Inc., solid content of 60%) | |
| 2-butanone | 100 |

In the moiré preventing layer, the volume ratio (P/R) of the inorganic pigment (P) to the binder resin (R) is 1/1, and the weight ratio (A/M) of the alkyd resin (A) to the melamine resin (M) is 6/4.

### Examples 36 to 41

The procedure for evaluation of the photoreceptor 2 in Example 20 was repeated to evaluate the photoreceptors 36 to 41 except for replacing the photoreceptor 2 with the photoreceptors 36 to 41. The results are shown in Table 6 together with those of Example 20.

TABLE 6

| | PH No. | HT | BF | CL | DOT | AL (μm) |
|---|---|---|---|---|---|---|
| Example 20 | 2 | ◯ | Δ | ◯ | ⊚ | 9.7 |
| Example 36 | 32 | ◯ | ⊚ | ◯ | ⊚ | 9.7 |
| Example 37 | 33 | ◯ | ◯ | ◯ | ⊚ | 9.7 |
| Example 38 | 34 | ◯ | ⊚ | ◯ | ⊚ | 9.7 |
| Example 39 | 35 | ◯ | ⊚ | ◯ | ⊚ | 9.7 |
| Example 40 | 36 | ◯ | ◯ | ◯ | ⊚ | 9.7 |
| Example 41 | 37 | ◯ | ⊚ | ◯ | ⊚ | 9.7 |

Table 6 shows that the photoreceptors have good resistance to background fouling when using a combination of a charge blocking layer and an anti-moiré layer as the intermediate layer.

### Photoreceptor Preparation Example 38

The procedure for preparation of photoreceptor 1 in Photoreceptor Preparation Example 1 was repeated to prepare a photoreceptor 38 except for changing the CGL coating liquid (dispersion 1) to the dispersion 5. The thickness of the CGL was adjusted to have a transmission of 20% against light having a wavelength of 445 nm.

### Photoreceptor Preparation Example 39

The procedure for preparation of photoreceptor 2 in Photoreceptor Preparation Example 2 was repeated to prepare a photoreceptor 39 except for changing the CGL coating liquid (dispersion 1) to the dispersion 5. The thickness of the CGL was adjusted to have a transmission of 20% against light having a wavelength of 445 nm.

### Photoreceptor Preparation Example 40

The procedure for preparation of photoreceptor 3 in Photoreceptor Preparation Example 3 was repeated to prepare a photoreceptor 40 except for changing the CGL coating liquid (dispersion 1) to the dispersion 5. The thickness of the CGL was adjusted to have a transmission of 20% against light having a wavelength of 445 nm.

### Photoreceptor Preparation Example 41

The procedure for preparation of photoreceptor 4 in Photoreceptor Preparation Example 4 was repeated to prepare a photoreceptor 41 except for changing the CGL coating liquid (dispersion 1) to the dispersion 5. The thickness of the CGL was adjusted to have a transmission of 20% against light having a wavelength of 445 nm.

### Photoreceptor Preparation Example 42

The procedure for preparation of photoreceptor 5 in Photoreceptor Preparation Example 5 was repeated to prepare a photoreceptor 42 except for changing the CGL coating liquid (dispersion 1) to the dispersion 5. The thickness of the CGL was adjusted to have a transmission of 20% against light having a wavelength of 445 nm.

### Photoreceptor Preparation Example 43

The procedure for preparation of photoreceptor 6 in Photoreceptor Preparation Example 6 was repeated to prepare a photoreceptor 43 except for changing the CGL coating liquid (dispersion 1) to the dispersion 5. The thickness of the CGL was adjusted to have a transmission of 20% against light having a wavelength of 445 nm.

### Example 42

The photoreceptor 38 was set in a process cartridge in FIG. 10, and which was further installed in an image forming apparatus having a structure illustrated in FIG. 9, and a running test in which 50,000 copies of an A4 chart in FIG. 15 are continuously produced such that the longitudinal direction of the chart and that of the photoreceptor are in line was performed under the following conditions.

Light irradiator: Irradiator having a writing light source including a laser diode emitting light having a wavelength of 407 nm, and a polygon mirror used

Charger: Scorotron charger

Transferer: Transfer belt

Discharger: Discharging lamp including a LED (from Rohm Co., Ltd.) which emits light having a wavelength of 660 nm

Potential of charged photoreceptor: −900 V

(potential of non-lighted part)

Developing method: Nega-posi developing method

Developing bias: −650 V

Potential of non-lighted part of photoreceptor after discharging process: −60 V

After the running test, a halftone image for each color Y, M, C and K was produced such that the longitudinal direction of the chart and that of the photoreceptor are in line. In addition, after the running test, a copy of an ISO/JIS-SCID N1 portrait image was produced to evaluate the color reproducibility of the photoreceptor. The evaluation results are shown in Table 7.

### Example 43

The procedure for evaluation of the photoreceptor 38 in Example 42 was repeated to evaluate the photoreceptor 39 except for replacing the photoreceptor 38 with the photoreceptor 39. The evaluation results are shown in Table 7.

### Example 44

The procedure for evaluation of the photoreceptor 38 in Example 42 was repeated to evaluate the photoreceptor 40 except for replacing the photoreceptor 38 with the photoreceptor 40. The evaluation results are shown in Table 7.

### Example 45

The procedure for evaluation of the photoreceptor 38 in Example 42 was repeated to evaluate the photoreceptor 41 except for replacing the photoreceptor 38 with the photoreceptor 41. The evaluation results are shown in Table 7.

### Example 46

The procedure for evaluation of the photoreceptor 38 in Example 42 was repeated to evaluate the photoreceptor 42 except for replacing the photoreceptor 38 with the photoreceptor 42. The evaluation results are shown in Table 7.

### Example 47

The procedure for evaluation of the photoreceptor 38 in Example 42 was repeated to evaluate the photoreceptor 38 except for changing the writing light source to a LD emitting light having a wavelength of 407 nm. The evaluation results are shown in Table 7.

### Example 48

The procedure for evaluation of the photoreceptor 38 in Example 47 was repeated to evaluate the photoreceptor 39 except for replacing the photoreceptor 38 with the photoreceptor 39. The evaluation results are shown in Table 7.

### Comparative Example 24

The procedure for evaluation of the photoreceptor 38 in Example 47 was repeated to evaluate the photoreceptor 40 except for replacing the photoreceptor 38 with the photoreceptor 40. The evaluation results are shown in Table 7.

### Comparative Example 25

The procedure for evaluation of the photoreceptor 38 in Example 47 was repeated to evaluate the photoreceptor 41 except for replacing the photoreceptor 38 with the photoreceptor 41. The evaluation results are shown in Table 7.

### Example 49

The procedure for evaluation of the photoreceptor 38 in Example 47 was repeated to evaluate the photoreceptor 42 except for replacing the photoreceptor 38 with the photoreceptor 42. The evaluation results are shown in Table 7.

### Comparative Example 26

The procedure for evaluation of the photoreceptor 38 in Example 42 was repeated to evaluate the photoreceptor 38 except for changing the writing light source to a LD emitting light having a wavelength of 375 nm. The evaluation results are shown in Table 7.

### Comparative Example 27

The procedure for evaluation of the photoreceptor 38 in Comparative Example 26 was repeated to evaluate the photoreceptor 39 except for replacing the photoreceptor 38 with the photoreceptor 39. The evaluation results are shown in Table 7.

### Comparative Example 28

The procedure for evaluation of the photoreceptor 38 in Comparative Example 26 was repeated to evaluate the photoreceptor 40 except for replacing the photoreceptor 38 with the photoreceptor 40. The evaluation results are shown in Table 7.

### Comparative Example 29

The procedure for evaluation of the photoreceptor 38 in Comparative Example 26 was repeated to evaluate the photoreceptor 41 except for replacing the photoreceptor 38 with the photoreceptor 41. The evaluation results are shown in Table 7.

### Comparative Example 30

The procedure for evaluation of the photoreceptor 38 in Comparative Example 26 was repeated to evaluate the photoreceptor 42 except for replacing the photoreceptor 38 with the photoreceptor 42. The evaluation results are shown in Table 7.

### Example 50

The procedure for evaluation of the photoreceptor 38 in Example 42 was repeated to evaluate the photoreceptor 43 except for replacing the photoreceptor 38 with the photoreceptor 43. The evaluation results are shown in Table 7.

| | Writing light | Halftone image | | | | |
|---|---|---|---|---|---|---|
| | wavelength | Y | M | C | K | Color reproducibility |
| Example 42 | 445 | Good | Good | Good | Good | Good |
| Example 43 | 445 | Good | Good | Good | Good | Good |
| Example 44 | 445 | Good | Good | Good | Good | Good |
| Example 45 | 445 | Good | Good | Good | Good | Good |
| Example 46 | 445 | Good | Good | Good | Good | Good |
| Example 47 | 407 | Good | Good | Good | Good | Good |
| Example 48 | 407 | Good | Good | Good | Good | Good |
| Comparative | 407 | Logo and photo | Logo and photo | Photo have high | Letters and photo | Poor |
| Example 24 | | have high image | have high image | image density | have high image | |
| | | density | density | | density | |
| Comparative | 407 | Logo and photo | Logo and photo | Logo and photo | Logo and photo | Poor |
| Example 25 | | have slightly | have slightly | have slightly | have slightly | |
| | | high image | high image | high image | high image | |
| | | density | density | density | density | |
| Example 49 | 407 | Good | Good | Good | Good | Good |
| Comparative | 375 | Logo and photo | Logo and photo | Photo have high | Letters and photo | Poor |
| Example 26 | | have high image | have high image | image density | have high image | |
| | | density | density | | density | |
| Comparative | 375 | Logo and photo | Logo and photo | Logo and photo | Logo and photo | Poor |
| Example 27 | | have slightly | have slightly | have slightly | have slightly | |
| | | high image | high image | high image | high image | |
| | | density | density | density | density | |
| Comparative | 375 | Logo and photo | Logo and photo | Photo have high | Letters and photo | Poor |
| Example 28 | | have high image | have high image | image density | have high image | |
| | | density | density | | density | |
| Comparative | 375 | Logo and photo | Logo and photo | Logo and photo | Logo and photo | Poor |
| Example 29 | | have slightly | have slightly | have slightly | have slightly | |
| | | high image | high image | high image | high image | |
| | | density | density | density | density | |
| Comparative | 375 | Logo and photo | Logo and photo | Photo have high | Letters and photo | Poor |
| Example 30 | | have high image | have high image | image density | have high image | |
| | | density | density | | density | |
| Example 50 | 407 | Good | Good | Good | Good | Good |

The photoreceptors each having an intermediate layer including a metal oxide not absorbing writing light having a wavelength shorter than 450 nm (Examples 42 to 49) produced stable halftone images even after the running test, while the photoreceptors each having an intermediate layer including a metal oxide absorbing the writing light (Comparative Examples 24 to 30) did not.

The photoreceptors in Comparative Examples 25, 27 and 29, wherein each of the metal oxide is surface-treated, vary slightly less in electrostatic properties than those in Comparative Examples 24, 26 and 28.

The photoreceptors in Examples 42 to 49 did not produce images having abnormal color reproducibility even after the running test, while the photoreceptors in Comparative Examples 24 to 30 did.

The surface potential of the photoreceptor in Example 42 was lower than that In Example 50 even when irradiated at a same light quantity, which proves that the asymmetric azo pigment in the dispersion 5 increases the sensitivity of the photoreceptor.

This application claims priority and contains subject matter related to Japanese Patent Applications Nos. 2006-014539, 2006-014544 and 2006-014550, all of which were filed on Jan. 24, 2006, and the entire contents of each of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An image forming apparatus, comprising:
a photoreceptor, comprising:
a substrate; and
a photosensitive layer, comprising:
an intermediate layer overlying the substrate;
a charge generation layer overlying the intermediate layer; and
a charge transport layer overlying the charge generation layer;
a charger configured to charge the photoreceptor;
an irradiator configured to irradiate the photoreceptor with writing light having a wavelength shorter than 450 nm to form an electrostatic latent image thereon;
an image developer configured to develop the electrostatic latent image with a toner to form a toner image on the photoreceptor;
a transferer configured to transfer the toner image onto a recording medium;
a fixer configured to fix the toner image on the recording medium; and
a discharger configured to remove a residual potential from the photoreceptor with light;
wherein the intermediate layer comprises a metal oxide that does not absorb the writing light and the charge generation layer comprises an organic charge generation material.

2. The image forming apparatus of claim 1, wherein the metal oxide is an anatase titanium oxide and the writing light has a wavelength shorter than 410 nm.

3. The image forming apparatus of claim 1, wherein the metal oxide is a zinc oxide and the irradiator writing light has a wavelength shorter than 410 nm.

4. The image forming apparatus of claim 1, wherein the metal oxide is surface-treated.

5. The image forming apparatus of claim 2, wherein the anatase titanium oxide is surface-treated.

6. The image forming apparatus of claim 3, wherein the zinc oxide is surface-treated.

7. The image forming apparatus of claim 1, wherein the charge generation layer has a transmission of from 10 to 25% against the writing light.

8. The image forming apparatus of claim 1, wherein the charge transport layer has a transmission not less than 30% against the writing light.

9. The image forming apparatus of claim 1, wherein the photoreceptor further comprises a protection layer on the photosensitive layer.

10. The image forming apparatus of claim 9, wherein the protection layer has a transmission not less than 30% against the writing light.

11. The image forming apparatus of claim 9, wherein the protection layer comprises an inorganic pigment or a metal oxide having a specific resistivity not less than 10¹⁰ Ω·cm.

12. The image forming apparatus of claim 9, wherein the protection layer is formed by hardening a radical polymerizable tri- or more-functional monomer having no charge transport structure and a radical polymerizable monofunctional monomer having a charge transport structure.

13. The image forming apparatus of claim 1, wherein the intermediate layer further comprises a charge blocking layer and an anti-moiré layer, and wherein the anti-moiré layer comprises the metal oxide.

14. The image forming apparatus of claim 13, wherein the charge blocking layer is formed of an insulative material and has a thickness not less than 0.3 μm and less than 2.0 μm.

15. The image forming apparatus of claim 14, wherein the insulative material is a N-methoxymethylated nylon.

16. The image forming apparatus of claim 13, wherein the anti-moiré layer further comprises a binder resin, and wherein a volume ratio of the metal oxide to the binder resin is form 1/1 to 3/1.

17. The image forming apparatus of claim 1, wherein the discharger removes the residual potential from the photoreceptor with light having such a wavelength as is not absorbed in the metal oxide in the intermediate layer.

18. The image forming apparatus of claim 1, further comprising a plurality of the photoreceptors, chargers, irradiators, image developers, transferers and dischargers.

19. The image forming apparatus of claim 1, further comprising a process cartridge detachable from the image forming apparatus, comprising:
a photoreceptor; and
at least one of a charger, irradiator, an image developer, a discharger and a cleaner.

20. An image forming method, comprising:
charging a photoreceptor, comprising:
a substrate; and
a photosensitive layer, comprising:
an intermediate layer overlying the substrate;
a charge generation layer overlying the intermediate layer; and
a charge transport layer, overlying the charge generation layer;
irradiating the photoreceptor to form an electrostatic latent image thereon;
developing the electrostatic latent image with a toner to form a toner image on the photoreceptor;
transferring the toner image onto a recording medium;
fixing the toner image on the recording medium; and
removing a residual potential from the photoreceptor with light;
wherein the intermediate layer comprises a metal oxide that does not absorb the writing light and the charge generation layer comprises an organic charge generation material.

21. The image forming method of claim 20, wherein the residual potential is removed from the photoreceptor with light having such a wavelength as is not absorbed in the metal oxide in the intermediate layer.

22. The image forming method of claim 20, wherein the charging, irradiating, developing, transferring and discharging are plurally performed at the same time.
